(19) United States
(12) Patent Application Publication
(10) Pub. No.: US 2009/0033833 A1
(43) Pub. Date: Feb. 5, 2009

(54) Polarizing Plate and Liquid Crystal Display Device Comprising the Same

(75) Inventor: Eiichiro Aminaka, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Tokyo (JP)

(21) Appl. No.: 11/791,226

(22) PCT Filed: Nov. 30, 2005
(86) PCT No.: PCT/JP05/22411

§ 371 Date: May 22, 2007

(30) Foreign Application Priority Data
Nov. 30, 2004 (JP) 2004-347003
Mar. 22, 2005 (JP) 2005-081847

(51) Int. Cl. B32B 33/00; G02F 1/1335; G02F 1/13357

(52) U.S. Cl. 349/68; 428/409; 349/96

(57) ABSTRACT

A polarizing plate comprising a protective film provided on the both sides of a polarizer, wherein the polarizing plate has an adhesive layer provided on at least one side thereof, which adhesive layer comprising a (meth)acrylic copolymer composition composed of (A) a specific (meth)acrylic copolymer reactive with the following polyfunctional compound (B) and (B) a polyfunctional compound and having a specific gel fraction.

### TECHNICAL FIELD

The present invention relates to a polarizing plate having little light leakage due to compression stress of polarizing plate at the periphery of screen caused by change of temperature and humidity or during continuous lighting of liquid crystal display device and a liquid crystal display device comprising same.

### BACKGROUND ART

Liquid crystal display devices have been widely used for monitor for personal computer and cellular phone, television, etc. because they are advantageous in that they can operate at low voltage with low power consumption and are available in small size and thickness. These liquid crystal display devices have been proposed in various modes depending on the alignment of liquid crystal molecules in the liquid crystal cell. To date, TN mode, in which liquid crystal molecules are aligned twisted at about 90 degrees from the lower substrate to the upper substrate of the liquid crystal cell, has been a mainstream.

A liquid crystal display device normally comprises a liquid crystal cell, an optical compensation sheet and a polarizer. The optical compensation sheet is used to eliminate undesirable coloring of image or expand the viewing angle. As such an optical compensation sheet there is used a stretched birefringent film or a transparent film coated with a liquid crystal.

For example, Japanese Patent 2,587,398 discloses a technique for the expansion of the viewing angle involving the application to a TN mode liquid crystal cell of an optical compensation sheet obtained by spreading a discotic liquid crystal over a triacetyl cellulose film, and then orienting and fixing the coat layer. However, liquid crystal display devices for TV use which are supposed to give a wide screen image that can be viewed at various angles have severe requirements for dependence on viewing angle. These requirements cannot be met even by the aforementioned approach. To this end, liquid crystal display devices of modes different from TN mode, including IPS (In-Plane Switching) mode, OCB (Optically Compensatory Bend) mode, VA (Vertically Aligned) mode, have been under study. In particular, VA mode has been noted as liquid crystal display device for TV use because it gives a high contrast image and can be produced in a relatively high yield.

A cellulose acylate film is characterized by a higher optical isotropy (lower retardation value) than other polymer films. Accordingly, it is normally practiced to use a cellulose acylate film in uses requiring optical isotropy such as polarizing plate.

On the contrary, the optical compensation sheet (retardation film) for liquid crystal display device is required to have an optical anisotropy (high retardation value). In particular, the optical compensation sheet for VA mode is required to have a front retardation (Re₅₉₀) of from 20 nm to 200 nm and a thickness direction retardation (Rth₅₉₀) of from 0 nm to 400 nm. Accordingly, as the optical compensation sheet there has been normally used a synthetic polymer film having a high retardation value such as polycarbonate film and polysulfone film.

As mentioned above, it is a general principle in the art of optical material that a synthetic polymer film is used in the case where a polymer film having a high optical anisotropy (high retardation value) is required while a cellulose acylate film is used in the case where a polymer film having an optical isotropy (low retardation value) is required.

European Patent Application Disclosure No. 911,656 overthrows this conventional general principle and proposes a cellulose acylate film having a high retardation value that can be used also for purposes requiring optical anisotropy. In accordance with this proposal, an aromatic compound having at least two aromatic rings, particularly a compound having 1,3,5-triazine ring, is added to cellulose triacetate to be stretched in order to realize a cellulose triacetate film having a high retardation value. It is generally known that a cellulose triacetate is a polymer material that can be difficultly stretched and provided with a high birefringence. However, European Patent Application Disclosure No. 911,656 proposes that when additives are oriented at the same time with stretching, making it possible to raise birefringence and realize a high retardation value. This film is advantageous in that it can act also as a protective film for polarizing plate and thus can provide an inexpensive thin liquid crystal display device.

JP-A-2002-71957 discloses an optical film comprising a cellulose ester having a C₂-C₄ acyl group as a substituent satisfying the formulae 2.0≦A+B≦3.0 and A<2.4 supposing that the degree of substitution of acetyl group is A and the degree of substitution of propionyl group or butyryl group is B.

JP-A-2003-270442 discloses a polarizing plate for use in VA mode liquid crystal display device, wherein the polarizing plate has a polarizer and an optically biaxial mixed aliphatic acid cellulose ester film which is disposed interposed between the liquid crystal cell and the polarizer.

The method disclosed in the aforementioned reference is advantageous in that an inexpensive and thin liquid crystal display device can be obtained. With the recent rapid trend for the enhancement of size and brightness of liquid crystal display device, however, a problem of light leakage in the periphery of screen during black display due to compressive stress of polarizing plate has appeared. A polarizing plate tends to shrink with the change of ambient temperature and humidity. However, since the polarizing plate is fixed to the liquid crystal cell with an adhesive layer, local stress is developed on the protective film and adhesive layer of the polarizing plate and the glass substrate of the liquid crystal cell (particularly in the periphery of screen). The resulting change of birefringence due to their photoelasticity causes light leakage.

When a liquid crystal cell comprising a polarizing plate stuck thereto is processed at high temperatures, the water content is released from the polarizing plate. As a result, the polarizing plate shows a great shrinkage. During the high temperature processing and shortly after being withdrawn from the high temperature processing to ordinary temperature and humidity, violet light leakage occurs. Thereafter, when the polarizing plate is allowed to stand at ordinary temperature and humidity, the polarizing plate absorbs water content to reduce its shrinkage and light leakage. Even at ordinary temperature and humidity, when the backlight is continuously lighted, the temperature of the polarizing plate rises, causing the occurrence of light leakage as in the high temperature processing.

When a liquid crystal cell comprising a polarizing plate stuck thereto is processed at high temperature and high humidity, the polarizing plate absorbs water content. When the polarizing plate is then allowed to stand at ordinary temperature and humidity, the water content is then released from the polarizing plate. As a result, the shrinkage of the polarizing plate rises. With the rise of shrinkage, light leakage occurs more violently.

It has thus been desired to eliminate the occurrence of light leakage in the periphery of screen due to change of temperature and humidity or continuous lighting of backlight.

In TN mode, as the adhesive to be used to stick the polarizing plate to the liquid crystal cell there is used a soft adhesive. In this arrangement, the shrinkage stress on the optical compensation film is relaxed to eliminate the aforementioned light leakage. JP-A-2001-272541, JP-A-2003-50313 and JP-A-2001-350020 each disclose that the creep of the adhesive is raised to relax the shrinkage stress.

It has been further disclosed that various elastic moduli of the adhesive for sticking the polarizing plate or optical compensation film to the liquid crystal cell are lowered to relax the shrinkage stress. Examples of the elastic moduli include relaxation modulus (JP-A-11-52133), elastic modulus (JP-A-2001-272542, JP-A-2000-321992, JP-A-2000-162584 and JP-A-2000-155215), and shear modulus (JP-A-2001-272544).

It is considered effective to lower the gel fraction of the adhesive for sticking the polarizing plate or optical compensation film to the liquid crystal cell and hence relax the shrinkage stress as disclosed in JP-A-2000-155213.

Heretofore, it has been practiced to use a soft adhesive so as to cause the aforementioned stress relaxation. It has also been practiced to design the adhesion of the adhesive so low as to provide the polarizing plate with reworkability as disclosed in JP-A-11-258419, JP-A-2000-9973 and JP-A-2004-78171.

### DISCLOSURE OF THE INVENTION

An aim of the invention is to provide a polarizing plate having a high optical performance and little light leakage at the periphery of screen due to change of temperature and humidity or continuous lighting of liquid crystal display device and a liquid crystal display device comprising the polarizing plate. Another aim of the invention is to provide a polarizing plate having a high optical compensation function and little light leakage at the periphery of screen due to change of temperature and humidity or continuous lighting of liquid crystal display device and a liquid crystal display device comprising the polarizing plate.

The inventors made extensive studies. As a result, it has been found that the stress on the protective film and adhesive layer due to shrinkage of the polarizing plate can be inhibited by using a specific composition as the adhesive layer provided on the side where the polarizing plate is stuck to the glass sheet of the liquid crystal cell, making it possible to eliminate the occurrence of light leakage in the periphery of screen due to change of temperature and humidity or continuous lighting.

The inventors made further extensive studies on liquid crystal display device comprising a liquid crystal cell having a polarizing plate provided on both sides thereof wherein the absorption axis of the polarizing plates are perpendicular to each other and are parallel to the longer side or shorter side of the liquid crystal cell. As a result, it has been found that unlike a liquid crystal display device comprising a liquid crystal cell having a polarizing plate provided on both sides thereof wherein the absorption axis of the polarizing plates are perpendicular to each other and are disposed at angle of 45° with respect to the longer side or shorter side of the liquid crystal cell, the occurrence of light leakage in the periphery of screen due to shrinkage stress of polarizer can be eliminated by using a hard adhesive layer with which the polarizing plate is stuck to the glass sheet of the liquid crystal cell.

The inventors further found that the temperature of the surface of the backlight in the liquid crystal display device has something to do with light leakage in the periphery of screen during continuous lighting of the liquid crystal display device. It has thus been found that the use of a backlight having a surface temperature of 40° C. or less makes it possible to eliminate the occurrence of light leakage in the periphery of screen during continuous lighting.

In other words, the invention concerns a polarizing plate and a liquid crystal display device having the following constitution with which the aforementioned aims of the invention are accomplished.

(1) A polarizing plate comprising:

a polarizer; and

at least two protective films provided on both sides of the polarizer,

wherein the polarizing plate has an adhesive layer provided on at least one side of the polarizing plate, and

wherein the adhesive layer is formed by spreading an adhesive comprising a (meth)acrylic copolymer composition comprising:

(A) 100 parts by mass of a copolymer comprising:
(a₁) a (meth)acrylic acid ester monomer having Tg of less than −30° C. in a form of homopolymer in a mass proportion of 75% by mass or more as calculated in terms of monomer unit;
(a₂) a vinyl group-containing compound having Tg of −30° C. or more in a form of homopolymer in a mass proportion of 25% by mass or less as calculated in terms of monomer unit; and
(a₃) a functional group-containing monomer reactive with a polyfunctional compound (B) in an amount of 10 parts by mass or less based on 100 parts by mass of a sum of the mass of the monomer (a₁) and the compound (a₂); and

(B) from 0.005 to 5 parts by mass of a polyfunctional compound having at least two functional groups in a molecule, and the at least two functional groups can react with a functional group in the functional group-containing monomer (a₃) to form a crosslinked structure, and

wherein a gel fraction of the adhesive is from not smaller than 40% by mass to not greater than 90% by mass.

(2) A polarizing plate comprising:

a polarizer; and

at least two protective films provided on both sides of the polarizer,

wherein the polarizing plate has an adhesive layer provided on at least one side of the polarizing plate, and

wherein the adhesive layer is formed by spreading an adhesive comprising a (meth)acrylic copolymer composition comprising:

(A₁) 100 parts by mass of a copolymer having a mass-average molecular mass of 1,000,000 or more comprising:
(a₁₁) a (meth)acrylic acid ester monomer having Tg of less than −30° C. in a form of homopolymer in a mass proportion of 75% by mass or more as calculated in terms of monomer unit;
(a₁₂) a vinyl group-containing compound having Tg of −30° C. or more in a form of homopolymer in a mass proportion of 25% by mass or less as calculated in terms of monomer unit; and
(a₁₃) a functional group-containing monomer reactive with a polyfunctional compound (B) in an amount of 10 parts by mass or less based on 100 parts by mass of a sum of the mass of the monomer (a₁₁) and the compound (a₁₂); and

(A₂) from 20 to 200 parts by mass of a copolymer having a mass-average molecular mass of 100,000 or less comprising:
(a₂₁) a (meth)acrylic acid ester monomer having Tg of less than −30° C. in a form of homopolymer in a mass proportion of 75% by mass or more as calculated in terms of monomer unit;
(a₂₂) a vinyl group-containing compound having Tg of −30° C. or more in a form of homopolymer in a mass proportion of 25% by mass or less as calculated in terms of monomer unit; and
(a₂₃) a functional group-containing monomer reactive with a polyfunctional compound (B) in an amount of 10 parts by mass or less based on 100 parts by mass of a sum of the mass of the monomer (a₂₁) and the compound (a₂₂); and

(B) from 0.005 to 5 parts by mass of a polyfunctional compound having at least two functional groups in a molecule, and the at least two functional groups can react with a functional group in the functional group-containing monomers (a₁₃) and (a₂₃) to form a crosslinked structure, and

wherein a gel fraction of the adhesive is from not smaller than 40% by mass to not greater than 90% by mass, and

wherein an amount of repeating units derived from the functional group-containing monomers (a₁₃) and (a₂₃) incorporated in the (meth)acrylic copolymers (A₁) and (A₂), respectively, satisfies a percent functional group distribution range of from 0 to 15% by mass defined by numerical formula (1):

Percent functional group distribution=[mass of repeating units derived from functional group-containing monomer (a₂₃) in (meth)acrylic copolymer (A₂)/mass of repeating units derived from functional group-containing monomer (a₂₃) in (meth)acrylic copolymer (A₁)]×100 (1)

(3) The polarizing plate as described in (1) or (2) above,

wherein the (meth)acrylic copolymer A has a glass transition temperature of 0° C. or less.

(4) The polarizing plate as described in any (1) to (3) above,

wherein the adhesive layer exhibits a creep of less than 70 μm when subjected to a load of 200 g in a 50° C. atmosphere for 1 hour while being stuck to an alkali-free glass sheet at an area of 10 mm width and 10 mm length.

(5) The polarizing plate as described in any of (1) to (4) above,

wherein the adhesive layer exhibits a creep of less than 40 μm when subjected to a load of 200 g in a 50° C. atmosphere for 1 hour while being stuck to an alkali-free glass sheet at an area of 10 mm width and 10 mm length.

(6) The polarizing plate as described in any of (1) to (5) above,

wherein the adhesive layer exhibits a 90° peel adhesion of 10 N/25 mm width or more with respect to an alkali-free glass sheet in a 25° C. atmosphere.

(7) The polarizing plate as described in any of (1) to (6) above,

wherein the adhesive layer exhibits a 90° peel adhesion of 10 N/25 mm width or more with respect to an alkali-free glass sheet at any measuring temperature between 0° C. and 90° C. after processed in a 70° C. atmosphere for 5 hours.

(8) The polarizing plate as described in any of (1) to (7) above,

wherein the adhesive layer has an elastic modulus of 0.08 MPa or more.

(9) The polarizing plate as described in any of (1) to (8) above,

wherein the adhesive layer has an elastic modulus of 0.06 MPa or more at 90° C.

(10) The polarizing plate as described in any of (1) to (9) above,

wherein the adhesive layer has a shear modulus of from 0.1 GPa to 100 GPa.

(11) The polarizing plate as described in any of (1) to (10) above,

wherein a gel fraction of the adhesive is from not smaller than 60% by mass to not greater than 90% by mass.

(12) The polarizing plate as described in any of (1) to (11) above,

wherein the adhesive layer has a thickness of from 5 μm to 30 μm.

(13) The polarizing plate as described in any of (1) to (12) above,

wherein the adhesive has a surface tension of γ_{A} and a polarity component of γ_{A}^{p} satisfying numerical formulae (20) to (23), and at least one of the at least two protective films has a surface tension of γ_{F} and a polarity component of γ_{F}^{p} satisfying numerical formulae (20) to (23),

30≦γ_{A}≦45 (20)

5≦γ_{A}≦15 (21)

50≦γ_{F}≦75 (22)

20≦γ_{F}^{P}≦45 (23)

wherein each of γ_{A}, γ_{A}^{p}, γ_{F}, and γ_{F}^{p} has a unit of mN/m.

(14) The polarizing plate as described in any of (1) to (13) above,

wherein at least one of the at least two protective films has a front retardation value Reλ and a thickness direction retardation value Rthλ satisfying numerical formulae (2) and (3):

0 nm≦Re₅₉₀≦200 nm (2)

0 nm≦Rth₅₉₀≦400 nm (3)

wherein each of Re₅₉₀ and Rth₅₉₀ is a value at a wavelength λ of 590 nm, and has a unit of nm.

(15) The polarizing plate as described in any of (1) to (14) above,

wherein at least one of the at least two protective films is a cellulose acylate film comprising, as a main polymer component, a cellulose acylate which is a mixed aliphatic acid ester of cellulose in which a hydroxyl group of cellulose is substituted by an acetyl group and an acyl group having 3 or more carbon atoms, and

wherein a degree A of substitution of the cellulose acylate by the acetyl group and a degree B of substitution of the cellulose acylate by the acyl group having 3 or more carbon atoms satisfy numerical formulae (4) and (5):

2.0≦A+B≦3.0 (4)

0<B (5)

(16) The polarizing plate as described in (15) above,

wherein the acyl group having 3 or more carbon atoms is a propionyl group or butanoyl group.

(17) The polarizing plate as described in (15) or (16) above,

wherein a degree of substitution of 6-position hydroxyl group in the cellulose is 0.75 or more.

(18) The polarizing plate as described in any of (1) to (17) above,

wherein at least one of the at least two protective films is a film comprising a cellulose acylate obtained by substituting a hydroxyl group in a glucose unit constituting the cellulose by an acyl group having two or more carbon atoms, and

wherein supposing that degrees of substitution of a 2-position hydroxyl group, a 3-position hydroxyl group and a 6-position hydroxyl group in the glucose unit constituting the cellulose by the acyl group having two or more carbon atoms are DS₂, DS₃ and DS₆, respectively, the degrees satisfy numerical formulae (6) and (7):

2.0≦DS₂+DS₃+DS₆≦3.0 (6)

DS₆/(DS₂+DS₃+DS₆)≧0.315 (7)

(19) The polarizing plate as described in (18) above,

wherein the acyl group is an acetyl group.

(20) The polarizing plate as described in any of (1) to (19) above,

wherein at least one of the at least two protective films comprises at least one retardation developer which is a rod-like compound or a disc-shaped compound.

(21) The polarizing plate as described in any of (1) to (20) above,

wherein at least one of the at least two protective films is a cycloolefin-based polymer.

(22) The polarizing plate as described in any of (1) to (21) above,

wherein at least one of the at least two protective films has a front retardation value Reλ and a thickness direction retardation value Rthλ satisfying numerical formulae (8) to (11):

0≦|Re₅₉₀|≦10 (8)

|Rth₅₉₀|≦25 (9)

|Re₄₀₀−Re₇₀₀|≦10 (10)

|Rth₄₀₀−Rth₇₀₀|≦35 (11)

wherein each of Re₅₉₀ and Rth₅₉₀ is a value at a wavelength λ of 590 nm, and has a unit of nm;

each of Re₄₀₀ and Rth₄₀₀ is a value at a wavelength λ of 400 nm, and has a unit of nm; and

each of Re₇₀₀ and Rth₇₀₀ is a value at a wavelength λ of 700 nm, and has a unit of nm.

(23) The polarizing plate as described in (22) above,

wherein at least one of the at least two protective films comprises:

a cellulose acylate film having an acyl substitution degree of from 2.85 to 3.00; and

at least one compound for lowering Reλ and Rthλ in an amount of from 0.01 to 30% by mass based on a solid content of the cellulose acylate.

(24) The polarizing plate as described in any of (1) to (23) above,

wherein an optically anisotropic layer is provided on at least one of the at least two protective films.

(25) The polarizing plate as described in any of (1) to (24) above,

wherein at least one of the at least two protective films comprises at least one of plasticizer, ultraviolet absorbent, peel accelerator, dye and matting agent.

(26) The polarizing plate as described in any of (1) to (25) above,

wherein at least one of hard coat layer, anti-glare layer and anti-reflection layer is provided on a surface of at least one of the at least two protective films.

(27) A liquid crystal display device comprising:

a liquid crystal cell; and

a plurality of polarizing plates,

wherein at least one of the plurality of polarizing plates is a polarizing plate as described in any of (1) to (26) above.

(28) A liquid crystal display device comprising:

a liquid crystal cell; and

a polarizing plate as described in (26) above,

wherein the at least one of the at least two protective films having at least one of hard coat layer, anti-glare layer and anti-reflection layer is disposed on a side of the polarizing plate opposite to the liquid crystal cell.

(29) The liquid crystal display device as described in (27) or (28) above, which comprises a pair of polarizing plates,

wherein the liquid crystal cell is disposed interposed between the pair of polarizing plates, and

wherein a transmission axis of the pair of polarizing plates are disposed perpendicular to each other and disposed perpendicular or parallel to a side of the pair of polarizing plates.

(30) The liquid crystal display device as described in any of (27) to (29) above,

wherein the liquid crystal cell is a VA mode.

(31) The liquid crystal display device as described in any of (27) to (30) above,

wherein a backlight having a surface temperature of 40° C. or less is utilized.

(32) The liquid crystal display device as described in (31) above,

wherein one of light-emitting diode and two-dimensionally laminated fluorescent lamp is utilized as a source of a backlight.

### BRIEF DESCRIPTION OF THE DRAWING

FIG. 1 is a diagrammatic view illustrating an example of the method of laminating a cellulose acylate film during the production of a polarizing plate according to the invention;

FIG. 2 is a view diagrammatically illustrating an example of the sectional configuration of a polarizing plate according to the invention;

FIG. 3 is a view diagrammatically illustrating an example of the sectional configuration of a liquid crystal display device according to the invention; and

FIG. 4 is a diagram illustrating the measurement of the creep of an adhesive of the invention,

wherein 1 denotes Polarizer, 2 denotes Transmission axis, 3 denotes TAC1: protective film (cellulose acylate film which is preferably used in the invention), 4 denotes Slow axis, 11: denotes Polarizer, 12 denotes TAC1 or TAC3: (liquid crystal cell side) protective film (cellulose acylate film which is preferably used in the invention), 13 denotes TAC2: protective film (on the side opposite liquid crystal cell), 14 denotes Functional layer (hard coat layer, anti-glare layer, anti-reflection layer) (22-21-23: viewising side polarizing plate), 21 denotes Polarizer, 22 denotes TAC1: liquid crystal cell side protective film, 23 denotes TAC2: protective film on side opposite liquid crystal cell (32-31-33: backlight side polarizing plate), 31 denotes Polarizer, 32 dentoes TAC3: liquid crystal cell side protective film, 33 denotes TAC2: protective film on side opposite liquid crystal cell, 40 denotes VA mode liquid crystal cell, 50 denotes Viewing side, 60 denotes Backlight side, 70 denotes Glass sheet, 80 denotes Adhesive layer and 90 denotes Polarizing plate.

### BEST MODE FOR CARRYING OUT THE INVENTION

The invention will be further described hereinafter. The term “(numerical value 1) to (numerical value 2)” as used hereinafter is meant to indicate “(numerical value 1) to (numerical value 2), both inclusive”. The term “(meth)acryloyl” as used hereinafter is meant to indicate “at least any of acryloyl and methacryloyl”. This can apply to “(meth)acrylate”, “(meth)acrylic acid”, etc.

<Adhesive Layer>

Firstly, the adhesive layer according to the invention will be described hereinafter. When a liquid crystal display device is allowed to stand at high temperatures, the ambient temperature and humidity are changed from high temperature and humidity to low temperature and humidity or the backlight is continuously lighted, the polarizing plate shows a dimensional change that can cause the adhesive layer to be foamed or exfoliated from the adherend such as liquid crystal cell. The related art adhesive layer has heretofore been improved to withstand the aforementioned severe conditions by raising the molecular mass or crosslinking degree of the adhesive.

On the other hand, in a liquid crystal display device comprising a liquid crystal cell having a polarizing plate provided on both sides thereof wherein the absorption axis of the polarizing plates are perpendicular to each other and are disposed at angle of 45° with respect to the longer side or shorter side of the liquid crystal cell such as TN mode liquid crystal display device, a problem has appeared that internal stress developed due to dimensional change of the polarizing plate after prolonged use is concentrated on the periphery of the polarizing plate, causing the occurrence of light leakage in the periphery of screen of the liquid crystal display device. The occurrence of light leakage can be eliminated by relaxing the internal stress due to dimensional change of the polarizing plate. The relaxation of internal stress has been realized by allowing the adhesive layer to follow the dimensional change of the polarizing plate.

However, the result of studies made by the inventors show that the occurrence of light leakage in the periphery of screen due to shrinkage stress of polarizer in a liquid crystal display device comprising a liquid crystal cell having a polarizing plate provided on both sides thereof wherein the absorption axis of the polarizing plates are perpendicular to each other and are parallel to the longer side or shorter side of the liquid crystal cell such as VA mode liquid crystal display device can be eliminated by using a hard adhesive layer to stick the polarizing plate to the glass sheet of liquid crystal cell as opposed to the TN mode.

However, when a hard adhesive layer is used as mentioned above, the adhesion of the adhesive layer decreases, causing foaming or exfoliation under severe conditions. The inventors found that when the adhesive layer is three-dimensionally crosslinked (gelated) to harden itself, the dimensional change of the polarizing plate can be prevented. Further, the use of a (meth)acrylic acid ester having a low Tg value in the form of homopolymer, that is, a soft (meth)acrylic acid ester as an adhesive makes it possible to secure desired adhesion as well. Moreover, the aforementioned adhesion and hardness can be well balanced by properly adjusting the distribution of molecular mass (ratio of high molecular components to low molecular components), proportion of monomer components (low Tg, high Tg) constituting the copolymer and the degree of three-dimensional crosslinking.

### [(Meth)Acrylic Copolymer: (A) {and A₁ and A₂}]

(a₁), (a₁₁), (a₂₁): (Meth)acrylic acid ester monomer having Tg of less than −30° C. in the form of homopolymer

In order to relax internal stress, a (meth)acrylic acid ester monomer having Tg of less than −30° C., preferably less than −40° C., more preferably less than −50° C. in the form of homopolymer is used. Examples of the (meth)acrylic acid ester having Tg of less than −30° C. include ethyl acrylate, propyl acrylate, n-butyl acrylate, n-pentyl acrylate, n-hexyl acrylate, n-heptyl acrylate, n-octyl acrylate, n-nonyl acrylate, n-decyl acrylate, 2-methoxyethyl acrylate, ethoxymethyl acrylate, 2-ethoxyethyl acrylate, 3-ethoxypropyl acrylate, n-octyl methacrylate, n-nonyl methacrylate, n-decyl methacrylate, n-undecacyl methacrylate, n-dodecyl methacrylate, and n-tridecyl methacrylate.

(a₂), (a₁₂), (a₂₂): Vinyl group-containing compound having Tg of −30° C. or more in the form of homopolymer

Examples of the vinyl compound having Tg of −30° C. or more in the form of homopolymer include (meth)acrylates such as methyl acrylate, i-butyl acrylate, t-butyl acrylate, cyclohexyl acrylate, benzyl acrylate, n-undecacyl acrylate, n-dodecyl acrylate, n-tridecyl acrylate, n-tetradecyl acrylate, n-pentadecyl acrylate, n-hexadecyl acrylate, methyl methacrylate, ethyl methacrylate, propyl methacrylate, n-butyl methacrylate, i-butyl methacrylate, t-butyl methacrylate, n-pentyl methacrylate, n-hexyl methacrylate, cyclohexyl methacrylate, benzyl methacrylate, n-heptyl methacrylate, n-tetradecyl methacrylate, n-pentadecyl methacrylate and n-hexadecyl methacrylate. Other examples of the vinyl compound include vinyl acetate, styrene, methyl styrene, vinyl toluene, acrylonitrile, (meth)acrylamide, and N-methyl acrylamide.

### [Measurement of Tg]

For the measurement of Tg in the form of homopolymer, a Type DSC2910 differential scanning calorimeter (produced by TA Instruments Inc.) was used. The polymer was put in an aluminum pan where it was then heated from −160° C. to +100° C. at a rate of 10° C./min and cooled from +100° C. to −160° C. From the data of temperature drop was then determined Tg.

In the invention, referring to the mass proportion of the repeating unit RUs derived from the aforementioned (meth)acrylic acid ester having Tg of less than −30° C. in the form of homopolymer to the repeating unit RU_{H} derived from the vinyl compound having Tg of −30° C. or more, the proportion of RUs and RU_{H} are 75 parts by mass or more and 25 parts by mass or less, respectively, as calculated in terms of monomer unit. (In this specification, parts by mass and % by mass are equal to parts by weight and % by weight, respectively.) The proportion of RUs and RU_{H} may be 100 parts by mass and 0 parts by mass, respectively. In the invention, however, a copolymer of the (meth)acrylic acid ester having Tg of less than −30° C. in the form of homopolymer and the vinyl compound having Tg of −30° C. or more in the form of homopolymer is preferably used. In this arrangement, the cohesiveness of the adhesive layer can be enhanced, making it possible to enhance the properties such as adhesion, water resistance, transparency and workability of the adhesive layer.

The proportion of RUs and RU_{H} are more preferably 85 parts by mass or more and 15 parts by mass or less, respectively, most preferably 95 parts by mass or more and 5 parts by mass or less, respectively.

(a₃), (a₁₃), (a₂₃): Functional group-containing monomer reactive with polyfunctional compound (B)

Examples of the functional group-containing monomer reactive with polyfunctional compound include monomers containing carboxyl group such as (meth)acrylic acid, β-carboxyethyl acrylate, itaconic acid, crotonic acid, maleic acid, maleic anhydride and butyl maleate, monomers containing hydroxyl group such as 2-hydroxyethyl (meth)acrylate, 2-hydroxypropyl (meth)acrylate, 4-hydroxybutyl (meth)acrylate, chloro-2-hydroxypropyl (meth)acrylate, diethylene glycol mono(meth)acrylate and allyl alcohol, monomers containing amino group such as aminomethyl (meth)acrylate, dimethylaminomethyl (meth)acrylate, diemethylaminoethyl (meth)acrylate, dimethylaminopropyl (meth)acrylate and vinyl pyridine, monomers containing epoxy group such as glycidyl (meth)acrylate and monomers containing acetoacetyl group such as acetoacetoxyethyl (meth)acrylate. These functional group-containing monomers may be used singly or in combination.

Preferred among these functional group-containing monomers are monomers containing carboxyl group and monomers containing hydroxyl group.

The (meth)acrylic copolymer (A) (and (A₁), (A₂) described later) as a main component of the (meth)acrylic copolymer composition constituting the adhesive layer in the invention is a copolymer of the aforementioned (meth)acrylic acid ester (a₁) {or (a₁₁), (a₂₁)} having Tg of less than −30° C. in the form of homopolymer and the vinyl compound (a₂) {or (a₁₂), (a₂₂)} having Tg of −30° C. or more in the form of homopolymer with a functional group-containing monomer (a₃) (or (a₁₃), (a₂₃)) reactive with the polyfunctional compound (B) described later in an amount of 10 parts by mass or less, preferably from 0.5 to 10 parts by mass based on 100 parts by mass of the sum of the mass of the (meth)acrylic acid ester (a₁) and vinyl compound (a₂).

By copolymerizing the (meth)acrylic acid ester (a₁) {or (a₁₁), (a₂₁)} and the vinyl compound (a₂) {or (a₁₂), (a₂₂)} with the functional group-containing monomer (a₃) (or (a₁₃), (a₂₃)) reactive with the polyfunctional compound in the above defined amounts, a copolymer composition which can be bonded to the polyfunctional compound (B) to exhibit a good adhesion can be formed.

### [Polyfunctional Compound: (B)]

The adhesive layer for polarizing plate of the invention contains a polyfunctional compound (B) having a reactive functional group.

The functional group contained in this compound reacts with the reactive functional group in the aforementioned (meth)acrylic polymer (A) {and (A₁), (A₂)} and has at least two, preferably from 2 to 4 functional groups per molecule.

Examples of the aforementioned polyfunctional compound (B) include isocyanate-based compounds, epoxy-based compounds, amine-based compounds, metal chelate-based compounds, and aziridine-based compounds.

Examples of the isocyanate-based compounds include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylyelene diisocyanate, naphthalene diisocyanate, triphenylmethane triisocyanate, polymethyleene polyphenyl isocyanate, and adducts thereof with polyols such as trimethylolpropane.

Examples of the epoxy-based compounds include bisphenol A type epoxy resins, epichlorohydrin type epoxy resins, ethylene glycol glycidnyl ether, polyethylene glycol diglycidyl ether, glycerin diglycidyl ether, glycerin triglycidyl ether, 1,6-hexanediol diglycidyl ether, trimethyolpropane triglycidyl ether, diglycidyl aniline, diglycidylamine, N,N,N′,N′-tetraglycidyl-m-xylenediamine, and 1,3-bis(N,N′-diglycidylaminomethyl)cyclohexane.

Examples of the amine-based compounds include hexamethylene diamine, triethyl diamine, polyethyleneimine, hexamethylene tetramine, diethylene triamine, triethyl tetramine, isophorone diamine, amino resin such as urea resin and melamine resin, and methylene resin.

Examples of the metal chelate compound include compounds having a polyvalent metal such as aluminum, iron, copper, zinc, tin, titanium, nickel, antimony, magnesium, vanadium, chromium and zirconium oriented in acetyl acetone or ethyl acetoacetate.

Examples of the aziridine-based compound include N,N′-diphenyl methane-4,4′-bis(1-aziridine carboxide), N,N′-toluene-2,4-bis(1-aziridine carboxide), triethylene melamine, bisisophthaloyl-1-(2-methyl aziridine), tri-1-aziridinyl phosphine oxide, N,N′-hexamethylene-1,6-bis(1-aziridine carboxide), trimethylolpropane-tri-β-aziridinyl propionate, and tetramethylolmethane-tri-α-aziridinyl propionate.

Besides these compounds, dialdehyde, methylol polymers, acids, acid anhydrides, amino acids, etc. may be used.

The aforementioned polyfunctional compound (B) is normally used in an amount of from 0.005 to 5 parts by mass, preferably from 0.01 to 3 parts by mass based on 100 parts by mass of the aforementioned high molecular (meth)acrylic copolymer (A) {or (A₁), (A₂)}. When the polyfunctional compound (B) is used in the above defined amount, a suitable three-dimensional crosslinked structure is formed with the aforementioned high molecular (meth)acrylic copolymer. These polyfunctional compounds (B) may be used singly or in combination.

### [Production of (Meth)Acrylic Copolymer]

The production of the (meth)acrylic copolymer (A) constituting the adhesive layer for polarizing plate of the invention can be carried out by any known method. For example, the high molecular (meth)acrylic copolymer (A₁) having a mass-average molecular mass of 1,000,000 or more is synthesized by subjecting the monomers as starting material to bulk polymerization, solution polymerization, emulsion polymerization, suspension polymerization or the like, preferably solution polymerization, in the presence of a polymerization initiator (azo-based polymerization initiator such as azobisisobutylonitrile and azobiscyclohexanecarbonitrile, peroxide such as benzoyl peroxide and acetyl peroxide, photopolymerization initiator such as diphenyl ketone and 2-hydroxy-2-methyl-1-phenyl-propane-1-one) in an amount of from 0.01 to 1 parts by mass based on 100 parts by mass of the starting materials.

In the case of solution polymerization, as a polymerization solvent there is used ethyl acetate, toluene, hexane, acetone or the like. The reaction temperature is from 50° C. to 150° C., preferably from 50° C. to 110° C. The reaction time is from 3 to 15 hours, preferably from 5 to 10 hours.

Further, the low molecular (meth)acrylic (co)polymer (A₂) having a mass-average molecular mass of 100,000 or less is synthesized by bulk polymerization, solution polymerization, emulsion polymerization, suspension polymerization or the like, preferably solution polymerization, similarly to the high molecular acrylic copolymer (A₁). However, in order to reduce the mass-average molecular mass of the product to 100,000 or less, the amount of the polymerization initiator to be used is from about 10 to 100 times that of the high molecular acrylic copolymer. More preferably, mercaptane such as lauryl mercaptane, n-dodecyl mercaptane and n-octyl mercaptane and a chain transfer agent such as α-methylstyrene dimer and limonene are used.

### [Adhesive for Polarizing Plate]

The adhesive for polarizing plate of the invention can be produced by mixing the (meth)acrylic copolymer (A) and polyfunctional compound (B) thus produced. As the (meth)acrylic copolymer (A) there may be used either (A₁) or (A₂).

Alternatively, the adhesive for polarizing plate of the invention can be produced by mixing the high molecular (meth)acrylic copolymer (A₁), low molecular (meth)acrylic copolymer (A₂) and polyfunctional compound (B) thus produced. In other words, as the (meth)acrylic copolymer (A) there may be used both (A₁) and (A₂).

During this procedure, the low molecular (meth)acrylic (co)polymer (A₂) is used in an amount of from 20 to 200 parts by mass, preferably from 30 to 150 parts by mass based on 100 parts by mass of the aforementioned high molecular (meth)acrylic copolymer (A₁). The polyfunctional compound (B) is used in an amount of from 0.005 to 5 parts by mass, preferably from 0.01 to 3 parts by mass based on 100 parts by mass of the aforementioned high molecular (meth)acrylic copolymer (A₁).

Japanese Patent No. 3,533,589 discloses that the relaxation of internal stress can be accomplished by the use of a (meth)acrylic acid ester having a low Tg in the form of homopolymer as well as the formation of a three-dimensional crosslinked structure from a high molecular (meth)acrylate copolymer (A₁) in which three-dimensional crosslinked structure a low molecular (meth)acrylate copolymer (A₂) moves (slides). In the invention, the degree of relaxation of the internal stress can be properly adjusted by the amount of the repeating units derived from the functional group-containing monomers (a₁₃) and (a₂₃) incorporated in the (meth)acrylic copolymer (A₁) having a molecular mass as high as 1,000,000 or more and the (meth)acrylic copolymer (A₂) having a molecular mass as low as 100,000 or less. In some detail, the percent distribution of functional group defined by the following numerical formula (1) is preferably from 0% to 15% by mass, more preferably from 0% to 10% by mass.

Percent functional group distribution=[mass of repeating units derived from functional group-containing monomer (a₂₃) in (meth)acrylic copolymer (A₂)/mass of repeating units derived from functional group-containing monomer (a₃) in (meth)acrylic copolymer (A₁)]×100 (1)

The degree of three-dimensional crosslinking (gel fraction) in the adhesive is from not smaller than 40% to not greater than 90% by mass, preferably from not smaller than 60% to not greater than 90% by mass, more preferably from not smaller than 70% to not greater than 90% by mass.

When the degree of three-dimensional crosslinking falls within the above defined range, the adhesion and the relaxation can be balanced more significantly to advantage. The degree of three-dimensional crosslinking can be properly adjusted by the amount of the polymerizable monomer reactive with the polyfunctional compound or the amount of the polyfunctional compound.

The adhesive for polarizing plate of the invention is mainly composed of (meth)acrylic copolymer composition comprising a (meth)acrylic copolymer (A) {or high molecular (meth)acrylic copolymer (A₁) and low molecular (meth)acrylic copolymer (A₂)} and a polyfunctional compound (B) as mentioned above. The adhesive for polarizing plate may further comprise a weathering stabilizer, tackifier, plasticizer, softener, dye, pigment, silane coupling agent and inorganic filler such as electrically-conductive particulate material and light-scattering particulate material commonly incorporated in adhesives.

The glass transition temperature of the aforementioned (meth)acrylic copolymer (A) is preferably 0° C. or less, more preferably from −80° C. to −5° C., particularly from −60° C. to −10° C. When the glass transition temperature of the (meth)acrylic copolymer (A) is too high, the resulting adhesive layer exhibits a high resistance to cohesive failure during foaming or exfoliation at high temperatures but a low adhesion. On the contrary, when the glass transition temperature of the (meth)acrylic copolymer (A) is too low, the resulting adhesive layer exhibits a high adhesion but a low resistance to cohesive failure during foaming or exfoliation at high temperatures. Accordingly, in order to balance well the adhesion and the resistance of adhesive layer to cohesive failure during foaming or exfoliation at high temperatures, the glass transition temperature of the (meth)acrylic copolymer (A) needs to be adjusted to the above cited range.

<Protective Film>

The polarizing plate of the invention has a protective film provided on the both sides of a polarizer. As the protective film there may be used any protective film which is normally used as a protective film in the polarizing plate. In the invention, a cellulose acylate film or cycloolefin-based polymer is preferably used. The protective film provided on the both sides of the polarizer may be the same or different. For example, one of the protective film provided on the both sides of the polarizer may be the aforementioned cellulose acylate film while the other may be a cycloolefin-based polymer film. Alternatively, films having different formulations or optical properties may be used. Further, a polymer layer may be provided as a protective film on the cellulose acylate film or cycloolefin-based polymer film. For example, a polyimide layer may be provided as a protective film on the cellulose acylate film. The polarizing plate of the invention comprises an adhesive layer provided on the protective film provided on at least one side thereof (one side of polarizer) or between the protective film and the polarizer with other functional group interposed therebetween.

{Cellulose Acylate Film}

The cellulose acylate film which is preferably used in the invention will be further described hereinafter.

The cellulose acylate film which is preferably used in the invention is formed by a specific cellulose acylate as a raw material. Cellulose acylates are distinguished between in the case where the developability of optical anisotropy is raised and in the case where the developability of optical anisotropy is reduced.

(Cellulose Acylate to be Used in the Case where a Great Optical Anisotropy is Required)

Firstly, the cellulose acylate to be used in the invention in the case where the development of a great optical anisotropy is required will be further described. In the invention, two or more different cellulose acylates may be used in admixture.

The aforementioned specific cellulose acylate is a mixed aliphatic ester of cellulose obtained by substituting the hydroxyl group in a cellulose by an acetyl group and an acyl group having 3 or more carbon atoms wherein the degree of substitution of hydroxyl group in the cellulose satisfies the following numerical formulae (4) and (5):

2.0≦A+B≦3.0 (4)

0<B (5)

wherein A and B represent the degree of substitution of hydroxyl group in the cellulose by acetyl group and acyl group having 3 or more carbon atoms, respectively.

The β-1,4 bonding glucose unit constituting cellulose has a free hydroxyl group in the 2-, 3- and 6-positions. The cellulose acylate is a polymer obtained by esterifying some or whole of these hydroxyl groups by acyl group. The degree of substitution by acyl group means the percent esterification of cellulose in each of 2-, 3- and 6-positions (100% esterification means substitution degree of 1).

In the invention, the sum (A+B) of the degree of substitution of hydroxyl groups A and B is preferably from 2.0 to 3.0, more preferably from 2.2 to 2.9, particularly from 2.40 to 2.85 as shown in the numerical formula (4). The degree of substitution of hydroxyl group B is preferably more than 0, more preferably 0.6 or more as shown in the numerical formula (5). When the sum (A+B) is 2.0 or more, the resulting cellulose acylate film is advantageous in that it doesn't exhibit too high a hydrophilicity and thus is not subject to the effect of ambient humidity.

Referring further to B in the numerical formula (5), the hydroxyl groups in the 6-position are preferably substituted in a proportion of not smaller than 28%, more preferably not smaller than 30%, even more preferably not smaller than 31%, particularly not smaller than 32%.

Further, the sum of the degrees A and B of substitution in the 6-position of cellulose acylate is preferably 0.75 or more, more preferably 0.80 or more, particularly 0.85 or more. A solution for the preparation of a film having desirable solubility and filterability can be prepared from the cellulose acylate film. A good solvent can be prepared even with a nonchlorine-based organic solvent. A solution having a lower viscosity and better filterability can be prepared.

In the case where the cellulose acylate film is a protective film disposed on the liquid crystal cell side of the polarizing plate, supposing that the degree of substitution of hydroxyl group in the 2-position of glucose unit constituting cellulose is DS₂, the degree of substitution of hydroxyl group in the 3-position of glucose unit constituting cellulose is DS₃ and the degree of substitution of hydroxyl group in the 6-position of glucose unit constituting cellulose is DS₆, the following numerical formulae (6) and (7) are preferably satisfied:

2.0≦DS₂+DS₃+DS₆≦3.0 (6)

DS₆/(DS₂+DS₃+DS₆)≧0.315 (7)

When the aforementioned numerical formulae (6) and (7) are preferably satisfied, the resulting cellulose acylate film exhibits an enhanced solubility in solvent and a reduced temperature dependence of optical anisotropy to advantage.

Further, the aforementioned acyl group is preferably an acetyl group because saponification can easily proceed, the elastic modulus is raised, the dimensional change is reduced, the durability is raised and the cost is reduced.

The aforementioned acyl group having 3 or more carbon atoms may be an aliphatic or aromatic hydrocarbon group and is not specifically limited. Examples of the aliphatic or aromatic hydrocarbon group include alkylcarbonyl ester, alkenylcarbonyl ester, aromatic carbonylester and aromatic alkylcarbonylester of cellulose which may have substituted groups.

Preferred examples of the acyl group having 3 or more carbon atoms include propionyl, butanoyl, keptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl, and cinnamoyl. Preferred among these acyl groups are propionyl, butanoyl, dodecanoyl, octadecanoyl, t-butanoyl, oleoyl, benzoyl, naphthylcarbonyl, and cinnamoyl. Particularly preferred among these acyl groups are propionyl and butanoyl.

In the case of propionyl group, the substitution degree B is preferably 1.3 or more.

Specific examples of the aforementioned mixed aliphatic cellulose acylate include cellulose acetate propionate, and cellulose acetate butyrate.

(Cellulose Acylate to be Used in the Case where a Small Optical Anisotropy is Required)

In the case where a small optical anisotropy is required, the degree of substitution of hydroxyl group in the cellulose by acyl group is preferably from 2.50 to 3.00, more preferably from 2.75 to 3.00, even more preferably from 2.85 to 3.00.

The C₂-C₂₂ acyl group by which the hydroxyl group in the cellulose is substituted may be either an aliphatic group or an allyl group and is not specifically limited. These acyl groups may be used singly or in admixture of two or more thereof. Examples of the acyl group include alkylcarbonyl ester of cellulose, alkenylcarbonyl ester of cellulose, aromatic carbonyl ester of cellulose, and aromatic alkylcarbonyl ester of cellulose. These acyl groups may each have substituents. Preferred among these acyl groups are acetyl, propionyl, butanoyl, heptanoyl, hexanoyl, octanoyl, decanonyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl. Preferred among these acyl groups are acetyl, propionyl, butanoyl, decanonyl, octadecanoyl, t-butanoyl, oleoyl, benzoyl, naphthylcarbonyl, and cinnamoyl. Particularly preferred among these acyl groups are acetyl, propionyl and butanoyl.

In the case where the cellulose acylate film is composed of at least two of acetyl group, propionyl group and butanoyl group among the acyl substituents by which the hydroxyl group in the aforementioned cellulose, the total substitution degree is preferably from 2.5 to 3.00. More preferably, the degree of substitution by acyl group is from 2.75 to 3.00, even more preferably from 2.85 to 3.00. When the degree of substitution falls within the above cited range, the optical anisotropy of the cellulose acylate film can be sufficiently reduced to advantage.

### (Method of Synthesizing Cellulose Acylate)

A basic principle of the method of synthesizing cellulose acylate is described in Migita et al, “Mokuzai Kagaku (Wood Chemistry)”, pp. 180-190, Kyoritsu Shuppan, 1968. A typical synthesis method involves liquid phase acetylation in the presence of a carboxylic anhydride-acetic acid-sulfuric acid catalyst.

In order to obtain the aforementioned cellulose acylate, a cellulose material such as cotton linter and wood pulp is pretreated with a proper amount of acetic acid, and then put in a carboxylated mixture which has been previously cooled to undergo esterification to synthesize a complete cellulose acylate (the sum of degrees of substitution by acyl in the 2-, 3- and 6-positions is almost 3.00).

The aforementioned carboxylated mixture normally comprises acetic acid as a solvent, carboxylic anhydride as an esterifying agent and sulfuric acid as a catalyst. The carboxylic anhydride is normally used stoichiometrically in excess of the sum of the amount of cellulose reacting with the carboxylic anhydride and water content present in the system. The termination of the esterification reaction is followed by the addition of an aqueous solution of a neutralizing agent (e.g., carbonate, acetate or oxide of calcium, magnesium, iron, aluminum or zinc) for the purpose of hydrolyzing excessive carboxylic anhydride left in the system and neutralizing part of the esterification catalyst.

Subsequently, the complete cellulose acylate thus obtained is kept at a temperature of from 50 to 90° C. in the presence of a small amount of an acetylation reaction catalyst (normally remaining sulfuric acid) to undergo saponification ripening that causes the conversion to cellulose acylate having a desired acyl substitution degree and polymerization degree. At the time when such a desired cellulose acylate is obtained, the catalyst remaining in the system is completely neutralized with a neutralizing agent mentioned above or the cellulose acylate solution is put in water or diluted sulfuric acid without being neutralized (alternatively, water or diluted sulfuric acid is put in the cellulose acylate solution) to separate the cellulose acylate which is then washed and stabilized or otherwise processed to obtain the aforementioned specific cellulose acylate.

In the aforementioned cellulose acylate film, the polymer component constituting the film is preferably made substantially of the aforementioned specific cellulose acylate. The “substantially” as used herein is meant to indicate 55% or more (preferably 70% or more, more preferably 80% or more) of the polymer component.

The aforementioned cellulose acylate is preferably used in particulate form. 90% by mass or more of the particles used preferably have a particle diameter of from 0.5 to 5 mm. Further, 50% by mass or more of the particles used preferably have a particle diameter of from 1 to 4 mm. The particulate cellulose acylate preferably is in a form as much as close to sphere.

The polymerization degree of cellulose acylate which is preferably used in the invention is preferably from 200 to 700, more preferably from 250 to 550, even more preferably from 250 to 400, particularly from 250 to 350 as calculated in terms of viscosity-average polymerization degree. The average polymerization degree can be measured by an intrinsic viscosity method proposed by Uda et al (Kazuo Uda, Hideo Saito, “Seni Gakkaishi (JOURNAL OF THE SOCIETY OF FIBER SCIENCE AND TECHNOLOGY, JAPAN)”, No. 1, Vol. 18, pp. 105-120, 1962). For more details, reference can be made to JP-A-9-95538.

When low molecular components are removed, the resulting cellulose acylate has a raised average molecular mass (polymerization degree). However, the viscosity of the cellulose acylate is lower than that of ordinary acylates. Thus, as the aforementioned cellulose acylate, those freed of low molecular components are useful.

Cellulose acylates having a small content of low molecular components can be obtained by removing low molecular components from cellulose acylates which have been synthesized by an ordinary method. The removal of the low molecular components can be carried out by washing the cellulose acylate with a proper organic solvent. In order to produce the cellulose acylate having a small content of low molecular components, the amount of the sulfuric acid catalyst in the acetylation reaction is preferably adjusted to a range of from 0.5 to 25 parts by mass based on 100 parts by mass of cellulose acylate. When the amount of the sulfuric acid catalyst falls within the above defined range, a cellulose acylate which is desirable also in the light of molecular mass distribution (uniform molecular mass distribution) can be synthesized.

When used in the production of the cellulose acylate, the cellulose acylate preferably has a water content of 2% by mass or less, more preferably 1% by mass or less, particularly 0.7% by mass or less. A cellulose acylate normally contains water and is known to have a water content of from 2.5 to 5% by mass. In order to provide the cellulose acylate with a water content falling within this range in the invention, the cellulose acylate needs to be dried. The drying method is not specifically limited so far as the desired water content is attained.

For the details of cotton as starting material of the aforementioned cellulose acylate and its synthesis method, reference can be made to Kokai Giho No. 2001-1745, pp. 7-12, Mar. 15, 2001, Japan Institute of Invention and Innovation.

The cellulose acylate film which is preferably used in the invention can be obtained by filming a solution of the aforementioned specific cellulose acylate and optionally additives in an organic solvent.

### [Additives]

Examples of the additives which can be incorporated in the aforementioned cellulose acylate solution in the invention include plasticizer, ultraviolet absorber, deterioration inhibitor, retardation (optical anisotropy) developer, retardation (optical anisotropy) reducer, particulate material, peel accelerator, and infrared absorber. In the invention, the retardation developer is preferably used. It is also preferred that at least one of plasticizer, ultraviolet absorber and peel accelerator be used.

These additives may be in the form of solid material or oil-based material. In other words, these additives are not specifically limited in their melting point or boiling point. For example, ultraviolet absorbers having a melting point of 20° C. or less and 20° C. or more may be used in admixture with each other or a plasticizer. For details, reference can be made to JP-A-2001-151901.

### [Ultraviolet Absorber]

As the ultraviolet absorber there may be used an arbitrary kind of ultraviolet absorber depending on the purpose. Examples of the ultraviolet absorber employable herein include salicylic acid ester-based absorbers, benzophenone-based absorbers, benzotriazole-based absorbers, benzoate-based absorbers, cyano acrylate-based absorbers, and nickel complex salt-based absorbers. Preferred among these ultraviolet absorbers are benzophenone-based absorbers, benzotriazole-based absorbers, and salicylic acid ester-based absorbers.

Examples of the benzophenone-based ultraviolet absorbers include 2,4-dihydroxybenzophenone, 2-hydroxy-4-acetoxybenzopheone, 2-hydroxy-4-methoxy benzophenone, 2,2′-di-hydroxy-4-metoxybenzopheone, 2,2′-di-hydroxy-4,4′-metoxybenzophenone, 2-hydroxy-4-n-octoxybenzophenone, 2-hydroxy-4-dodecyloxy benzophenone, and 2-hydroxy-4-(2-hydroxy-3-methacryloxy)propoxybenzophenone.

Examples of the benzotriazole-based ultraviolet absorbers include 2(2′-hydroxy-3′-tert-butyl-5′-methylphenyl)-5-chlorobenzotriazole, 2(2′-hydroxy-5′-tert-butylphenyl)benzotriazole, 2(2′-hydroxy-3′,5′-di-tert-amylphenyl)benzotriazole, 2(2′-hydroxy-3′,5′-di-tert-butylphenyl)-5-chlorobenzotriazole, and 2(2′-hydroxy-5′-tert-octylphenyl)benzotriazole.

Examples of the salicylic acid ester-based absorbers include phenyl salicylate, p-octylphenyl salicylate, and p-tert-butyl phenyl salicylate.

Particularly preferred among these exemplified ultraviolet absorbers are 2-hydroxy-4-methoxybenzophenone, 2,2′-di-hydroxy-4,4′-methoxy benzophenone, 2(2′-hydroxy-3′-tert-butyl-5′-methyl phenyl)-5-chlorobenzotriazole, 2(2′-hydroxy-5′-tert-butylphenyl)benzotriazole, 2(2′-hydroxy-3′,5′-di-tert-amylphenyl)benzotriazole, and 2(2′-hydroxy-3′,5′-di-tert-butyphenyl)-5-chlorobenzotriazole.

A plurality of ultraviolet absorbers having different absorption wavelengths are preferably used to obtain a high barrier effect within a wide wavelength range. As the ultraviolet absorber for liquid crystal there is preferably used one having an excellent absorption of ultraviolet rays having a wavelength of 370 nm or less from the standpoint of prevention of deterioration of liquid crystal or one having little absorption of visible light having a wavelength of 400 nm or more. Particularly preferred examples of the ultraviolet absorbers include benzotriazole-based compounds and salicylic acid ester-based compounds previously exemplified. Preferred among these ultraviolet absorbers are benzotriazole-based compounds because they cause little unnecessary coloration of cellulose ester.

As the ultraviolet absorbers there may be used also compounds disclosed in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

The amount of the ultraviolet absorbers to be incorporated is preferably from 0.001 to 5% by mass, more preferably from 0.01 to 1% by mass based on the cellulose acylate. When the amount of the ultraviolet absorbers to be incorporated exceeds 0.001% by mass, the desired effect of these ultraviolet absorbers can be sufficiently exerted. Further, when the amount of the ultraviolet absorbers to be incorporated falls below 5% by mass, it is possible to inhibit the bleed out of ultraviolet absorbers to the surface of the film.

Further, the ultraviolet absorber may be added at the same time as the dissolution of cellulose acylate or may be added to the dope prepared by dissolution. It is particularly preferred that using a static mixer, an ultraviolet absorber be added to the dope which is ready to be casted because the spectral absorption characteristics can be easily adjusted.

### [Deterioration Inhibitor]

The aforementioned deterioration inhibitor can be used to prevent the deterioration or decomposition of cellulose triacetate, etc. Examples of the deterioration inhibitor include compounds such as butylamine, hindered amine compound (JP-A-8-325537), guanidine compound (JP-A-5-271471), benzotriazole-based ultraviolet absorber (JP-A-6-235819) and benzophenone-based ultraviolet absorber (JP-A-6-118233).

### [Plasticizer]

As the plasticizer there is preferably used phosphoric acid ester or carboxylic acid ester. The aforementioned plasticizer is more preferably selected from the group consisting of triphenyl phosphate (TPP), tricresyl phosphate (TCP), cresyl diphenyl phosphate, octyl diphenyl phosphate, biphenyl diphenyl phosphate (BDP), trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetylcitrate (OACTE), tributyl O-acetylcitrate (OACTB), acetyltriethyl citrate, acetyltributyl citrate, butyl oleate, methylacetyl ricinoleate, dibutyl sebacate, triacetin, tributylin, butylphthalyl glycolate, ethylphthalylethyl glycolate, methylphthalylethyl glycolate, and butylphthalylbutyl glycolate. Further, the aforementioned plasticizer is preferably selected from the group consisting of (di)pentaerythritolesters, glycerolesters and diglycerolesters.

### [Peel Accelerator]

Examples of the peel accelerator employable herein include citric acid ethyl esters.

### [Infrared Absorbent]

Examples of the infrared absorbent employable herein include those disclosed in JP-A-2001-194522.

### [Adding Time]

These additives may be added at any time during the process of preparing the dope. The step of adding these additives may be conducted at the final step in the process of preparing the dope. Further, the amount of these materials to be added is not specifically limited so far as their functions can be exhibited.

In the case where the cellulose acylate film is in a multi-layer form, the kind and added amount of additives in the various layers may be different. As disclosed in JP-A-2001-151902 for example, these techniques have heretofore been known.

The glass transition point Tg of the cellulose acylate film measured by a Type DVA-225 Vibron dynamic viscoelasticity meter (produced by IT Keisoku Seigyo Co., Ltd.) and the elastic modulus of the cellulose acylate measured by a Type Strograph R2 tensile testing machine (produced by TOYO SEIKI KOGYO CO., LTD.) are preferably predetermined to a range of from 70° C. to 150° C., more preferably from 80° C. to 135° C., and a range of from 1,500 to 4,000 MPa, more preferably from 1,500 to 3,000 MPa, respectively, by properly selecting the kind and added amount of these additives. In other words, the cellulose acylate film which is preferably used in the invention preferably exhibits a glass transition point Tg and an elastic modulus falling within the above defined range from the standpoint of adaptability to the step of forming polarizing plate or assembling liquid crystal display device.

As these additives there may be properly used those disclosed in detail in Kokai Giho No. 2001-1745, pp. 16 and after, Japan Institute of Invention and Innovation.

### [Retardation Developer]

In the invention, a retardation developer is preferably used to develop a great optical anisotropy and realize a desired retardation value.

The retardation developer to be used in the invention may be one made of a rod-shaped or disc-shaped compound. As the aforementioned rod-shaped or disc-shaped compound there may be used a compound having at least two aromatic rings.

The amount of the retardation developer made of a rod-shaped compound to be incorporated is preferably from 0.1 to 30 parts by mass, more preferably from 0.5 to 20 parts by mass based on 100 parts by mass of the polymer component containing cellulose acylate.

As the aforementioned rod-shaped or disc-shaped compound there may be used a compound having at least two aromatic rings.

The amount of the retardation developer made of a rod-shaped compound to be incorporated is preferably from 0.1 to 30 parts by mass, more preferably from 0.5 to 20 parts by mass based on 100 parts by mass of the polymer component containing cellulose acylate.

The disc-shaped retardation developer is preferably used in an amount of from 0.05 to 20 parts by mass, more preferably from 0.1 to 10 parts by mass, even more preferably from 0.2 to 5 parts by mass, most preferably from 0.5 to 2 parts by mass based on 100 parts by mass of the polymer component containing cellulose acylate.

The disc-shaped compound is superior to the rod-shaped compound in Rth retardation developability and thus is preferably used in the case where a remarkably great Rth retardation is required.

Two or more retardation developers may be used in combination.

The aforementioned retardation developer made of rod-shaped compound or disc-shaped compound preferably has a maximum absorption at a wavelength of from 250 to 400 nm and substantially no absorption in the visible light range.

### (Disc-Shaped Compound)

The disc-shaped compound will be further described hereinafter. As the disc-shaped compound there may be used a compound having at least two aromatic rings.

The term “aromatic ring” as used herein is meant to include aromatic heterocyclic groups in addition to aromatic hydrocarbon rings.

The aromatic hydrocarbon ring is preferably a 6-membered ring (i.e., benzene ring) in particular. The aromatic heterocyclic group is normally an unsaturated heterocyclic group. The aromatic heterocyclic group is preferably a 5-membered ring, 6-membered ring or 7-membered ring, more preferably a 5-membered ring or 6-membered ring.

The aromatic heterocyclic group normally has the most numerous double bonds. As hetero atoms there are preferably used nitrogen atom, oxygen atom and sulfur atom, particularly nitrogen atom. Examples of the aromatic heterocyclic group include furane ring, thiophene ring, pyrrole ring, oxazole ring, isooxazole ring, thiazole ring, isothiazole ring, imidazole ring, pyrazole ring, furazane ring, triazole ring, pyrane ring, pyridine ring, pyridazine ring, pyrimidine ring, pyrazine ring, and 1,3,5-triazine ring. Preferred examples of the aromatic ring include benzene ring, furane ring, thiophene ring, pyrrole ring, oxazole ring, thiazole ring, imidazole ring, triazole ring, pyridine ring, pyrimidine ring, pyrazine ring, and 1,3,5-triazine ring. Particularly preferred among these aromatic rings is 1,3,5-triazine ring. In some detail, as the disc-shaped compound there is preferably used one disclosed in JP-A-2001-166144.

The number of aromatic rings contained in the aforementioned disc-shaped compound is preferably from 2 to 20, more preferably from 2 to 12, even more preferably from 2 to 8, most preferably from 2 to 6.

Referring to the connection of two aromatic rings, (a) they may form a condensed ring, (b) they may be connected directly to each other by a single bond or (c) they may be connected to each other via a connecting group (No spiro bond cannot be formed due to aromatic ring). Any of the connections (a) to (c) may be established.

Preferred examples of the condensed ring (a) (formed by the condensation of two or more aromatic rings) include indene ring, naphthalene ring, azlene ring, fluorene ring, phenathrene ring, anthracene ring, acenaphthylene ring, biphenylene ring, naphthacene ring, pyrene ring, indole ring, isoindole ring, benzofurane ring, benzothiophene ring, benzotriazole ring, purine ring, indazole ring, chromene ring, quinoline ring, isoquinoline ring, quinolidine ring, quinazoline ring, cinnoline ring, quinoxaline ring, phthaladine ring, puteridine ring, carbazole ring, acridine ring, phenathridine, xanthene ring, phenazine ring, phenothiazine ring, phenoxathine ring, phenoxazine ring, and thianthrene ring. Preferred among these condensed rings are naphthalene ring, azlene ring, indole ring, benzooxazole ring, benzothiazole ring, benzoimidazole ring, benzotriazole ring, and quinoline ring.

The single bond (b) is preferably a bond between the carbon atom of two aromatic rings. Two or more aromatic rings may be connected via two or more single bonds to form an aliphatic ring or nonaromatic heterocyclic group between the two aromatic rings.

The connecting group (c), too, is preferably connected to the carbon atom of two aromatic rings. The connecting group is preferably an alkylene group, alkenylene group, alkinylene group, —CO—, —O—, —NH—, —S— or combination thereof.

Examples of the connecting group comprising these groups in combination will be given below. The order of the arrangement of components in the following connecting groups may be inverted.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and connecting group may have substituents.

Examples of the substituents include halogen atoms (F, Cl, Br, I), hydroxyl groups, carboxyl groups, cyano groups, amino groups, sulfo groups, carbamoyl groups, sulfamoyl groups, ureido groups, alkyl groups, alkenyl groups, alkinyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, aliphatic substituted amino groups, aliphatic substituted carbamoyl groups, aliphatic substituted sulfamoyl groups, aliphatic substituted ureido groups, and nonaromatic heterocyclic groups.

The number of carbon atoms in the alkyl group is preferably from 1 to 8. A chain-like alkyl group is preferred to cyclic alkyl group. A straight-chain alkyl group is particularly preferred. The alkyl group preferably further has substituents (e.g., hydroxy group, carboxy group, alkoxy group, alkyl-substituted amino group). Examples of the alkyl group (including substituted alkyl group) include methyl group, ethyl group, n-butyl group, n-hexyl group, 2-hydroxyethyl group, 4-carboxybutyl group, 2-methoxyethyl group, and 2-diethylaminoethyl group.

The number of carbon atoms in the alkenyl group is preferably from 2 to 8. A chain-like alkinyl group is preferred to cyclic alkenyl group. A straight-chain alkenyl group is particularly preferred. The alkenyl group may further have substituents. Examples of the alkenyl group include vinyl group, allyl group, and 1-hexenyl group.

The number of carbon atoms in the alkinyl group is preferably from 2 to 8. A chain-like alkinyl group is preferred to cyclic alkinyl group. A straight-chain alkinyl group is particularly preferred. The alkinyl group may further have substituents. Examples of the alkinyl group include ethinyl group, 1-butinyl group, and 1-hexinyl group.

The number of carbon atoms in the aliphatic acyl group is preferably from 1 to 10. Examples of the aliphatic acyl group include acetyl group, propanoyl group, and butanoyl group.

The number of carbon atoms in the aliphatic acyloxy group is preferably from 1 to 10. Examples of the aliphatic acyloxy group include acetoxy group.

The number of carbon atoms in the alkoxy group is preferably from 1 to 8. The alkoxy group may further has substituents (e.g., alkoxy group). Examples of the alkoxy group (including substituted alkoxy groups) include methoxy group, ethoxy group, butoxy group, and methoxyethoxy group.

The number of carbon atoms in the alkoxycarbonyl group is preferably from 2 to 10. Examples of the alkoxycarbonyl group include methoxycarbonyl group, and ethoxycarbonyl group.

The number of carbon atoms in the alkoxycarbonylamino group is preferably from 2 to 10. Examples of the alkoxycarbonylamino group include methoxycarbonylamino group, and ethoxycarbonylamino group.

The number of carbon atoms in the alkylthio group is preferably from 1 to 12. Examples of the alkylthio group include methylthio group, ethylthio group, and octylthio group.

The number of carbon atoms in the alkylsulfonyl group is preferably from 1 to 8. Examples of the alkylsulfonyl group include methanesulfonyl group, and ethanesulfonyl group.

The number of carbon atoms in the aliphatic amide group is preferably from 1 to 10. Examples of the aliphatic amide group include acetamide group.

The number of carbon atoms in the aliphatic sulfonamide group is preferably from 1 to 8. Examples of the aliphatic sulfonamide group include methanesulfonamide group, butanesulfonamide group, and n-octanesulfonamide group.

The number of carbon atoms in the aliphatic substituted amino group is preferably from 1 to 10. Examples of the aliphatic substituted amino group include dimethylamino group, diethylamino group, and 2-carboxyethylamino group.

The number of carbon atoms in the aliphatic substituted carbamoyl group is preferably from 2 to 10. Examples of the aliphatic substituted carbamoyl group include methylcarbamoyl group, and diethylcarbamoyl group.

The number of carbon atoms in the aliphatic substituted sulfamoyl group is preferably from 1 to 8. Examples of the aliphatic substituted sulfamoyl group include methylsulfamoyl group, and diethylsulfamoyl group.

The number of carbon atoms in the aliphatic substituted ureido group is preferably from 2 to 10. Examples of the aliphatic substituted ureido group include methylureido group.

Examples of the nonaromatic heterocyclic group include piperidino group, and morpholino group.

The molecular mass of the retardation developer made of disc-shaped compound is preferably from 300 to 800.

### (Rod-Shaped Compound)

In the invention, a rod-shaped compound having a linear molecular structure may be preferably used besides the aforementioned disc-shaped compounds. The term “linear molecular structure” as used herein is meant to indicate that the molecular structure of the rod-shaped compound which is most thermodynamically stable is linear. The most thermodynamically stable structure can be determined by crystallographic structure analysis or molecular orbital calculation. For example, a molecular orbital calculation software (e.g., WinMOPAC2000, produced by Fujitsu Co., Ltd.) may be used to effect molecular orbital calculation, making it possible to determine a molecular structure allowing the minimization of heat formation of compound. The term “linear molecular structure” as used herein also means that the most thermodynamically stable molecular structure thus calculated forms a main chain at an angle of 140 degrees or more.

The rod-shaped compound is preferably one having at least two aromatic rings. As the rod-shaped compound having at least two aromatic rings there is preferably used a compound represented by the following general formula (1):

Ar¹-L¹-Ar² (1)

wherein Ar¹ and Ar² each independently represent an aromatic ring.

Examples of the aromatic ring employable herein include aryl groups (aromatic hydrocarbon group), substituted aryl groups, and substituted aromatic heterocyclic groups. The aryl group and substituted aryl group are preferred to the aromatic heterocyclic group and substituted aromatic heterocyclic group.

The heterocyclic group in the aromatic heterocyclic group is normally unsaturated. The aromatic heterocyclic group is preferably a 5-membered ring, 6-membered ring or 7-membered ring, more preferably a 5-membered ring or 6-membered ring. The aromatic heterocyclic group normally has the most numerous double bonds. The hetero atom is preferably nitrogen atom, oxygen atom or sulfur atom, more preferably nitrogen atom or sulfur atom.

Preferred examples of the aromatic ring in the aromatic group include benzene ring, furane ring, thiophene ring, pyrrole ring, oxazole ring, thiazole ring, imidazole ring, triazole ring, pyridine ring, pyrimidine ring, and pyrazine ring. Particularly preferred among these aromatic rings is benzene ring.

Examples of the substituents on the substituted aryl group and substituted aromatic heterocyclic group include halogen atoms (F, Cl, Br, I), hydroxyl groups, carboxyl groups, cyano groups, amino groups, alkylamino groups (e.g., methylamino group, ethylamino group, butylamino group, dimethylamino group), nitro groups, sulfo groups, carbamoyl groups, alkylcarbamoyl groups (e.g., N-methylcarbamoyl group, N-ethylcarbamoyl group, N,N-dimethylcarbamoyl group), sulfamoyl groups, alkylsulfamoyl groups (e.g., N-methylsulfamoyl group, N-ethylsulfamoyl group, N,N-dimethylsulfamoyl group), ureido groups, alkylureido groups (e.g., N-methylureido group, N,N-dimethylureido group, N,N,N′-trimethyl ureido group), alkyl groups (e.g., methyl group, ethyl group, propyl group, butyl group, pentyl group, heptyl group, octyl group, isopropyl group, s-butyl group, t-amyl group, cyclohexyl group, cyclopentyl group), alkenyl groups (e.g., vinyl group, allyl group, hexenyl group), alkinyl groups (e.g., ethinyl group, butinyl group), acyl groups (e.g., formyl group, acetyl group, butyryl group, hexanoyl group, lauryl group), acyloxy groups (e.g., acetoxy group, butyryloxy group, hexanoyloxy group, lauryloxy group), alkoxy groups (e.g., methoxy group, ethoxy group, propoxy group, butoxy group, pentyloxy group, heptyloxy group, octyloxy group), aryloxy groups (e.g., phenoxy group), alkoxycarbonyl groups (e.g., methoxycarbonyl group, ethoxycarbonyl group, propoxycarbonyl group, butoxycarbonyl group, pentyloxycarbonyl group, heptyloxycarbonyl group), aryloxycarbonyl groups (e.g., phenoxycarbonyl group), alkoxycarbonylamino groups (e.g., butoxycarbonylamino group, hexyloxycarbonylamino group), alkylthio groups (e.g., methylthio group, ethylthio group, propylthio group, butylthio group, pentylthio group, heptylthio group, octylthio group), arylthio groups (e.g., phenylthio group), alkylsulfonyl groups (e.g., methyl sulfonyl group, ethylsulfonyl group, propylsulfonyl group, butylsulfonyl group, pentylsulfonyl group, heptylsulfonyl group, octylsulfonyl group), amide groups (e.g., acetamide group, butylamide group, hexylamide group, laurylamide group), and nonaromatic heterocyclic groups (e.g., morpholyl group, pyradinyl group).

Examples of the substituents on the substituted aryl group and substituted aromatic heterocyclic group include halogen atoms, cyano groups, carboxyl groups, hydroxyl groups, amino groups, alkyl-substituted amino groups, acyl groups, acyloxy groups, amide groups, alkoxycarbonyl groups, alkoxy groups, alkylthio groups, and alkyl groups.

The alkyl moiety and alkyl group in the alkylamino group, alkoxycarbonyl group, alkoxy group and alkylthio group may further have substituents. Examples of the substituents on the alkyl moiety and alkyl group include halogen atoms, hydroxyl groups, carboxyl groups, cyano groups, amino groups, alkylamino groups, nitro groups, sulfo groups, carbamoyl groups, alkylcarbamoyl groups, sulfamoyl groups, alkylsulfamoyl groups, ureido groups, alkylureido groups, alkenyl groups, alkinyl groups, acyl groups, acyloxy groups, acylamino groups, alkoxy groups, aryloxy groups, alkoxycarbonyl groups, aryloxycarbonyl groups, alkylthio groups, arylthio groups, alkylsulfonyl groups, amide groups, and nonaromatic heterocyclic groups. Preferred among these substituents on the alkyl moiety and alkyl group are halogen atoms, hydroxyl groups, amino groups, alkylamino groups, acyl groups, acyloxy groups, acylamino groups, and alkoxy groups.

In the general formula (1), L1 represents a divalent connecting group selected from the group consisting of groups composed of alkylene group, alkenylene group, alkinylene group, —O—, —CO— and combination thereof.

The alkylene group may have a cyclic structure. The cyclic alkylene group is preferably cyclohexylene, particularly 1,4-cyclohexylene. As the chain-like alkylene group, a straight-chain alkylene is preferred to a branched alkylene. The number of carbon atoms in the alkylene group is preferably from 1 to 20, more preferably from 1 to 15, even more preferably from 1 to 10, even more preferably from 1 to 8, most preferably from 1 to 6.

The alkenylene group and alkinylene group preferably has a chain-like structure rather than cyclic structure, more preferably a straight-chain structure than branched chain-like structure. The number of carbon atoms in the alkenylene group and alkinylene group is preferably from 2 to 10, more preferably from 2 to 8, even more preferably from 2 to 6, even more preferably from 2 to 4, most preferably 2 (vinylene or ethinylene).

The number of carbon atoms in the arylene group is preferably from 6 to 20, more preferably from 6 to 16, even more preferably from 6 to 12.

In the molecular structure of the general formula (1), the angle formed by Ar¹ and Ar² with L¹ interposed therebetween is preferably 140 degrees or more.

The rod-shaped compound is more preferably a compound represented by the following general formula (2):

Ar¹-L²-X-L³-Ar² (2)

wherein Ar¹ and Ar² each independently represent an aromatic group. The definition and examples of the aromatic group are similar to that of Ar¹ and Ar² in the general formula (1).

In the general formula (2), L² and L³ each independently represent a divalent connecting group selected from the group consisting of groups formed by alkylene group, —O—, —CO— and combination thereof.

The alkylene group preferably has a chain-like structure rather than cyclic structure, more preferably a straight-chain structure rather than branched chain-like structure.

The number of carbon atoms in the alkylene group is preferably from 1 to 10, more preferably from 1 to 8, even more preferably from 1 to 6, even more preferably from 1 to 4, most preferably 1 or 2 (methylene or ethylene).

L² and L³ each are preferably —O—CO— or —CO—O— in particular.

In the general formula (2), X represents 1,4-cyclohexylene, vinylene or ethinylene. Specific examples of the compound represented by the general formula (1) or (2) include those disclosed in JP-A-2004-109657, [ka-1] to [ka-11].

Besides these compounds, a compound represented by the following general formulae (3) is preferred.

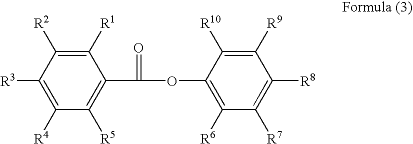

wherein R¹, R², R³, R⁴, R⁵, R⁶, R⁷, R⁹ and R¹⁰ each independently represent a hydrogen atom or substituent, with the proviso that at least one of R¹, R², R³, R⁴ and R⁵ represents one electron-donating group; and R⁸ represents a hydrogen atom, C₁-C₄ alkyl group, C₂-C₆ alkenyl group, C₂-C₆ alkinyl group, C₆-C₁₂ aryl group, C₁-C₁₂ alkoxy group, C₆-C₁₂ aryloxy group, C₂-C₁₂ alkoxycarbonyl group, C₂-C₁₂ acylamino group, cyano group or halogen atom.

Specific examples of the rod-shaped compound represented by the general formula (3) among the retardation developers will be given below.

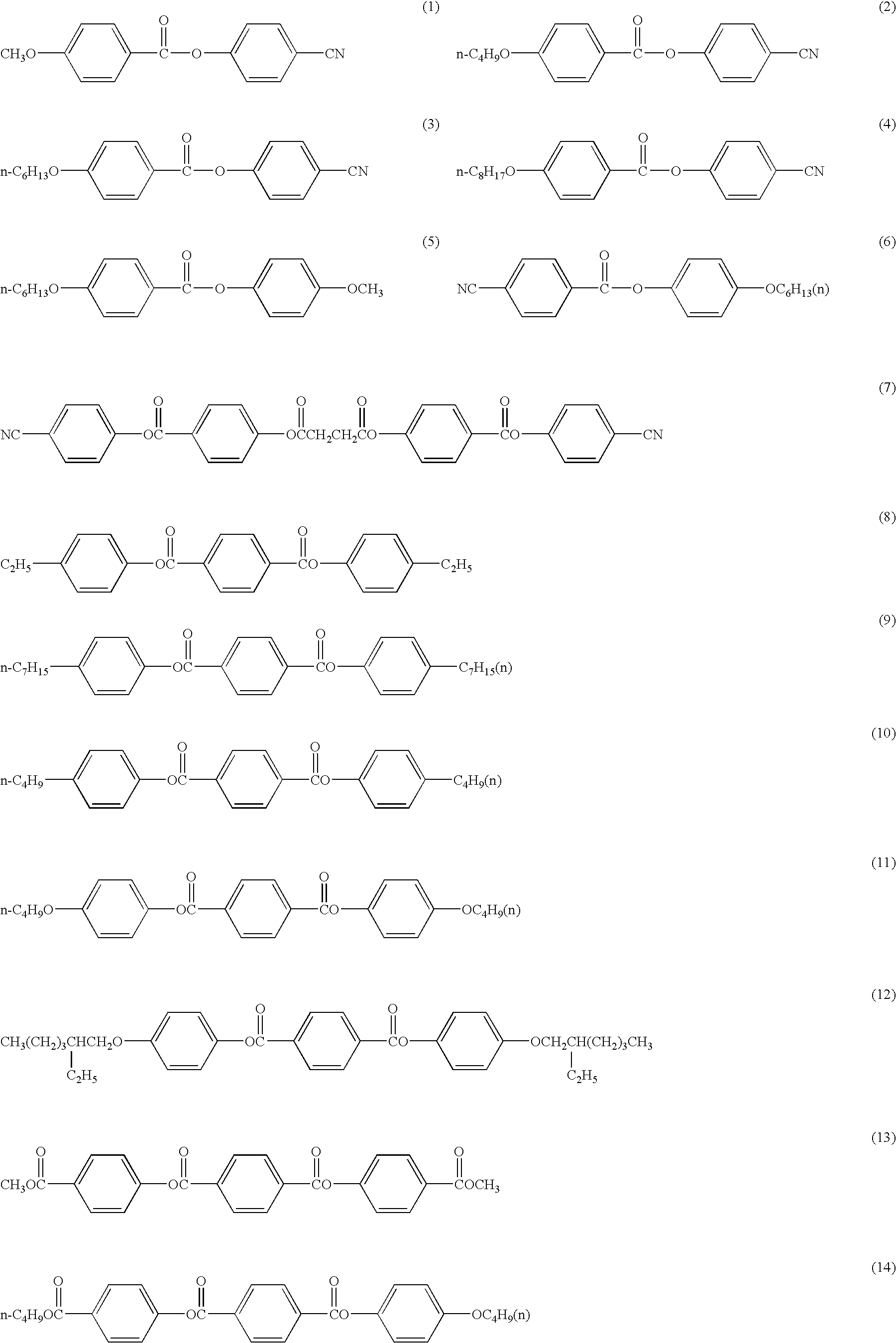

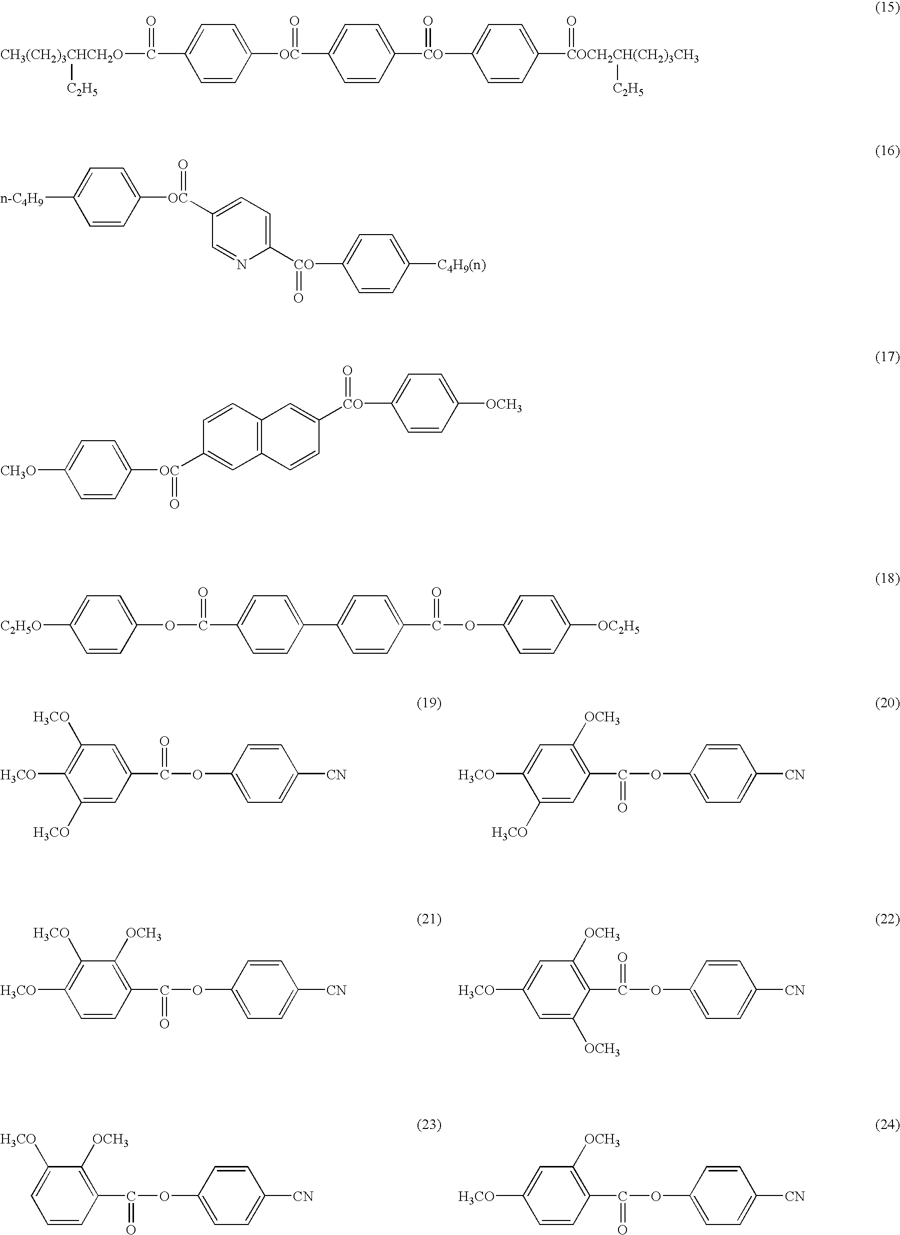

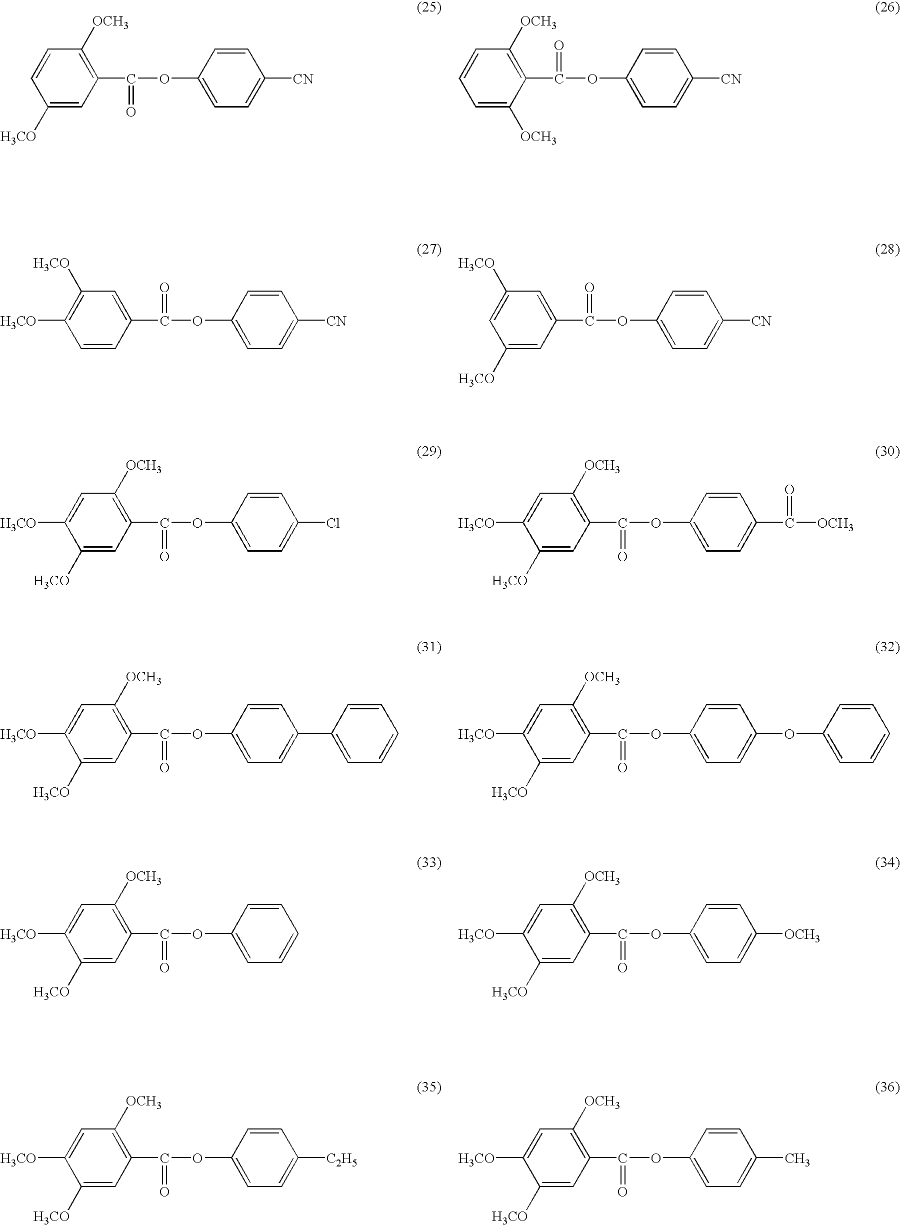

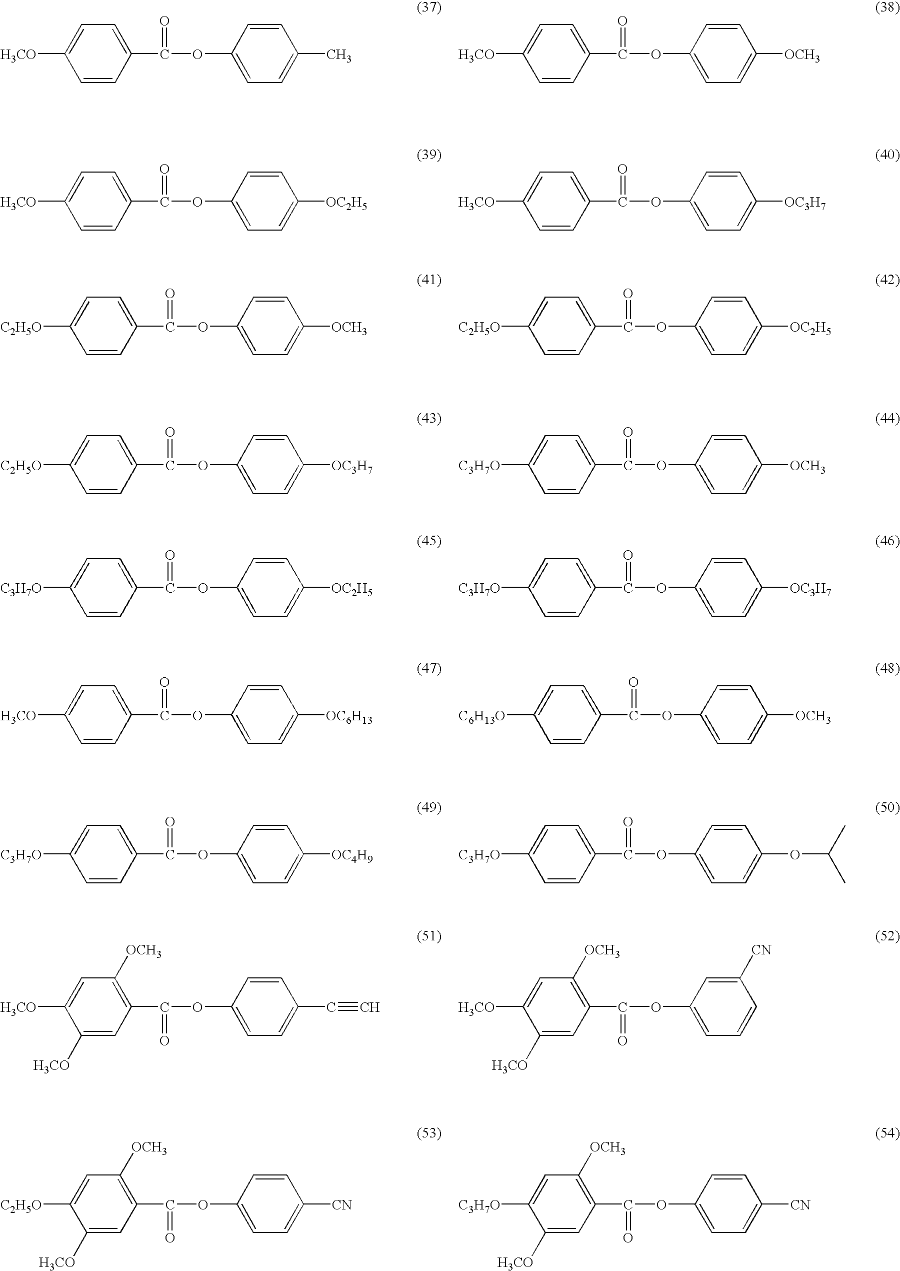

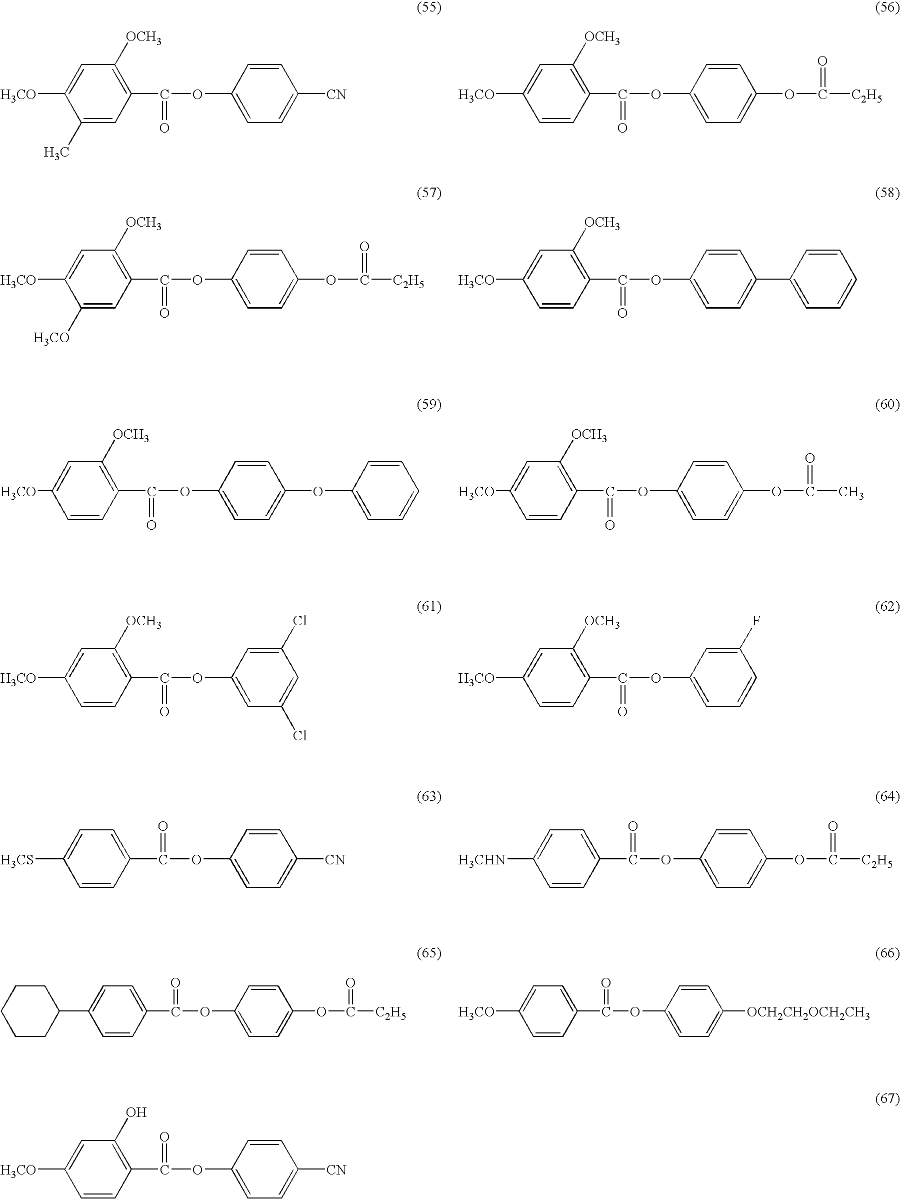

Two or more rod-shaped compounds having a maximum absorption wavelength (λmax) of shorter than 250 nm in the ultraviolet absorption spectrum of solution may be used in combination.

The rod-shaped compound can be synthesized by any method disclosed in literatures such as “Mol. Cryst. Liq. Cryst.”, vol. 53, page 229, 1979, “Mol. Cryst. Liq. Cryst.”, vol. 89, page 93, 1982, “Mol. Cryst. Liq. Cryst.”, vol. 145, page 11, 1987, “Mol. Cryst. Liq. Cryst.”, vol. 170, page 43, 1989, “J. Am. Chem. Soc.”, vol. 113, page 1, 349, 1991, “J. Am. Chem. Soc.”, vol. 118, page 5, 346, “J. Am. Chem. Soc.”, vol. 92, page 1, 582, 1970, “J. Org. Chem.”, vol. 40, page 420, 1975, and “Tetrahedron”, vol. 48, No. 16, page 3, 437, 1992.

### [Retardation Decreaser]

A retardation decreaser which is used when lowering optical anisotropy of a cellulose acylate film will be described.

A compound which prevents the cellulose acylate in the film from being oriented in the in-plane or thickness direction can be used to sufficiently lower optical anisotropy, making it possible to reduce Re and Rth to zero or close to zero. To this end, it is preferred that the compound which lowers optical anisotropy be thoroughly dissolved in the cellulose acylate and the compound have neither rod-shaped nor planar structure. In some detail, in the case where there are a plurality of planar functional groups such as aromatic group, the aforementioned compound has these functional groups in a non-planar alignment rather than on the same plane to advantage.

### (Log P Value)

In order to prepare a cellulose acylate film having a low optical anisotropy, a compound having an octanol-water distribution coefficient (log P value) of from 0 to 7 among the compounds compound which prevent the cellulose acylate in the film from being oriented in the in-plane or thickness direction to lower optical anisotropy is preferably used. The compound having a log P value of 7 or less exhibits a good compatibility with cellulose acylate to cause little clouding or dusting of film to advantage.

Further, the compound having a log P value of 0 or more doesn't exhibit too high a hydrophilicity and thus doesn't cause the deterioration of water resistance of cellulose acylate film to advantage. The log P value of the compound is more preferably from 1 to 6, particularly from 1.5 to 5.

For the measurement of octanol-water distribution coefficient (log P value), a flask osmosis method described in JIS Z7260-107 (2000) can be employed. The octanol-water distribution coefficient can be estimated by computational chemistry or empirical method rather than measurement.

Preferred examples of the calculation method employable herein include Crippen's fragmentation method (J. Chem. Inf. Comput. Sci., 27, 21 (1987)), Viswanadhan's fragmentation method (J. Chem. Inf. Comput. Sci., 29, 163 (1989)), and Broto's fragmentation method (Eur. J. Med. Chem.—Chim. Theor., 19, 71 (1984)). Particularly preferred among these calculation methods is Crippen's fragmentation method (J. Chem. Inf. Comput. Sci., 27, 21 (1987)).

In the case where the log P value of a compound differs with the measurement method or calculation method, it is desired to use Crippen's fragmentation method to judge to see whether or not the compound falls within the above defined range.

### (Physical Properties of Compound for Deteriorating Optical Anisotropy)

The compound for deteriorating optical anisotropy may or may not contain aromatic groups. The compound for deteriorating optical anisotropy preferably has a molecular mass of from not smaller than 150 to not greater than 3,000, more preferably from not smaller than 170 to not greater than 2,000, particularly from not smaller than 200 to not greater than 1,000. The compound for deteriorating optical anisotropy may have a specific monomer structure or an oligomer or polymer structure comprising a plurality of such monomer units connected to each other so far as it has a molecular mass falling within this range.

The compound for deteriorating optical anisotropy preferably stays liquid at 25° C. or is a solid material having a melting point of from 25 to 250° C., more preferably stays liquid at 25° C. or is a solid material having a melting point of from 25 to 200° C. The compound for deteriorating optical anisotropy preferably undergoes no evaporation during the casting and drying of dope in the preparation of cellulose acylate film.

The added amount of the compound for deteriorating optical anisotropy is preferably from 0.01 to 30% by mass, more preferably from 1 to 25% by mass, particularly from 5 to 20% by mass based on the mass of cellulose acylate.

The compounds for deteriorating optical anisotropy may be used singly or in admixture of two or more thereof at an arbitrary ratio.

The compound for deteriorating optical anisotropy may be added at any time during the preparation of the dope or in the final stage of the preparation of the dope.

The compound which deteriorates optical anisotropy is preferably incorporated in the cellulose acylate film such that the average content thereof in the region between the surface of at least one side of the film and the portion apart from the surface of the film by 10% of the total thickness thereof is from 80% to 99% of the average content of the compound in the central part of the film. The content of the compound which deteriorates optical anisotropy can be determined by measuring the amount of the compound in the surface and central part of the film using a method involving infrared absorption spectroscopy as disclosed in JP-A-8-57879.

(Specific Examples of Compound which Deteriorates Optical Anisotropy)

Specific examples of the compound for deteriorating the optical anisotropy of the cellulose acylate film which can be preferably used in the invention will be given below, but the invention is not limited thereto.

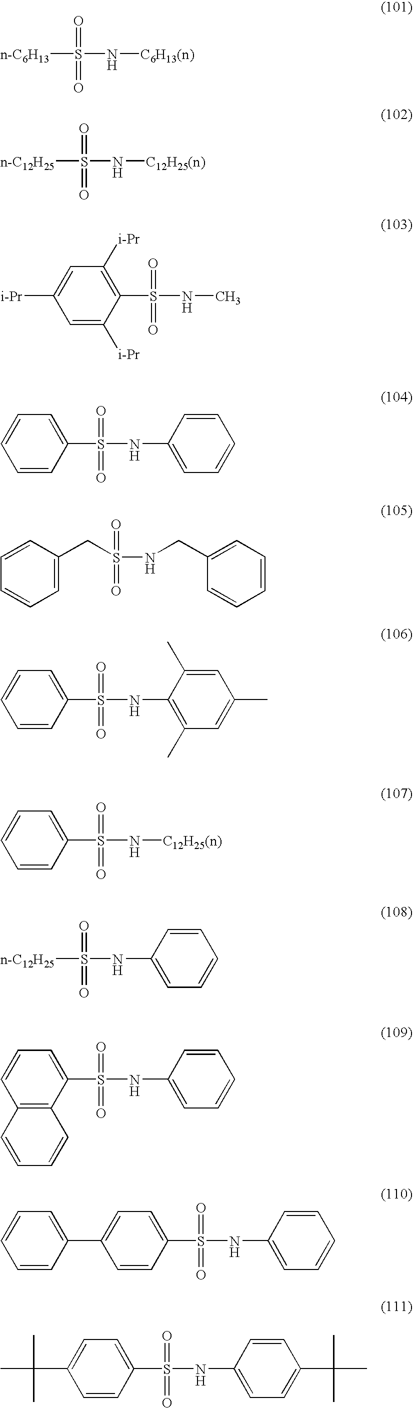

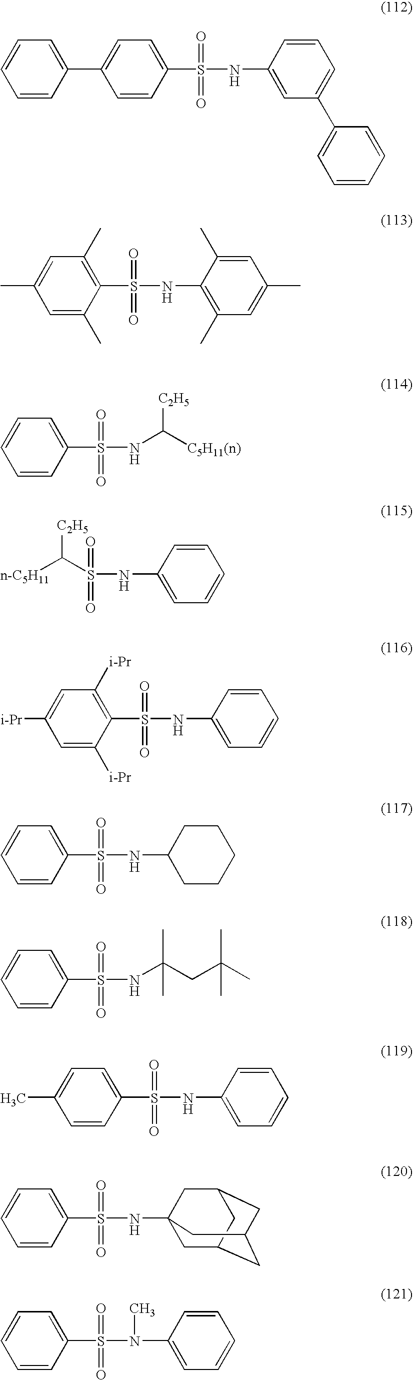

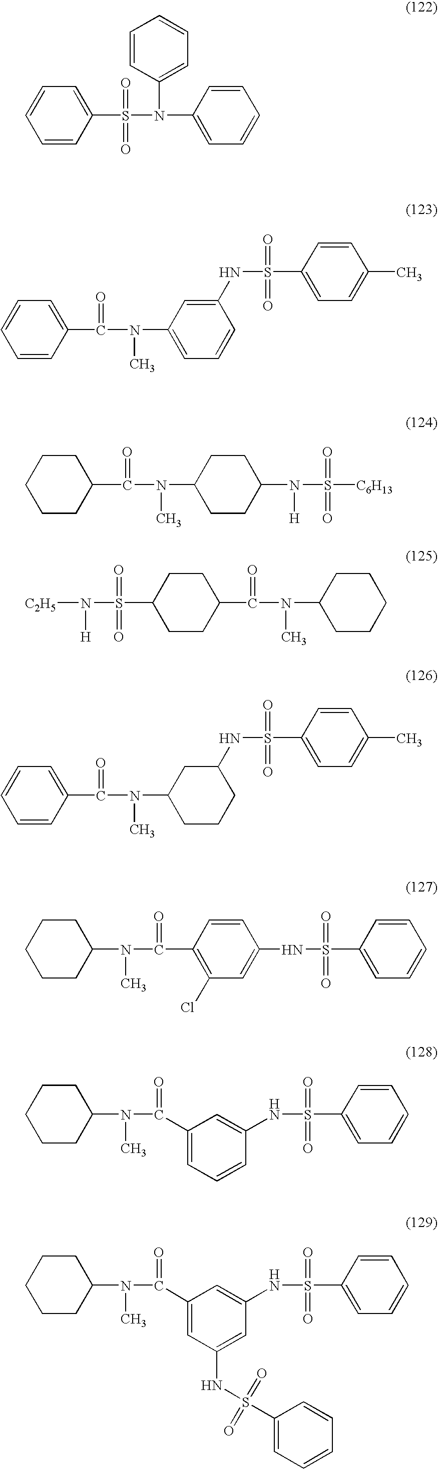

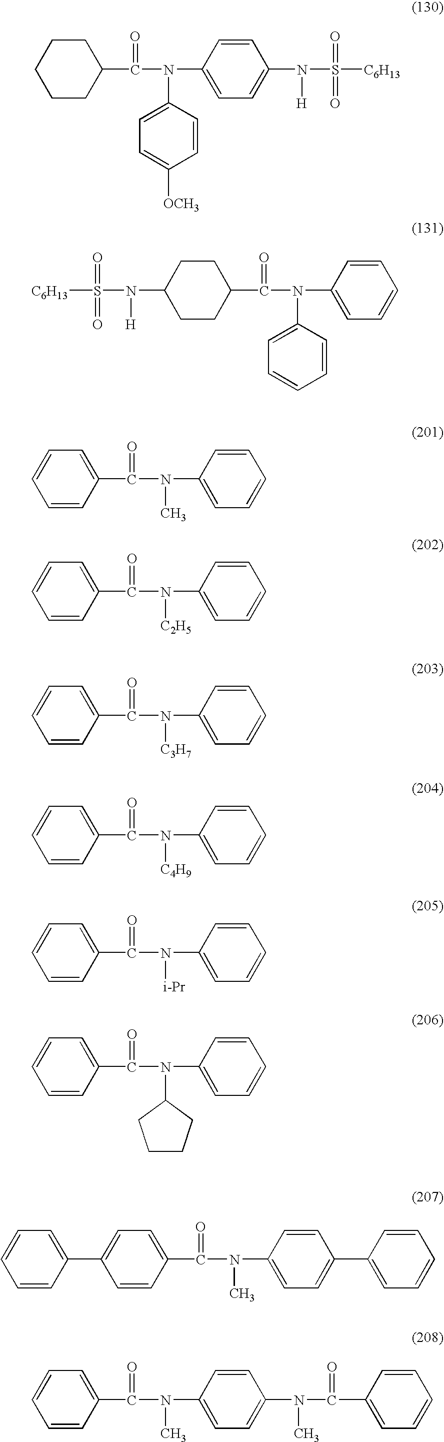

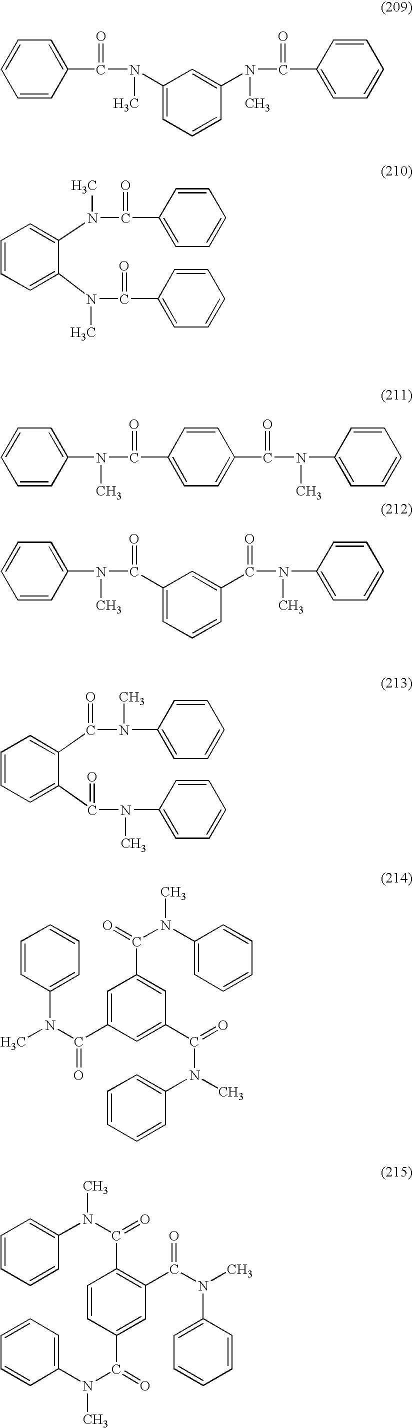

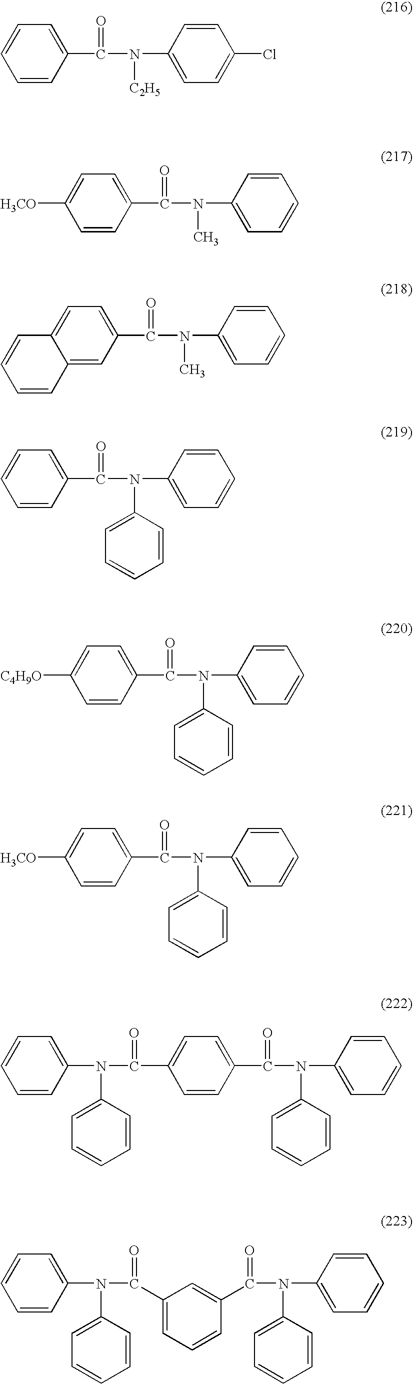

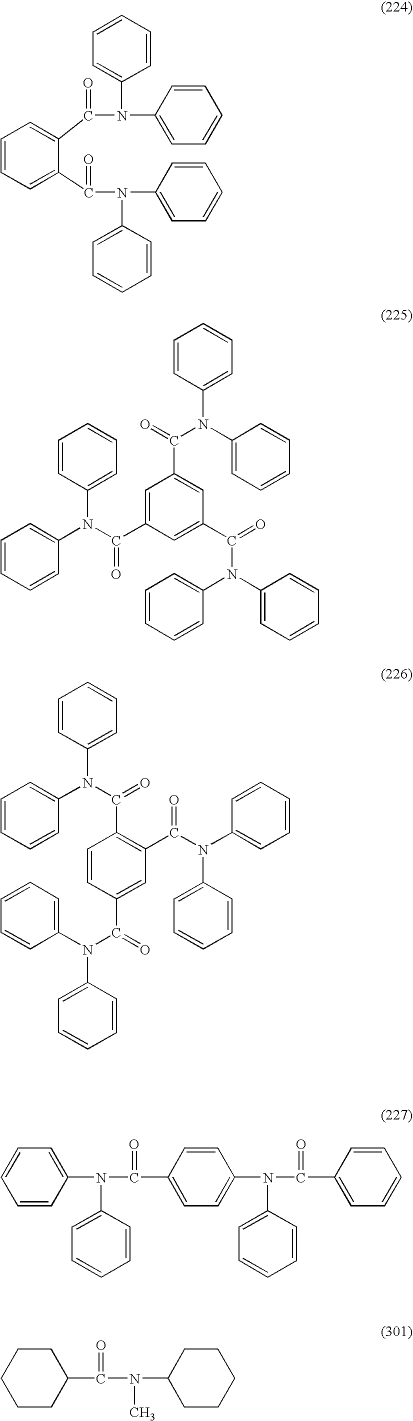

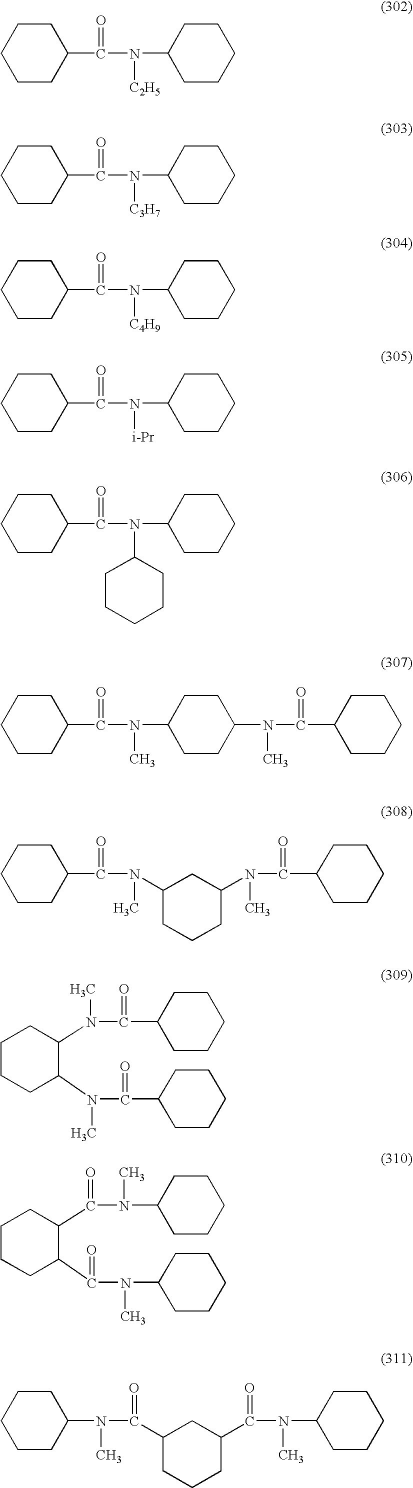

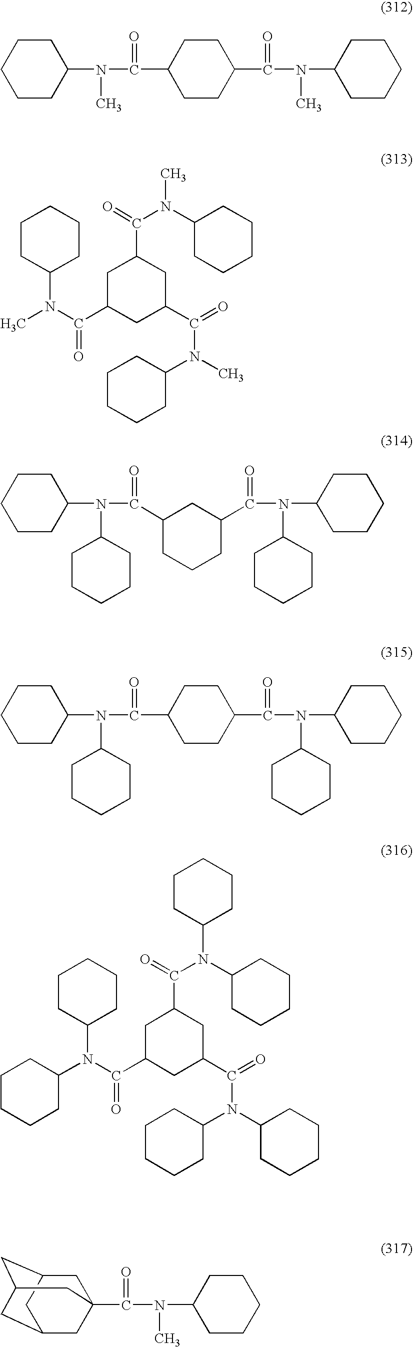

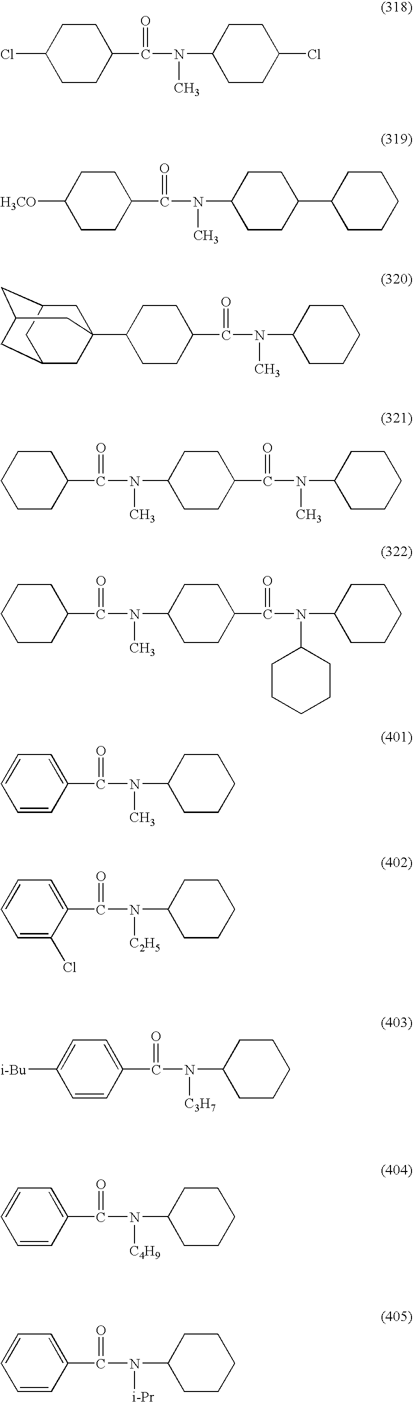

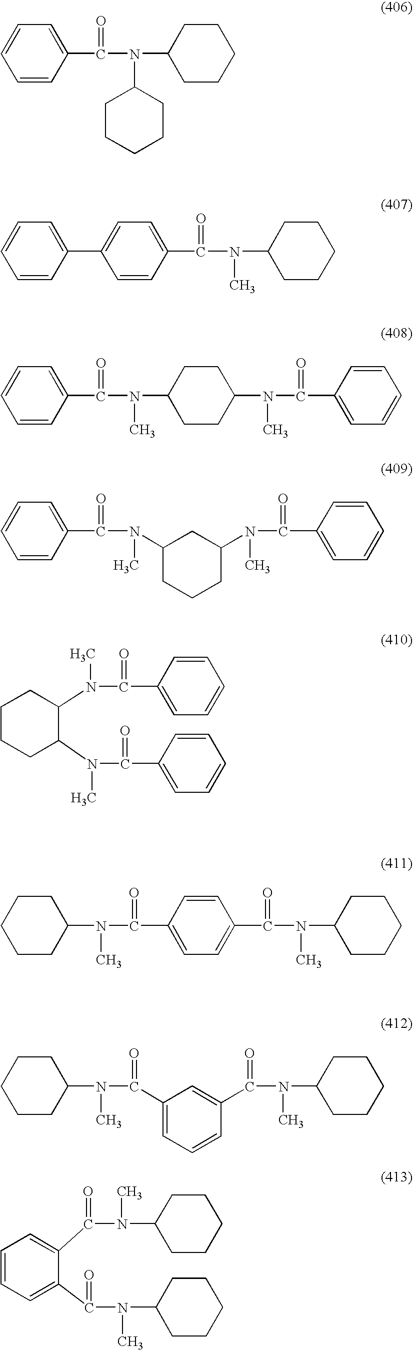

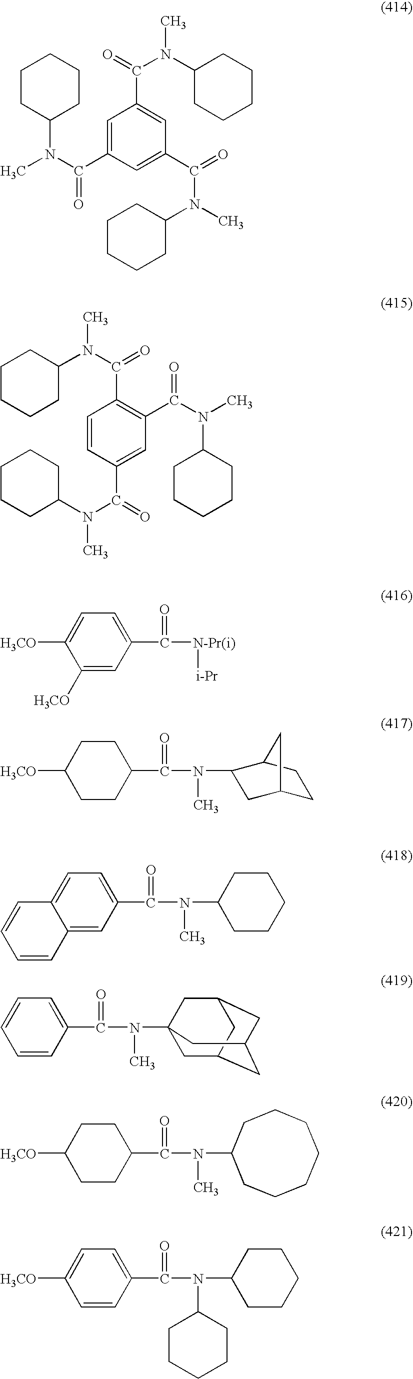

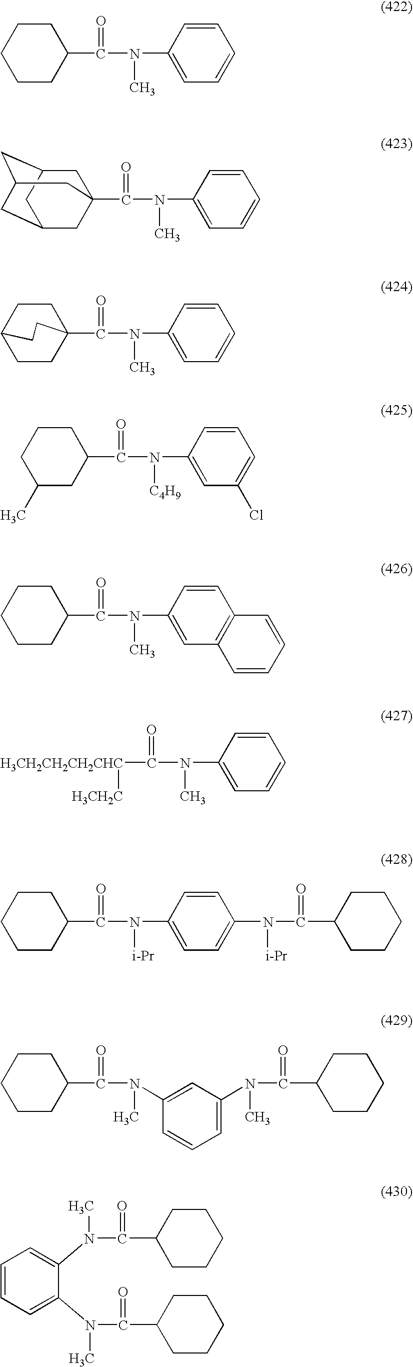

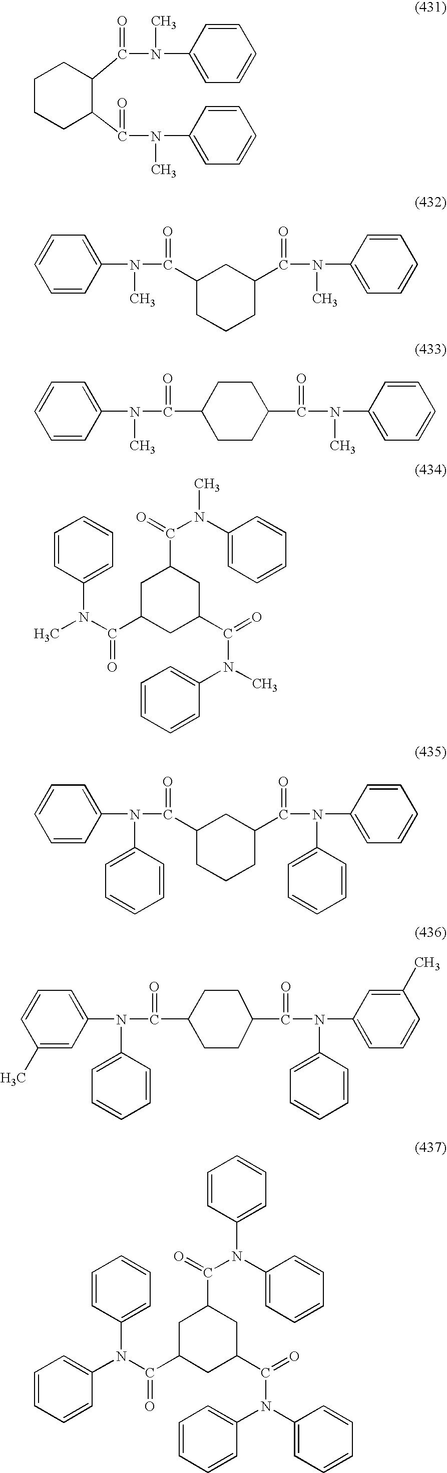

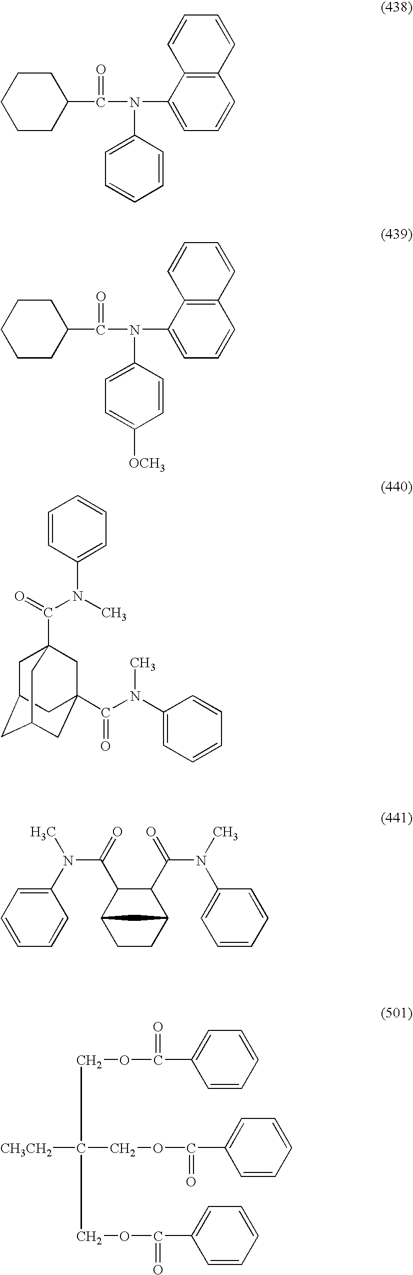

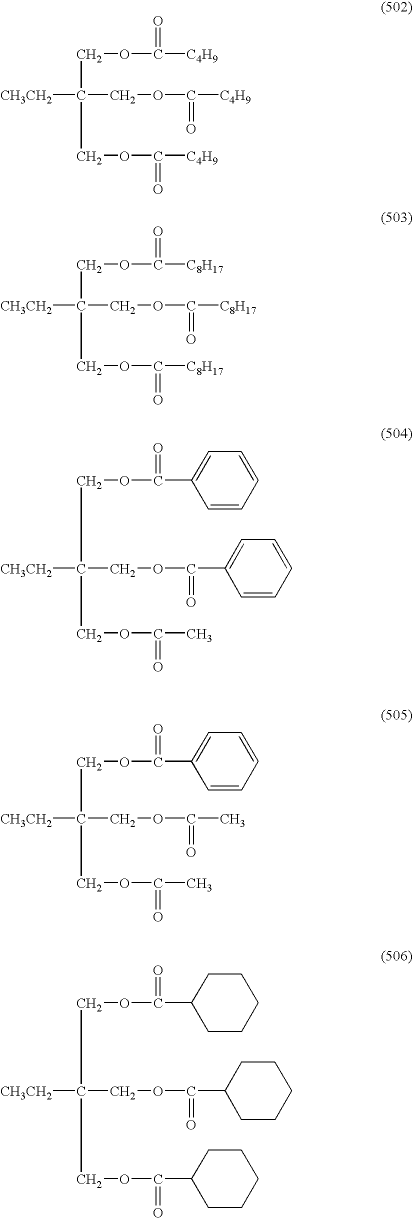

### [Wavelength Dispersion Adjustor]

The compound which reduces wavelength dispersion of cellulose acylate film will be described hereinafter. At least one compound having an absorption in the ultraviolet range of from 200 nm to 400 nm which reduces |Re₄₀₀−Re₇₀₀| and |Rth₄₀₀−Rth₇₀₀| of film is preferably incorporated in an amount of from 0.01 to 30% by mass based on the solid content in the cellulose acylate film. The incorporation of the wavelength dispersion adjustor makes it possible to adjust wavelength dispersion of Re and Rth of the cellulose acylate film. Re₄₀₀ and Rth₄₀₀ each are a value at wavelength λ of 400 nm and Re₇₀₀ and Rth₇₀₀ each are a value at wavelength λ of 700 nm (unit: nm). When the aforementioned compound is incorporated in an amount of from 0.1 to 30% by mass, the wavelength dispersion of Re and Rth of the cellulose acylate film can be properly adjusted.

The wavelength dispersion characteristics of the cellulose acylate film are such that Re and Rth value are normally greater on the long wavelength side than on the short wavelength side. Accordingly, it is required that Re and Rth values on the short wavelength side, which are relatively small, be raised to smoothen wavelength dispersion. On the other hand, the compound having absorption in ultraviolet range of from 200 to 400 nm has wavelength dispersion characteristics such that absorbance is greater on the long wavelength side than on the short wavelength side. It is presumed that when the compound itself is isotropically present in the cellulose acylate film, the birefringence of the compound itself and hence Re and Rth wavelength dispersion is greater on the short wavelength side similar to the wavelength dispersion of absorbance.

Accordingly, the use of the aforementioned compound which has absorption in ultraviolet range of from 200 to 400 nm and greater Re and Rth wavelength dispersion on the short wavelength side makes it possible to adjust. Re and Rth wavelength dispersion of cellulose acylate film. To this end, it is required that the compound the wavelength dispersion of which is needed to be adjusted have a sufficiently uniform compatibility with cellulose acylate. The ultraviolet absorption wavelength range of such a compound is preferably from 200 to 400 nm, more preferably from 220 to 395 nm, even more preferably from 240 to 390 nm.

The recent trend is for more liquid crystal display devices for television, note personal computer, mobile cellular phone, etc. to comprise optical members having higher transmission for higher brightness with lower electric power. In this respect, the compound having an absorption in the ultraviolet range of from 200 nm to 400 nm which reduces |Re₄₀₀−Re₇₀₀| and |Rth₄₀₀−Rth₇₀₀| of film is required to have a higher spectral transmission when incorporated in the cellulose acylate film. The cellulose acylate film which is preferably used in the invention preferably exhibits a spectral transmission of from not smaller than 45% to not greater than 95% at a wavelength of 380 nm and 10% or less at a wavelength of 350 nm.

The aforementioned wavelength dispersion adjustor which can be preferably used in the invention preferably has a molecular mass of from 250 to 1,000, more preferably from 260 to 800, even more preferably from 270 to 800, particularly from 300 to 800 from the standpoint of volatility. The wavelength dispersion adjustor may have a specific monomer structure or an oligomer or polymer structure comprising a plurality of such monomer units connected to each other so far as it has a molecular mass falling within this range.

The wavelength dispersion adjustor of the invention preferably undergoes no evaporation during the casting and drying of dope in the preparation of cellulose acylate film.

### (Added Amount of Wavelength Dispersion Adjustor)

The added amount of the wavelength dispersion adjustor which is preferably used in the prevention is preferably from 0.01% to 30% by mass, more preferably from 0.1% to 20% by mass, particularly from 0.2% to 10% by mass based on the solid content in the cellulose acylate film.

### (Method of Adding Wavelength Dispersion Adjustor)

These wavelength dispersion adjustors may be used singly or in arbitrary combination of two or more thereof.

These wavelength dispersion adjustors may be added at any time during the process of preparing the dope. The step of adding these wavelength dispersion adjustors may be conducted at the final step in the process of preparing the dope.

Specific examples of the wavelength dispersion adjustors which are preferably used in the invention include benzotriazole-based compounds, benzophenone-based compounds, compounds containing cyano group, oxybenzophenone-based compounds, salicylic acid ester-based compounds, and nickel complex salt-based compounds. The invention is not limited to these compounds.

### [Dye]

In the invention, a dye for hue adjustment may be added. The content of such a dye is preferably from 10 ppm to 1,000 ppm, more preferably from 50 ppm to 500 ppm based on the mass of cellulose acylate. The incorporation of such a dye makes it possible to eliminate light piping of cellulose acylate film and hence improve yellowish tint. These compounds may be added with the cellulose acylate or solvent during or after the preparation of the cellulose acylate solution. Alternatively, these compounds may be added to the ultraviolet absorbent solution to be in-line added. Dyes disclosed in JP-A-5-34858 may be used.

### [Particulate Matting Agent]

The cellulose acylate film which is preferably used in the invention preferably has a particulate material incorporated therein as a matting agent. Examples of the particulate material employable herein include silicon dioxide, titanium dioxide, aluminum oxide, zirconium oxide, calcium carbonate, talc, clay, calcined kaolin, calcined calcium silicate, hydrous calcium silicate, aluminum silicate, magnesium silicate, and calcium phosphate. The particulate material preferably contains silicon to reduce turbidity. In particular, silicon dioxide is preferred.

The particulate silicon dioxide preferably has a primary average particle diameter of 20 nm or less and an apparent specific gravity of 70 g/l or more. The primary average particle diameter of the particulate silicon dioxide is more preferably as small as from 5 to 16 nm to reduce the haze of the film. The apparent specific gravity of the particulate silicon dioxide is preferably not smaller than from 90 to 200 g/l, more preferably not smaller than from 100 to 200 g/l. As the apparent specific gravity of the silicon dioxide rises, a high concentration dispersion can be prepared more easily to reduce haze and agglomeration.

The amount of the aforementioned particulate silicon dioxide, if used, is preferably from 0.01 to 0.3 parts by mass based on 100 parts by mass of the polymer component containing cellulose acylate.

These particles normally form secondary particles having an average particle diameter of from 0.1 to 3.0 μm. These particles are present in the film in the form of agglomerates of primary particles to form an unevenness having a height of from 0.1 to 3.0 μm on the surface of the film. The secondary average particle diameter is preferably from not smaller than 0.2 μm to not greater than 1.5 μm, more preferably from not smaller than 0.4 μm to not greater than 1.2 μm, most preferably from not smaller than 0.6 μm to not greater than 1.1 μm. When the secondary average particle diameter exceeds 1.5 m, the resulting film exhibits a raised haze. On the contrary, when the secondary average particle diameter falls below 0.2 μm, the effect of preventing squeak is reduced to advantage.

For the determination of primary and secondary particle diameter, particles in the film are observed under scanning electron microphotograph. The particle diameter is defined by the diameter of the circle circumscribing the particle. 200 particles which are located in dispersed positions are observed. The measurements are averaged to determine the average particle diameter.

As the particulate silicon dioxide there may be used a commercially available product such as Aerosil R972, R972V, R974, R812, 200, 200V, 300, R202, OX50 and TT600 (produced by Nippon Aerosil Co., Ltd.). The particulate zirconium oxide is commercially available as Aerosil R976 and R811 (produced by Nippon Aerosil Co., Ltd.). These products can be used in the invention.

Particularly preferred among these products are Aerosil 200V and Aerosil R972V because they are a particulate silicon dioxide having a primary average particle diameter of 20 nm or less and an apparent specific gravity of 70 g/l or more that exerts a great effect of reducing friction coefficient while keeping the turbidity of the optical film low.

In the invention, in order to obtain a cellulose acylate film containing particles having a small secondary average particle diameter, various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficultly re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer. The invention is not limited to these methods. The concentration of silicon dioxide during the mixing and dispersion of the particulate silicon dioxide with a solvent or the like is preferably from 5 to 30% by mass, more preferably from 10 to 25% by mass, most preferably from 15 to 20% by mass.

As the concentration of dispersion rises, the turbidity of the solution with respect to the added amount decreases to further reduce haze and agglomeration to advantage. The content of the matting agent in the final cellulose acylate dope solution is preferably from 0.01 to 1.0 g, more preferably from 0.03 to 0.3 g, most preferably from 0.08 to 0.16 g per m².

Preferred examples of the solvent which is a lower alcohol include methyl alcohol, ethyl alcohol, propyl alcohol, isopropyl alcohol, and butyl alcohol. The solvent other than lower alcohol is not specifically limited, but solvents which are used during the preparation of cellulose ester are preferably used.

The aforementioned organic solvent in which the cellulose acylate of the invention is dissolved will be described hereinafter.

In the invention, as the organic solvent there may be used either a chlorine-based solvent mainly composed of chlorine-based organic solvent or a nonchlorine-based solvent free of chlorine-based organic solvent.

### (Chlorine-Based Solvent)

In order to prepare the cellulose acylate solution of the invention, as the main solvent there is preferably used a chlorine-based organic solvent. In the invention, the kind of the chlorine-based organic solvent is not specifically limited so far as the cellulose acylate can be dissolved and casted to form a film, thereby attaining its aim. The chlorine-based organic solvent is preferably dichloromethane or chloroform. In particular, dichloromethane is preferred. The chlorine-based organic solvent may be used in admixture with organic solvents other than chlorine-based organic solvent. In this case, it is necessary that dichloromethane be used in an amount of at least 50% by mass based on the total amount of the organic solvents.

Other organic solvents to be used in combination with the chlorine-based organic solvent in the invention will be described hereinafter.

In some detail, other organic solvents employable herein are preferably selected from the group consisting of ester, ketone, ether, alcohol and hydrocarbon having from 3 to 12 carbon atoms. The ester, ketone, ether and alcohol may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group at the same time. The number of carbon atoms in the solvent having two or more functional groups, if used, may fall within the range defined for the compound having any of these functional groups. Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The alcohol to be used in combination with the chlorine-based organic solvent may be preferably straight-chain, branched or cyclic. Preferred among these organic solvents is saturated aliphatic hydrocarbon. The hydroxyl group in the alcohol may be primary to tertiary. Examples of the alcohol employable herein include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol. Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene.

Examples of the combination of chlorine-based organic solvent and other organic solvents include the following formulations, but the invention is not limited thereto.

Dichloromethane/methanol/ethanol/butanol (80/10/5/5, parts by mass)

Dichloromethane/acetone/methanol/propanol (80/10/5/5, parts by mass)

Dichloromethane/methanol/butanol/cyclohexane (80/10/5/5, parts by mass)

Dichloromethane/methyl ethyl ketone/methanol/butanol (80/10/5/5, parts by mass)

Dichloromethane/acetone/methyl ethyl ketone/ethanol/isopropanol (75/8/5/5/7, parts by mass)

Dichloromethane/cyclopentanone/methanol/isopropanol (80/7/5/8, parts by mass)

Dichloromethane/methyl acetate/butanol (80/10/10, parts by mass)

Dichloromethane/cyclohexanone/methanol/hexane (70/20/5/5, parts by mass)

Dichloromethane/methyl ethyl ketone/acetone/methanol/ethanol (50/20/20/5/5, parts by mass)

Dichloromethane/1,3-dioxolane/methanol/ethanol (70/20/5/5, parts by mass)

Dichloromethane/dioxane/acetone/methanol/ethanol (60/20/10/5/5, parts by mass)

Dichloromethane/acetone/cyclopentanone/ethanol/isobutanol/cyclohexane (65/10/10/5/5, parts by mass)

Dichloromethane/methyl ethyl ketone/acetone/methanol/ethanol (70/10/10/5/5, parts by mass)

Dichloromethane/acetone/ethyl acetate/ethanol/butanol/hexane (65/10/10/5/5/5, parts by mass)

Dichloromethane/methyl acetoacetate/methanol/ethanol (65/20/10/5, parts by mass)

Dichloromethane/cyclopentanone/ethanol/butanol (65/20/10/5, parts by mass)

### [Nonchlorine-Based Solvent]

The nonchlorine-based solvent which can be preferably used to prepare the cellulose acylate solution of the invention will be described hereinafter. The nonchlorine-based organic solvent to be used in the invention is not specifically limited so far as the cellulose acylate can be dissolved and casted to form a film, thereby attaining its aim. The nonchlorine-based organic solvent employable herein is preferably selected from the group consisting of ester, ketone, ether and having from 3 to 12 carbon atoms. The ester, ketone and ether may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group. The number of carbon atoms in the solvent having two or more functional groups, if used, may fall within the range defined for the compound having any of these functional groups. Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The nonchlorine-based organic solvent to be used for cellulose acylate may be selected from the aforementioned various standpoints of view but is preferably as follows. In some detail, the nonchlorine-based solvent is preferably a mixed solvent mainly composed of the aforementioned nonchlorine-based organic solvent. This is a mixture of three or more different solvents wherein the first solvent is at least one or a mixture of methyl acetate, ethyl acetate, methyl formate, ethyl formate, acetone, dioxolane and dioxane, the second solvent is selected from the group consisting of ketones or acetoacetic acid esters having from 4 to 7 carbon atoms and the third solvent is selected from the group consisting of alcohols or hydrocarbons having from 1 to 10 carbon atoms, preferably alcohols having from 1 to 8 carbon atoms. In the case where the first solvent is a mixture of two or more solvents, the second solvent may be omitted. The first solvent is more preferably methyl acetate, acetone, methyl formate, ethyl formate or mixture thereof. The second solvent is preferably methyl ethyl ketone, cyclopentanone, cyclohexanone, methyl acetylacetate or mixture thereof.

The third solvent which is an alcohol may be straight-chain, branched or cyclic. Preferred among these alcohols are unsaturated aliphatic hydrocarbons. The hydroxyl group in the alcohol may be primary to tertiary. Examples of the alcohol include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol.

Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene.

The alcohols and hydrocarbons which are third solvents may be used singly or in admixture of two or more thereof without any limitation. Specific examples of the alcohol which is a third solvent include methanol, ethanol, 1-propanol, 2-propanol, 1-butanol, 2-butanol, cyclohexanol, cyclohexane, and hexane. Particularly preferred among these alcohols are methanol, ethanol, 1-propanol, 2-propanol, and 1-butanol.

Referring to the mixing ratio of the aforementioned three solvents, the mixing ratio of the first solvent, the second solvent and the third solvent are preferably from 20 to 95% by mass, from 2 to 60% by mass and from 2 to 30% by mass, more preferably from 30 to 90% by mass, from 3 to 50% by mass and from 3 to 25% by mass, particularly from 30 to 90% by mass, from 3 to 30% by mass and from 3 to 15% by mass, respectively, based on the total mass of the mixture.

For the details of the nonchlorine-based organic solvents to be used in the invention, reference can be made to Kokai Giho No. 2001-1745, Mar. 15, 2001, pp. 12-16, Japan Institute of Invention and Innovation.

Examples of the combination of nonchlorine-based organic solvents include the following formulations, but the invention is not limited thereto.

Methyl acetate/acetone/methanol/ethanol/butanol (75/10/5/5/5, parts by mass)

Methyl acetate/acetone/methanol/ethanol/propanol (75/10/5/5/5, parts by mass)

Methyl acetate/acetone/methanol/butanol/cyclohexane (75/10/5/5/5, parts by mass)

Methyl acetate/acetone/ethanol/butanol (8118/7/4, parts by mass)

Methyl acetate/acetone/ethanol/butanol (82/10/4/4, parts by mass)

Methyl acetate/acetone/ethanol/butanol (80/10/4/6, parts by mass)

Methyl acetate/methyl ethyl ketone/methanol/butanol (80/10/5/5, parts by mass)

Methyl acetate/acetone/methyl ethyl ketone/ethanol/isopropanol (75/8/10/5/7, parts by mass)

Methyl acetate/cyclopentanone/methanol/isopropanol (80/7/5/8, parts by mass)

Methyl acetate/acetone/butanol (85/10/5, parts by mass)

Methyl acetate/cyclopentanone/acetone/methanol/butanol (60/15/14/5/6, parts by mass)

Methyl acetate/cyclohexanone/methanol/hexane (70/20/5/5, parts by mass)

Methyl acetate/methyl ethyl ketone/acetone/methanol/ethanol (50/20/5/5, parts by mass)

Methyl acetate/1,3-dioxolane/methanol/ethanol (70/20/5/5, parts by mass)

Methyl acetate/dioxane/acetone/methanol/ethanol (60/20/10/5/5, parts by mass)

Methyl acetate/acetone/cyclopentanone/ethanol/isobutanol/cyclohexane (65/10/10/5/5/5, parts by mass)

Methyl formate/methyl ethyl ketone/acetone/methanol/ethanol (50/20/20/5/5, parts by mass)

Methyl formate/acetone/ethyl acetate/ethanol/butanol/hexane (65/10/5/5/5, parts by mass)

Acetone/methyl acetoacetate/methanol/ethanol (65/20/10/5, parts by mass)

Acetone/cyclopentanone/methanol/butanol (65/20/10/5, parts by mass)

Acetone/1,3-dioxolane/ethanol/butanol (65/20/10/5, parts by mass)

1,3-Dioxolane/cyclohexanone/methyl ethyl ketone/methanol/butanol (55/20/10/5/5/5, parts by mass)

Further, cellulose acylate solutions prepared by the following methods may be used.

Method which comprises preparing a cellulose acylate solution with methyl acetate/acetone/ethanol/butanol (81/8/7/4, parts by mass), filtering and concentrating the solution, and then adding 2 parts by mass of butanol to the solution

Method which comprises preparing a cellulose acylate solution with methyl acetate/acetone/ethanol/butanol (84/10/4/2, parts by mass), filtering and concentrating the solution, and then adding 4 parts by mass of butanol to the solution

Method which comprises preparing a cellulose acylate solution with methyl acetate/acetone/ethanol (84/10/6, parts by mass), filtering and concentrating the solution, and then adding 5 parts by mass of butanol to the solution

The dope to be used in the invention comprises dichloromethane incorporated therein in an amount of 10% by mass or less based on the total mass of the organic solvents of the invention besides the aforementioned nonchlorine-based organic solvent of the invention.

### [Properties of Cellulose Acylate Solution]

The cellulose acylate solution of the invention preferably comprises cellulose acylate incorporated in the aforementioned organic solvent in an amount of from 10 to 30% by mass, more preferably from 13 to 27% by mass, particularly from 15 to 25% by mass from the standpoint of adaptability to film casting.

The adjustment of the concentration of the cellulose acylate solution to the predetermined range may be effected at the dissolution step. Alternatively, a cellulose acylate solution which has been previously prepared in a low concentration (e.g., 9 to 14% by mass) may be adjusted to the predetermined concentration range at a concentrating step described later. Alternatively, a cellulose acylate solution which has been previously prepared in a high concentration may be adjusted to the predetermined lower concentration range by adding various additives thereto. Any of these methods may be used so far as the predetermined concentration range can be attained.

In the invention, the molecular mass of the associated cellulose acylate in the cellulose acylate solution which has been diluted with an organic solvent having the same formulation to a concentration of from 0.1 to 5% by mass is preferably from 150,000 to 15,000,000, more preferably from 180,000 to 9,000,000 from the standpoint of solubility in solvent. For the determination of the molecular mass of associated product, a static light scattering method may be used. The dissolution is preferably effected such that the concurrently determined square radius of inertia ranges from 10 to 200 nm, more preferably from 20 to 200 nm. Further, the dissolution is preferably effected such that the second virial coefficient ranges from −2×10⁻⁴ to +4×10⁻⁴, more preferably from −2×10⁻⁴ to +2×10⁻⁴.

The definition of the molecular mass of the associated product, the square radius of inertia and the second virial coefficient will be described hereinafter. These properties are measured by static light scattering method in the following manner. The measurement is made within a dilute range for the convenience of device, but these measurements reflect the behavior of the dope within the high concentration range of the invention.

Firstly, the cellulose acylate is dissolved in the same solvent as used for dope to prepare solutions having a concentration of 0.1% by mass, 0.2% by mass, 0.3% by mass and 0.4% by mass, respectively. The cellulose acylate to be weighed is dried at 120° C. for 2 hours before use to prevent moistening. The cellulose acylate thus dried is then weighed at 25° C. and 10% RH. The dissolution of the cellulose acylate is effected according to the same method as used in the dope dissolution (ordinary temperature dissolution method, cooled dissolution method, high temperature dissolution method). Subsequently, these solutions with solvent are filtered through a Teflon filter having a pore diameter of 0.2 μm. The solutions thus filtered are each then measured for static light scattering every 10 degrees from 30 degrees to 140 degrees at 25° C. using a Type DLS-700 light scattering device (produced by Otsuka Electronics Co., Ltd.). The data thus obtained are then analyzed by Berry plotting method. For the determination of refractive index required for this analysis, the refractive index of the solvent is measured by an Abbe refractometer. For the determination of concentration gradient of refractive index (dn/dc), the same solvent and solution as used in the measurement of light scattering are measured using a type DRM-1021 different refractometer (produced by Otsuka Electronics Co., Ltd.).

### [Preparation of Dope]

The preparation of the cellulose acylate solution (dope) will be described hereinafter. The method of dissolving the cellulose acylate is not specifically limited. The dissolution of the cellulose acylate may be effected at room temperature. Alternatively, a cooled dissolution method or a high temperature dissolution method may be used. Alternatively, these dissolution methods may be in combination. For the details of the method of preparing a cellulose acylate solution, reference can be made to JP-A-5-163301, JP-A-61-106628, JP-A-58-127737, JP-A-9-95544, JP-A-10-95854, JP-A-10-45950, JP-A-2000-53784, JP-A-1-322946, JP-A-11-322947, JP-A-2-276830, JP-A-2000-273239, JP-A-11-71463, JP-A-04-259511, JP-A-2000-273184, JP-A-11-323017, and JP-A-11-302388.

The aforementioned method of dissolving cellulose acylate in an organic solvent may be applied also to the invention so far as it falls within the scope of the invention. For the details of these methods, reference can be made to Kokai Giho No. 2001-1745, Mar. 15, 2001, pp. 22-25, Japan Institute of Invention and Innovation. The cellulose acylate dope solution of the invention is then subjected to concentration and filtration. For the details of these methods, reference can be made similarly to Kokai Giho No. 2001-1745, Mar. 15, 2001, page 25, Japan Institute of Invention and Innovation. In the case where dissolution is effected at high temperatures, the temperature is higher than the boiling point of the organic solvent used in most cases. In this case, dissolution is effected under pressure.

The viscosity and dynamic storage elastic modulus of the cellulose acylate solution preferably fall within the following range from the standpoint of castability. 1 mL of the sample solution is measured using a Type CLS 500 rheometer (produced by TA Instruments) with a steel cone having a diameter of 4 cm/2° (produced by TA Instruments). Referring to the measurement conditions, measurement is effected every 2° C. per minute within a range of from −10° C. to 40° C. at an oscillation step with temperature ramp to determine 40° C. static non-Newton viscosity n*(Pa·s) and −5° C. storage elastic modulus G′(Pa). The sample solution is previously kept at the measurement starting temperature before measurement.

In the invention, the sample solution preferably has a 40° C. viscosity of from 1 to 400 Pa·s, more preferably from 10 to 200 Pa·s, and a 15° C. dynamic storage elastic modulus of 500 Pa or more, more preferably from 100 to 1,000,000 Pa. The low temperature dynamic storage elastic modulus of the sample solution is preferably as great as possible. For example, if the casting support has a temperature of −5° C., the dynamic storage elastic modulus of the sample solution is preferably from 10,000 to 1,000,000 Pa at −5° C. If the casting support has a temperature of −50° C., the dynamic storage elastic modulus of the sample solution is preferably from 10,000 to 5,000,000 Pa at −50° C.

The invention is characterized in that the use of the aforementioned specific cellulose acylate makes it possible to obtain a high concentration dope. Accordingly, a high concentration cellulose acylate solution having an excellent stability can be obtained without relying on the concentrating method. In order to further facilitate dissolution, the cellulose acylate may be dissolved in a low concentration. The solution thus prepared is then concentrated by a concentrating method. The concentrating method is not specifically limited. For example, a method may be used which comprises introducing a low concentration solution into the gap between a case body and the rotary orbit of the periphery of a rotary blade that rotates circumferentially inside the case body while giving a temperature difference between the solution and the case body to vaporize the solution, thereby obtaining a high concentration solution (see, e.g., JP-A-4-259511). Alternatively, a method may be used which comprises blowing a heated low concentration solution into a vessel through a nozzle so that the solvent is flash-evaporated over the distance from the nozzle to the inner wall of the vessel while withdrawing the solvent thus evaporated from the vessel and the resulting high concentration solution from the bottom of the vessel (see, e.g., U.S. Pat. No. 2,541,012, U.S. Pat. No. 2,858,229, U.S. Pat. No. 4,414,341, U.S. Pat. No. 4,504,355).

Prior to casting, the solution is preferably freed of foreign matters such as undissolved matter, dust and impurities by filtration through a proper filtering material such as metal gauze and flannel. For the filtration of the cellulose acylate solution, a filter having an absolute filtration precision of from 0.1 to 100 μm is preferably used. More preferably, a filter having an absolute filtration precision of from 0.5 to 25 μm is used. The thickness of the filter is preferably from 0.1 to 10 mm, more preferably from 0.2 to 2 mm. In this case, filtration is preferably effected under a pressure of 1.6 MPa or less, more preferably 1.2 MPa or less, even more preferably 1.0 MPa or less, particularly 0.2 MPa or less. As the filtering material there is preferably used any known material such as glass fiber, cellulose fiber, filter paper and fluororesin, e.g., ethylene tetrafluoride resin. In particular, ceramics, metal, etc. are preferably used. The viscosity of the cellulose acylate solution shortly before filming may be arbitrary so far as the cellulose acylate solution can be casted during filming and normally is preferably from 10 Pa·s to 2,000 Pa·s, more preferably from 30 Pa·s to 1,000 Pass, even more preferably from 40 Pa·s to 500 Pa·s. The temperature of the cellulose acylate solution shortly before filming is not specifically limited so far as it is the casting temperature but is preferably from −5° C. to +70° C., more preferably from −5° C. to +55° C.

### [Filming]

The cellulose acylate film of the invention can be obtained by filming the aforementioned cellulose acylate solution. As the filming method and the filming device there may be used any solution casting/filing method and solution casting/filming device for use in the related art method of producing cellulose acylate film, respectively. The dope (cellulose acylate solution) prepared in the dissolving machine (kiln) is stored in a storage kiln so that bubbles contained in the dope are removed to make final adjustment. The dope thus adjusted is then delivered from the dope discharge port to a pressure die through a pressure constant rate gear pump capable of delivering a liquid at a constant rate with a high precision depending on the rotary speed. The dope is then uniformly casted through the slit of the pressure die over a metallic support in the casting portion which is being running endlessly. When the metallic support has made substantially one turn, the half-dried dope film (also referred to as “web”) is then peeled off the metallic support. The web thus obtained is then dried while being conveyed by a tenter with the both ends thereof being clamped by a clip to keep its width. Subsequently, the web is conveyed by a group of rolls in the drying apparatus to finish drying. The web is then wound to a predetermined length by a winding machine. The combination of tenter and a group of rolls varies with the purpose. In a solution casting/filming method for use in functional protective film for electronic display, a coating device is often added to the solution casting/filming device for the purpose of surface working of film such as subbing layer, antistatic layer, anti-halation layer and protective layer. The various producing steps will be briefly described hereinafter, but the invention is not limited thereto.

Firstly, in order to prepare a cellulose acylate film by a solvent casting method, the cellulose acylate solution (dope) thus prepared is casted over a drum or band so that the solvent is evaporated to form a film. The dope to be casted is preferably adjusted in its concentration such that the solid content is from 5 to 40% by mass. The surface of the drum or band is previously mirror-like finished. The dope is preferably casted over a drum or band having a surface temperature of 30° C. or less, particularly over a metallic support having a temperature of from −10 to 20° C. Further, methods disclosed in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511, and JP-A-02-208650 may be used in the invention.

### [Multi-Layer Casting]

The cellulose acylate solution may be casted over a smooth band or drum as a metallic support in the form of a single layer. Alternatively, two or more cellulose acylate solutions may be casted over the metallic support. In the case where a plurality of cellulose acylate solutions are casted, a cellulose acylate-containing solution may be casted over the metallic support through a plurality of casting ports disposed at an interval along the direction of running of the metallic support to make lamination. For example, any method as disclosed in JP-A-61-158414, JP-A-1-122419, and JP-A-11-198285 may be employed. Alternatively, a cellulose acylate solution may be casted through two casting ports to make filming. For example, any method as disclosed in JP-B-60-27562, JP-A-61-94724, JP-A-61-947245, JP-A-61-104813, JP-A-61-158413, and JP-A-6-134933 may be employed. As disclosed in JP-A-56-162617, a cellulose acylate film casting method may be used which comprises simultaneously casting a high viscosity cellulose acylate solution and a low viscosity cellulose acylate solution with a flow of the high viscosity cellulose acylate solution surrounded by the low viscosity cellulose acylate solution. Further, as disclosed in JP-A-61-94724 and JP-A-61-94725, it is a preferred embodiment that the outer solution contains a greater content of an alcohol component as a poor solvent than the inner solution. Alternatively, two casting ports may be used so that the film formed on the metallic support by the first casting port is peeled off the metallic support and the second casting is then made on the side of the film which has come in contact with the metallic support. For example, a method disclosed in JP-B-44-20235 may be used. The cellulose acylate solutions to be casted may be the same or different and thus are not specifically limited. In order to render a plurality of cellulose acylate layers functional, cellulose acylate solutions having a formulation according to the function may be extruded through the respective casting port. The casting of the cellulose acylate solution may be accompanied by the casting of other functional layers (e.g., adhesive layer, dye layer, antistatic layer, anti-halation layer, ultraviolet-absorbing layer, polarizing layer).

In order to form a film having a desired thickness from the related art single layer solution, it is necessary that a cellulose acylate solution having a high concentration and a high viscosity be extruded. In this case, a problem often arises that the cellulose acylate solution exhibits a poor stability and thus forms a solid material that causes the generation of granular structure or poor planarity. In order to solve these problems, a plurality of cellulose acylate solutions can be casted through casting ports, making it possible to extrude high viscosity solutions onto the metallic support at the same time. In this manner, a film having an improved planarity and hence excellent surface conditions can be prepared. Further, the use of a highly concentrated cellulose acylate solution makes it possible to attain the reduction of the drying load that can enhance the production speed of film.

In the case of co-casting method, the thickness of the inner solution and the outer solution are not specifically limited, but the thickness of the outer solution is preferably from 1 to 50%, more preferably from 2 to 30% of the total thickness. In the case of co-casting of three of more layers, the sum of the thickness of the layer in contact with the metallic support and the layer in contact with air is defined as the thickness of the outer layer. In the case of co-casting, cellulose acylate solutions having different concentrations of the aforementioned additives such as plasticizer, ultraviolet absorber and matting agent can be co-casted to a cellulose acylate film having a laminated structure. For example, a cellulose acylate film having a skin layer/core layer/skin layer structure can be prepared. For example, the matting agent can be incorporated much or only in the skin layer. The plasticizer and ultraviolet absorber may be incorporated more in the core layer than in the skin layer or only in the core layer. The kind of the plasticizer and the ultraviolet absorber may differ from the core layer to the skin layer. For example, at least either of low volatility plasticizer and ultraviolet absorber may be incorporated in the skin layer while a plasticizer having an excellent plasticity or an ultraviolet absorber having excellent ultraviolet absorbing properties may be incorporated in the core layer. In another preferred embodiment, a peel accelerator may be incorporated in only the skin layer on the metallic support side. It is also preferred that the skin layer contain an alcohol as a poor solvent more than the core layer in order that the solution might be gelled by cooling the metallic support by a cooled drum method. The skin layer and the core layer may have different Tg values. It is preferred that Tg of the core layer be lower than that of the skin layer. Further, the viscosity of the solution containing cellulose acylate may differ from the skin layer to the core layer during casting. It is preferred that the viscosity of the skin layer be lower than that of the core layer. However, the viscosity of the core layer may be lower than that of the skin layer.

### (Casting)

Examples of the solution casting method include a method which comprises uniformly extruding a dope prepared onto a metallic support through a pressure die, a doctor blade method which comprises adjusting the thickness of a dope casted over a metallic support using a blade, and a reverse roll coater method which comprises adjusting the thickness of the dope casted using a roll that rotates in the reverse direction. Preferred among these casting methods is the pressure die method. Examples of the pressure die include coat hunger type pressure die, and T-die type pressure die. Any of these pressure dies may be preferably used. Besides the aforementioned methods, various conventional methods for casting/filming a cellulose triacetate solution may be effected. By predetermining the various conditions taking into account the difference in boiling point between solvents used, the same effects as the contents disclosed in the above cited references can be exerted.

As the endless running metallic support to be used in the production of the cellulose acylate film which is preferably used in the invention there may be used a drum which has been mirror-like finished by chromium plating or a stainless steel belt (also referred to as “band”) which has been mirror-like finished by polishing. One or more pressure dies for producing the cellulose acylate film of the invention may be disposed above the metallic support. Preferably, the number of pressure dies is 1 or 2. In the case where two or more pressure dies are provided, the dope to be casted may be allotted to these dies at various ratios. A plurality of precision constant rate gear pumps may be used to deliver the dope to these dies at the respect ratio. The temperature of the cellulose acylate solution to be casted is preferably from −10 to 55° C., more preferably from 25° C. to 50° C. In this case, the temperature of the cellulose acylate solution may be the same at all the steps or may differ from step to step. In the latter case, it suffices if the temperature of the cellulose acylate solution is the desired temperature shortly before being casted.

### [Drying]

General examples of the method of drying the dope on the metallic support in the production of the cellulose acylate film include a method which comprises blowing a hot air against the web on the front surface of the metallic support (drum or band), that is, the front surface of the web on the metallic support or on the back surface of the drum or band, and a liquid heat conduction method which comprises allowing a temperature-controlled liquid to come in contact with the back surface of the belt or drum, which is the side thereof opposite the dope casting surface, so that heat is conducted to the drum or belt to control the surface temperature. Preferred among these drying methods is the back surface liquid heat conduction method. The surface temperature of the metallic support before casting may be arbitrary so far as it is not higher than the boiling point of the solvent used in the dope. However, in order to accelerate drying or eliminate fluidity on the metallic support, it is preferred that the surface temperature of the metallic support be predetermined to be from 1 to 10° C. lower than the boiling point of the solvent having the lowest boiling point among the solvents used. However, this limitation is not necessarily applied in the case where the casted dope is cooled and peeled off the metallic support without being dried.

### [Stretching]

The cellulose acylate film which is preferably used in the invention may be subjected to stretching to adjust the retardation thereof. In particular, in order to raise the in-plane retardation value of the cellulose acylate film, a method involving positive crosswise stretching such as method involving stretching of film produced as disclosed in JP-A-62-115035, JP-A-4-152125, JP-A-4-284211, JP-A-4-298310, and JP-A-11-48271 may be used.

The stretching of the film is effected at ordinary temperature or under heating. The heating temperature is preferably not higher than the glass transition temperature of the film. The film may be subjected to monoaxial stretching only in the longitudinal or crosswise direction or may be subjected to simultaneous or successive biaxial stretching. The stretching is normally effected by a factor or from 1% to 200%, preferably from 1% to 100%, more preferably from 1% to 50%.

In order to inhibit the occurrence of light leakage when the optically anisotropic compensation and polarizing plates of liquid crystal cell are viewed obliquely, a protective film having an in-plane retardation value of 30 nm or more is preferably used. To this end, a stretched cellulose acylate film is used. In some detail, a cellulose acylate film which has been stretched by a factor of 10% or more, preferably 15% or more is used.

In order to inhibit the occurrence of light leakage when the aforementioned polarizing plate is viewed obliquely, it is necessary that the transmission axis of the polarizer and the in-plane slow axis of the cellulose acylate film be disposed parallel to each other. Since the transmission axis of the polarizer in the form of rolled film obtained by continuous process is parallel to the crosswise direction of the rolled film, it is necessary that the in-plane slow axis of the protective film in the form of rolled film be parallel to the crosswise direction of the film to continuously laminate the polarizer in the form of rolled film with the protective film composed of cellulose acylate film in the form of rolled film. Accordingly, the cellulose acylate film is preferably stretched more crosswise. The stretching may be effected during filming step. Alternatively, the raw fabric which has been wound may be stretched. In the former case, the film may be stretched with the residual solvent contained therein. When the residual solvent content is from 2% to 30%, stretching is preferably effected.

The thickness of the cellulose acylate film which is preferably used in the invention thus dried depends on the purpose but is normally preferably from 5 to 500 μm, more preferably from 20 to 300 μm, particularly from 30 to 150 μm. Further, the thickness of the cellulose acylate film for optical devices, particularly for VA liquid crystal display device, is preferably from 40 to 110 μm. In order to adjust the thickness of the film to the desired value, the concentration of solid content in the dope, the gap of slit of the die, the extrusion pressure of die, the speed of metallic support, etc. may be properly adjusted.

The width of the cellulose acylate film thus obtained is preferably from 0.5 to 3 m, more preferably from 0.6 to 2.5 m, even more preferably from 0.8 to 2.2 m. The winding length of the film per roll is preferably from 100 to 10,000 m, more preferably 500 to 7,000 m, even more preferably from 1,000 to 6,000. During winding, the film is preferably knurled at least at one edge thereof. The width of the knurl is preferably from 3 mm to 50 mm, more preferably from 5 mm to 30 mm. The height of the knurl is preferably from 0.5 to 500 nm, more preferably from 1 to 200 μm. The edge of the film may be knurled on one or both surfaces thereof.

The crosswise dispersion of Re₅₉₀ value is preferably ±5 nm, more preferably ±3 mm. The crosswise dispersion of Rth₅₉₀ value is preferably ±10 nm, more preferably ±5 nm. The longitudinal dispersion of Re value and Rth value preferably falls within the crosswise dispersion of Re value and Rth value.

### [Optical Properties of Cellulose Acylate Film]

The terms “Reλ” and “Rthλ” as used herein are meant to indicate in-plane retardation and thickness direction retardation at a wavelength λ, respectively. Reλ is measured by the incidence of light having a wavelength λ nm in the direction normal to the film in “KOBRA 21ADH” (produced by Ouji Scientific Instruments Co. Ltd.). Rthλ is calculated by “KOBRA 21ADH” on the basis of retardation values measured in the total three directions, i.e., Reλ, retardation value measured by the incidence of light having a wavelength λ nm in the direction inclined at an angle of +40° from the direction normal to the film with the in-plane slow axis (judged from “KOBRA 21ADH”) as an inclined axis (rotary axis), retardation value measured by the incidence of light having a wavelength λ nm in the direction inclined at an angle of −40° from the direction normal to the film.

As a hypothetical average refractive index there may be used one disclosed in “Polymer Handbook”, John Wiley & Sons, Inc. and various catalogues of optical films. For the cellulose acylate films having an unknown average refractive index, an Abbe refractometer may be used. The average refractive index of main optical films are exemplified below.

Cellulose acylate (1.48), cycloolefin polymer (1.52), polycarbonate (1.59), polymethylene methacrylate (1.49), polystyrene (1.59)

By inputting the hypothetic average refractive indexes and film thicknesses, KOBRA 21ADH calculates nₓ (refractive index in the slow axis direction), n_{y} (refractive index in the fast axis direction) and n_{z} (refractive index in the thickness direction). KOBRA 21ADH also calculates the angle β with respect to the direction normal to the film at which the retardation value is minimum with respect to light propagated by the interior of the film in the case where the in-plane slow axis is an inclined axis.

Reλ retardation value and Rthλ retardation value preferably satisfy the following numerical formulae (2) and (3), respectively, to raise the viewing angle of the liquid crystal display device, particularly of VA mode. These requirements are preferably satisfied particularly when the cellulose acylate film is used as a liquid crystal cell side protective film for polarizing plate.

0 nm≦Re₅₉₀≦200 nm (2)

0 nm≦Rth₅₉₀≦400 nm (3)

wherein Re₅₉₀ and Rth₅₉₀ each are a value (unit: nm) at a wavelength λ of 590 mm.

In order to eliminate the effect of optical anisotropy of cellulose acylate film, Reλ and Rthλ of the protective film (cellulose acylate film) disposed on the liquid crystal cell side preferably satisfy the numerical formulae (8) to (11):

0≦|Re₅₉₀|≦10 (8)

|Rth₅₉₀|≦25 (9)

|Re₄₀₀−Re₇₀₀|≦10 (10)

|Rth₄₀₀−Rth₇₀₀|≦35 (0.11)

wherein Re₅₉₀ and Rth₅₉₀ each are a value at a wavelength λ of 590 nm; Re₄₀₀ and Rth₄₀₀ each are a value at a wavelength λ of 400 nm; and Re₇₀₀ and Rth₇₀₀ each are a value at a wavelength λ of 700 nm (unit: nm).

In the case where the cellulose acylate film which is preferably used in the invention is used in VA mode, there are two cases of configuration. In one configuration, a sheet of cellulose acylate film is provided on both sides of the cell, totaling two sheets (two-plate type). In the other configuration, a sheet of cellulose acylate film is provided on only one of upper and lower sides of the cell (one-plate type).

In the case of two-plate type configuration, Re₅₉₀ is preferably from 20 nm to 100 nm, more preferably from 30 nm to 70 nm. Rth₅₉₀ is preferably from 70 nm to 300 nm, more preferably from 100 nm to 200 nm.

In the case of one-plate type configuration, Re₅₉₀ is preferably from 30 nm to 150 nm, more preferably from 40 nm to 100 nm. Rth₅₉₀ is preferably from 100 nm to 300 nm, more preferably from 150 nm to 250 nm.

The in-plane slow axis angle of the cellulose acylate film which is preferably used in the invention preferably varies within the range of from −2° to +2°, more preferably −1° to +1°, most preferably from −0.5° to +0.5° with respect to the reference direction of rolled film. The term “reference direction” as used herein is meant to indicate the longitudinal direction of rolled film in the case wherein the cellulose acylate film is longitudinally stretched or the crosswise direction of rolled film in the case wherein the cellulose acylate film is crosswise stretched.

In the cellulose acylate film which is preferably used in the invention, the difference ΔRe (=Re_{10%}−Re_{80%}) between Re value at 25° C.-10% RH and Re value at 25° C.-80% RH and the difference ΔRth (=Rth_{10%}−Re_{80%}) between Rth value at 25° C.-10% RH and Rth value at 25° C.-80% RH are preferably from 0 nm to 10 nm and from 0 nm to 30 nm to eliminate tint change of liquid crystal display device with time.

Further, in the cellulose acylate film which is preferably used in the invention, the equivalent water content at 25° C. and 80% RH is preferably 3.2% or less to eliminate tint change of liquid crystal display device with time.

For the measurement of water content, a cellulose acylate film sample having a size of 7 mm×35 mm is subjected to Karl Fischer method using a Type CA-03 water content meter and a Type VA-05 sample dryer (produced by Mitsubishi Chemical Corporation). The water content is calculated by dividing the amount of water (g) by the mass of the sample (g).

Moreover, the cellulose acylate film which is preferably used in the invention preferably exhibits a moisture permeability of from not smaller than 400 g/m²·24 hr to not greater than 1,800 g/m²·24 hr after 24 hours of 60° C. and 95% RH (as calculated in terms of 80 μm thickness) to eliminate tint change of liquid crystal display device with time.

The more the thickness of the cellulose acylate film is, the smaller is moisture permeability. On the contrary, the less the thickness of the cellulose acylate film is, the greater is moisture permeability. Therefore, it is necessary that a reference thickness on the basis of which conversion is made be predetermined for any sample thickness. In the invention, the reference thickness is predetermined to be 80 μm. The moisture permeability is calculated in equivalence of 80 μm according to the following numerical formula (13).

Moisture permeability in 80 μm equivalence=Measured moisture permeability×measured thickness (μm)/80 μm (13)

For the measurement of moisture permeability, the method disclosed in “Koubunshi no Bussei II (Physical Properties of Polymers II)”, Institute 4 of Polymer Experiment, Kyoritsu Shuppan, pp. 285-294: Measurement of Vapor Permeability (mass process, thermometer process, vapor pressure process, adsorption process) may be used.

For the measurement of glass transition temperature, a cellulose acylate film sample (unstretched) having a size of 5 mm×30 mm is moisture-conditioned at 25° C. and 60% RH for 2 hours. Using a Type DVA-225 Vibron dynamic viscoelasticity meter (produced b IT Keisoku Seigyo Co., Ltd.), the sample thus moisture-conditioned is measured at a grip separation distance of 20 mm, a temperature rising rate of 2° C./min, a measurement temperature range of from 30° C. to 200° C. and a frequency of 1 Hz. The temperature at which a sudden decrease of storage elastic modulus is shown when the state of the sample moves from solid range to glass transition range on a graph having storage elastic modulus and temperature (° C.) plotted logarithmically as ordinate and linearly as abscissa, respectively, is defined as glass transition temperature Tg. In some detail, the point of crossing of the straight line 1 drawn in the solid range on the chart thus obtained with the straight line 2 drawn in the glass transition range on the chart corresponds to the temperature at which the storage modulus shows a sudden change to initiate softening of film during temperature rise, i.e., the temperature at which the state of the sample begins to move to the glass transition range. This temperature is defined as glass transition temperature Tg (dynamic viscoelasticity).

For the measurement of elastic modulus, a cellulose acylate film sample having a size of 10 mm×150 mm is moisture-conditioned at 25° C. and 60% RH for 2 hours. Using a Type Strograph-R2 tensile testing machine (produced by Toyo Seiki Seisaku-Sho, Ltd.), the sample thus moisture-conditioned is measured at a chuck separation distance of 100 mm, a temperature of 25° C. and a stretching rate of 10 mm/min.

For the determination of hygroscopic expansion coefficient, the dimension of a film which has been allowed to stand at 25° C. and 80% RH for 2 hours and a film which has been allowed to stand at 25° C. and 10% RH for 2 hours are measured as L_{80%} and L_{10%}, respectively, using a pin gauge. From L_{80%} and L_{10%} is calculated the hygroscopic expansion coefficient according to the following numerical formula (14):

(L_{80%}−L_{10%})/(80% RH−10% RH)×10⁶ (14)

The cellulose acylate film which is preferably used in the invention preferably has a haze of from 0.01% to 2%. The haze of the cellulose acylate film can be measured in the following manner.

A cellulose acylate film sample having a size of 40 mm×80 mm is measured for haze at 25° C. and 60% RH according to JIS K-6714 using a Type HGM-2DP haze meter (produced by SUGA TEST INSTRUMENTS CO., LTD.).

Further, the cellulose acylate film which is preferably used in the invention preferably shows a mass change of from 0% to 5% by mass when allowed to stand at 80° C. and 90% RH for 48 hours.

Moreover, the cellulose acylate film which is preferably used in the invention preferably shows a dimensional change of from 0% to 5% when allowed to stand at 60° C. and 95% RH for 24 hours and when allowed to stand at 90° C. and 5% RH for 24 hours.

The cellulose acylate film of the invention preferably exhibits a photoelastic coefficient of 50×10⁻¹³ cm²/dyne or less to eliminate tint change of liquid crystal display device with time.

Explaining the measuring method in detail, a cellulose acylate film having a size of 10 mm×100 mm is subjected to application of tensile stress in the direction of major axis. The resulting retardation is measured using a Type M150 ellipsometer (produced by JASCO). The photoelastic coefficient is calculated from the change of retardation with stress.

### {Cycloolefin-Based Polymer}

As the protective film there may be used a cycloolefin-based polymer instead of cellulose acylate. Examples of the cycloolefin-based polymer employable herein include those disclosed in JP-A-1-132625, JP-A-1-132626, JP-A-1-240517, JP-A-63-145324, JP-A-63-264626, JP-A-63-218726, JP-A-2-133413, JP-A-60-168708, JP-A-61-120816, JP-A-60-115912, JP-A-62-252406, JP-A-60-252407, International Patent Disclosure No. 2004/049011A pamphlet, International Patent Disclosure No. 2004/068226A1 pamphlet, and International Patent Disclosure No. 2004/070463A1 pamphlet. Examples of marketed cycloolefin-based polymers employable herein include ARTON (produced by JSR Co., Ltd.), ZEONOR (produced by ZEON CORPORATION), ZEONEX (produced by ZEON CORPORATION), and Escena (produced by SEKISUI CHEMICAL CO., LTD.)

Referring to the cycloolefin-based polymer film, in order to eliminate the effect of its optical anisotropy, Reλ and Rthλ of the protective film (cycloolefin-based polymer film) provided on the liquid crystal cell side of the polarizer preferably satisfy the aforementioned numerical formulae (8) to (11).

<Polarizing Plate>

The polarizing plate according to the invention will be further described hereinafter.

In the polarizing plate according to the invention, the thickness d₁ of the protective film disposed on the liquid crystal cell side of the polarizer and the thickness d₂ of the protective film disposed on the side of the polarizer opposite the liquid crystal cell preferably satisfy the following numerical formula (15):

0.3×d₁≦d₂≦1.3×d₁ (15)

When the aforementioned numerical formula (15) is satisfied, the curl of the polarizing plate falls within a range of from −30 mm to +15 mm in the case where protective films having substantially the same elastic modulus and hygroscopic expansion coefficients are combined, making it possible to obtain desirable results.

Further, in the polarizing plate according to the invention, the elastic modulus E1 of the protective film disposed on the liquid crystal cell side of the polarizer and the elastic modulus E₂ of the protective film disposed on the side of the polarizer opposite the liquid crystal cell preferably satisfy the following numerical formula (16). In this arrangement, the curl of the polarizing plate falls within a range of from −30 mm to +15 mm in the case where protective films having substantially the same thicknesses and hygroscopic expansion coefficients are combined, making it possible to obtain desirable results.

0.3×E₁≦E₂≦1.3×E₁ (16)

Moreover, the thickness d₁ of the protective film disposed on the liquid crystal cell side and the elastic modulus E₁ and the thickness d₂ of the protective film disposed on the side opposite to the liquid crystal cell and the elastic modules E₂ preferably satisfy the following numerical formula (17):

0.3×E₁×d₁≦E₂×d₂≦1.3×E₁×d₁ (17)

When the aforementioned numerical formula (17) is satisfied, the curl of the polarizing plate falls within a range of from −30 mm to +15 mm also in the case where protective films having substantially the same thicknesses and hygroscopic expansion coefficients are combined.

Further, in the polarizing plate according to the invention, the hygroscopic expansion coefficient C₁ of the protective film disposed on the liquid crystal cell side of the polarizer and the hygroscopic expansion coefficient C₂ of the protective film disposed on the side of the polarizer opposite the liquid crystal cell preferably satisfy the following numerical formula (18):

0.3×C₁≦C₂≦1.3×C₁ (18)

When the aforementioned numerical formula is satisfied, the curl of the polarizing plate falls within a range of from −30 mm to +15 mm in the case where the humidity during the sticking of the polarizing plate to the liquid crystal cell is higher than during the preparation of the polarizing plate, making it possible to obtain desirable results.

Examples of the polarizer in polarizing film include iodine-based polarizers, dye-based polarizers comprising a dichromatic die, and polyene-based polarizers. The iodine-based polarizer and the dye-based polarizer are normally produced from a polyvinyl alcohol-based film.

In the case where a cellulose acylate film which is preferably used in the invention is used as a protective film for polarizing plate, the method of preparing the polarizing plate is not specifically limited but may be any ordinary method. For example, a method may be employed which comprises subjecting a cellulose acylate film obtained to alkaline treatment, and then sticking the cellulose acylate film to the both surfaces of a polarizer prepared by dipping and stretching a polyvinyl alcohol in an iodine solution with an aqueous solution of a fully-saponified polyvinyl alcohol. A processing for easy adhesion as disclosed in JP-A-6-94915 and JP-A-6-118232 may be effected instead of alkaline treatment. Examples of the adhesive with which the processed surface of the protective film and the polarizer are stuck to each other include polyvinyl-based adhesives such as polyvinyl alcohol and polyvinyl butyral, and vinyl-based latexes such as butyl acrylate.

In the case where such a cycloolefin-based polymer film is used as a protective film for polarizing plate, as an adhesive there may be used an adhesive such as acrylic polymer, epoxy-based polymer, modified olefin-based polymer and styrene butadiene-based polymer and special synthetic rubber besides polyvinyl alcohol-based adhesive such as polyvinyl alcohol and polyvinyl butyral and vinyl-based latex such as butyl acrylate.

In order to enhance the adhesion of the cellulose acylate film, the cellulose acylate film may be subjected to surface treatment. Specific examples of the surface treatment process employable herein include corona discharge treatment, glow discharge treatment, flame treatment, acid treatment, alkali treatment, and ultraviolet irradiation. Alternatively, the cellulose acylate film may have a subbing layer provided thereon as disclosed in JP-A-7-333433. From the standpoint of maintenance of planarity of the film, the polymer film is preferably kept at Tg (glass transition temperature) or less during these treatments.

The polarizing plate comprises a polarizer, a protective film for protecting the both surfaces thereof and an adhesive layer provided on at least one side thereof. The polarizing plate may further have a separate film provided on the surface of the adhesive layer and a protective film provided on the side of the polarizing plate opposite the separate film. The protective film and the separate film are used for the purpose of protecting the surface of the polarizing plate during the shipment of the polarizing plate and during the inspection of the product. In this case, the protective film is stuck to the polarizing plate for the purpose of protecting the surface of the polarizing plate. The protective film is provided on the side of the polarizing plate opposite the side on which it is stuck to the liquid crystal cell. The separate film is used for the purpose of covering the adhesive layer to be stuck to the liquid crystal cell. The separate film is provided on the side of the polarizing plate on which it is stuck to the liquid crystal cell.

The adhesive layer is formed by spreading a solution of a composition comprising a (meth)acrylic copolymer composed of the (meth)acrylic copolymer (A) {or high molecular (meth)acrylic copolymer (A₁) and low molecular (meth)acrylic (co)polymer (A₂)} and the polyfunctional compound (B) over a separate film using a coater such as die coater, drying the coat layer, and then transferring the coat layer onto a protective film for polarizing plate together with the separator film. Alternatively, a separator film may be provided to cover the coat layer obtained by spreading the aforementioned composition solution over the protective film for polarizing plate, and then drying the spread.

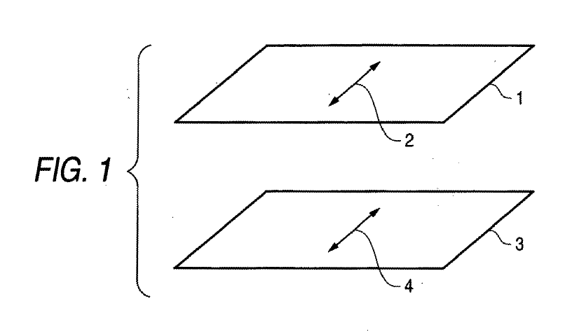

Referring to the sticking of the aforementioned stretched cellulose acylate film, if used, to the polarizer, the two components are preferably stuck to each other in such an arrangement that the transmission axis 2 of the polarizer 1 and the slow axis 4 of the cellulose acylate film 3 (TAC in FIG. 1) coincide with each other as shown in FIG. 1.

In the polarizing plate prepared under polarizing plate crossed nicols, when the precision in right-angle crossing of the slow axis of the cellulose acylate film of the invention with the absorption axis of the polarizer (perpendicular to the transmission axis) is greater than 1°, the polarizing properties under polarizing plate crossed nicols are deteriorated to cause light leakage. When such a polarizing plate is combined with a liquid crystal cell, sufficient black level or contrast cannot be obtained. Accordingly, the deviation of the direction of the main refractive index nx of the cellulose acylate film of the invention from the direction of the transmission axis of the polarizing plate needs to be 1° or less, preferably 0.5° or less.

The sticking of the polarizing plate to the liquid crystal cell is normally carried out by a process which comprises attaching the polarizing plate to a suction fixture having a numerous holes formed therein, peeling the separate film off the surface of the polarizing plate on which an adhesive is provided, bringing the adhesive surface of the polarizing plate into contact with the liquid crystal cell, and then pressing the laminate under a roller. In this procedure, when the polarizing plate is curled and bent toward the liquid crystal cell, the suction of the polarizing plate by the suction fixture cannot be fairly made, causing deviation of the angle at which the polarizing plate is attached to the suction fixture and hence deviation of the angle at which the polarizing plate is stuck to the liquid crystal cell and making it impossible to obtain the designed display properties. Further, the polarizing plate can come off the suction fixture during the sticking of the polarizing plate to the liquid crystal cell, making it impossible to continue sticking. In some cases, the operation can be suspended.

In order to prevent the occurrence of such malsticking of the polarizing plate, it is preferred that the curling of the polarizing plate fall within a range of from −30 mm to +15 mm, more preferably from −20 mm to +5 mm, most preferably from −10 mm to 0 mm. When the polarizing plate is curled and bent toward the side thereof on which it is stuck to the liquid crystal cell (adhesive coat side), it is called + (plus) curl. On the contrary, when the polarizing plate is curled and bent toward to the side of the polarizing plate opposite the adhesive coat side, it is called − (minus) curl. The curling of the polarizing plate can be controlled by adjusting the relationship between the thickness, elastic modulus and hygroscopic expansion coefficient of the protective film disposed on the liquid crystal cell side of the polarizer and the protective film disposed on the side of the polarizer opposite the liquid crystal cell side.

For the measurement of the curling of the polarizing plate, a polarizing plate having a size of 230 mm×305 mm is placed on a flat table with the side thereof having rising ends facing downward. The sample is then allowed to stand at 25° C. and 60% RH for 2 hours or more. The highest height of the end of the polarizing plate from the surface of the table is then measured to determine the curling. In the case where the polarizing plate is provided with a separate film and a protective film, measurement is conducted with these films left attached to the polarizing plate.

### [Surface Treatment]

The cellulose acylate film of the invention may be optionally subjected to surface treatment to attain the enhancement of the adhesion of the cellulose acylate film to the various functional layers (e.g., undercoat layer and back layer). Examples of the surface treatment employable herein include glow discharge treatment, irradiation with ultraviolet rays, corona treatment, flame treatment, and acid or alkaline treatment. The glow discharge treatment employable herein may involve the use of low temperature plasma developed under a low gas pressure of from 10⁻³ to 20 Torr, even more preferably plasma under the atmospheric pressure. The plasma-excitable gas is a gas which can be excited by plasma under the aforementioned conditions. Examples of such a plasma-excitable gas include argon, helium, neon, krypton, xenon, nitrogen, carbon dioxide, fluorocarbon such as tetrafluoromethane, and mixture thereof. For the details of these plasma-excitable gases, reference can be made to Kokai Giho No. 2001-1745, Mar. 15, 2001, pp. 30-32, Japan Institute of Invention and Innovation. In the plasma treatment under the atmospheric pressure, which has been recently noted, a radiation energy of from 20 to 500 Kgy is used under an electric field of from 10 to 1,000 Kev. Preferably, a radiation energy of from 20 to 300 Kgy is used under an electric field of from 30 to 500 Kev. Particularly preferred among these surface treatments is alkaline saponification, which is extremely effective for the surface treatment of the cellulose acylate film.

### [Alkaline Saponification]

The alkaline saponification is preferably carried out by dipping the cellulose acylate film directly in a saponifying solution tank or by spreading a saponifying solution over the cellulose acylate film. Examples of the coating method employable herein include dip coating method, curtain coating method, extrusion coating method, bar coating method, and E type coating method. As the solvent for the alkaline saponification coating solution there is preferably selected a solvent which exhibits good wetting properties and can keep the surface conditions of the cellulose acylate film good without roughening the surface thereof because the saponifying solution is spread over the cellulose acylate film. In some detail, an alcohol-based solvent is preferably used. An isopropyl alcohol is particularly preferred. Further, an aqueous solution of a surface active agent may be used as a solvent. The alkali of the alkaline saponification coating solution is preferably an alkali soluble in the aforementioned solvent, more preferably KOH or NaOH. The pH value of the saponification coating solution is preferably 10 or more, more preferably 12 or more. During the alkaline saponification, the reaction is preferably effected at room temperature for 1 second to 5 minutes, more preferably 5 seconds to 5 minutes, particularly 20 seconds to 3 minutes. The cellulose acylate film thus alkaline-saponified is preferably washed with water or an acid and then with water on the saponifying solution-coated surface thereof.

Further, the polarizing plate according to the invention preferably comprises an optically anisotropic layer provided on the protective film.

The material constituting the optically anisotropic layer is not limited. The material of the optically anisotropic layer may be a liquid crystal compound, non-liquid crystal compound, inorganic compound, organic/inorganic compound or the like. As the liquid crystal compound there may be used a low molecular compound having a polymerizable group which can be oriented and then optically or thermally polymerized to fix its orientation or a liquid crystal polymer which can be heated to undergo orientation and then cooled to fix its orientation in glass state. As such a liquid crystal compound there may be used one having a disc-shaped structure, one having a rod-shaped structure or one having an optically biaxial structure. As the non-liquid crystal compound there may be used a polymer having an aromatic ring such as polyimide and polyester.

The formation of the optically anisotropic layer can be carried out by any method such as coating, vacuum deposition and sputtering.

In the case where the optically anisotropic layer is provided on the protective film for polarizing plate, the adhesive layer is provided more outside the polarizer than the optically anisotropic layer.

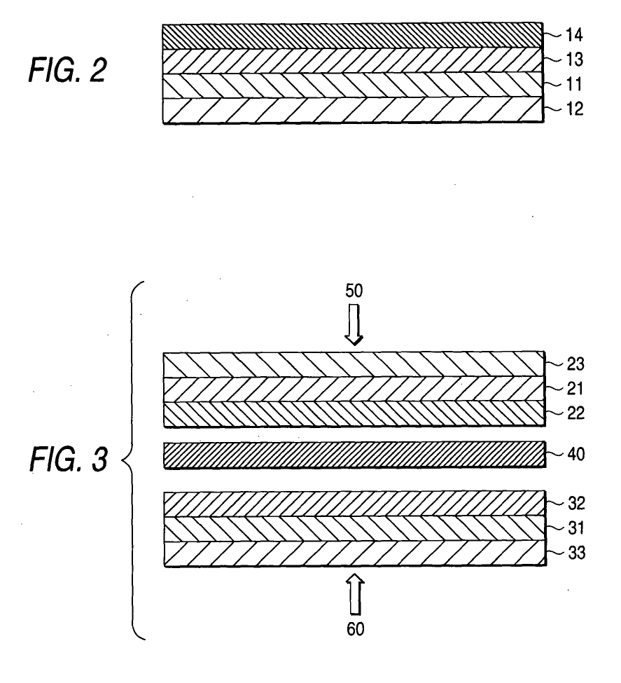

The polarizing plate of the invention preferably comprises at least one of hard coat layer, anti-glare layer and anti-reflection layer provided on the surface of the protective film disposed on the other side of the polarizing plate. In some detail, as shown in FIG. 2, a functional layer such as anti-reflection layer is preferably provided on the protective film (TAC2) disposed on the side of the polarizing plate opposite the liquid crystal cell during the use of the polarizing plate in the liquid crystal display device. As such a functional layer there is preferably provided at least one of hard coat layer, anti-glare layer and anti-reflection layer. The various layers do not necessarily need to be provided as separate layers. For example, the anti-reflection layer or hard coat layer may be provided with the function of anti-glare layer so that the anti-reflection layer or hard coat layer acts also as an anti-glare layer.

### [Anti-Reflection Layer]

In the invention, an anti-reflection layer comprising at least a light-scattering layer and a low refractive layer laminated on a protective film in this order or an anti-reflection layer comprising a middle refractive layer, a high refractive layer and a low refractive layer laminated on a protective film of polarizing plate in this order is preferably used. Preferred examples of such an anti-reflection layer will be given below. The former configuration normally exhibits a specular reflectance of 1% or more and is called low reflection (LR) film. The latter configuration can attain a specular reflectance of 0.5% or less and is called anti-reflection (AR) film.

### [LR Film]

A preferred example of the anti-reflection layer (LR film) comprising a light-scattering layer and a low refractive layer provided on a protective film will be described below.

The light-scattering layer preferably has a particulate mat dispersed therein. The refractive index of the material of the light-scattering layer other than the particulate mat is preferably from 1.50 to 2.00. The refractive index of the low refractive layer is preferably from 1.20 to 1.49. In the invention, the light-scattering layer has both anti-glare properties and hard coating properties. The light-scattering layer may be formed by a single layer or a plurality of layers such as two to four layers.

The anti-reflection layer is preferably designed in its surface roughness such that the central line average roughness Ra is from 0.08 to 0.40 μm, the ten point averaged roughness Rz is 10 times or less Ra, the average distance between mountain and valley Sm is from 1 to 100 μm, the standard deviation of the height of mountains from the deepest portion in roughness is 0.5 μm or less, the standard deviation of the average distance between mountain and valley Sm with central line as reference is 20 μm or less and the proportion of the surface having an inclination angle of from 0 to 5 degrees is 10% or less, making it possible to attain sufficient anti-glare properties and visually uniform matte finish.

Further, when the tint of reflected light under C light source comprises a* value of −2 to 2 and b* value of −3 to 3 and the ratio of minimum reflectance to maximum reflectance at a wavelength of from 380 nm to 780 nm is from 0.5 to 0.99, the tint of reflected light is neutral to advantage. Moreover, when the b* value of transmitted light under C light source is predetermined to range from 0 to 3, the yellow tint of white display for use in display devices is reduced to advantage. Further, when a lattice of having a size of 120 μm×40 μm is disposed interposed between the planar light source and the anti-reflection film of the invention so that the standard deviation of brightness distribution measured over the film is 20 or less, glare developed when the film of the invention is applied to a high precision panel can be eliminated to advantage.

When the optical properties of the anti-reflection layer employable herein are such that the specular reflectance is 2.5% or less, the transmission is 90% or more and the 60° gloss is 70% or less, the reflection of external light can be inhibited, making it possible to enhance the viewability to advantage. In particular, the specular reflectance is more preferably 1% or less, most preferably 0.5% or less. When the haze is from 20% to 50%, the ratio of inner haze to total haze is from 0.3 to 1, the reduction of haze from that up to the light-scattering layer to that developed after the formation of the low refractive layer is 15% or less, the sharpness of transmitted image at an optical comb width of 0.5 mm is from 20% to 50% and the ratio of transmission of vertical transmitted light to transmission of transmitted light in the direction of 2 degrees from the vertical direction is from 1.5 to 5.0, the prevention of glare on a high precision LCD panel and the elimination of blurring of letters, etc. can be attained to advantage.

### (Low Refractive Layer)

The refractive index of the low refractive layer employable herein is preferably from 1.20 to 1.49, more preferably from 1.30 to 1.44. Further, the low refractive layer preferably satisfies the following numerical formula (19) to advantage from the standpoint of reduction of reflectance.

(m/4)×0.7<n1d1<(m/4)×1.3 (19)

wherein m represents a positive odd number; n1 represents the refractive index of the low refractive layer; and d1 represents the thickness (nm) of the low refractive layer. λ is a wavelength ranging from 500 to 550 nm.

The materials constituting the low refractive layer will be described hereinafter.

The low refractive layer preferably comprises a fluorine-containing polymer incorporated therein as a low refractive binder. As such a fluorine-based polymer there is preferably used a thermally or ionized radiation-crosslinkable fluorine-containing polymer having a dynamic friction coefficient of from 0.03 to 0.20, a contact angle of from 90 to 120° with respect to water and a purified water slip angle of 70° or less. As the peel force of the polarizing plate of the invention with respect to a commercially available adhesive tape during the mounting on the image display device decreases, the polarizing plate can be more easily peeled after the sticking of seal or memo to advantage. The peel force of the polarizing plate is preferably 500 gf or less, more preferably 300 gf or less, most preferably 100 gf or less as measured by a tensile testing machine. The higher the surface hardness as measured by a microhardness meter is, the more difficultly can be damaged the low refractive layer. The surface hardness of the low refractive layer is preferably 0.3 GPa or more, more preferably 0.5 GPa or more.

Examples of the fluorine-containing polymer to be used in the low refractive layer include hydrolyzates and dehydration condensates of perfluoroalkyl group-containing silane compounds (e.g., (heptadecafluoro-1,1,2,2-tetrahydrodecyl)triethoxysilane). Other examples of the fluorine-containing polymer include fluorine-containing copolymers comprising a fluorine-containing monomer unit and a constituent unit for providing crosslinking reactivity as constituent components.

Specific examples of the fluorine-containing monomers include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.), and fully or partly fluorinated vinyl ethers, Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinking functional group such as glycidyl (meth)acrylate and glycidyl vinyl ether, constituent units obtained by the polymerization of monomers having carboxyl group, hydroxyl group, amino group, sulfo group or the like (e.g., (meth)acrylic acid, methyl (meth)acrylate, hydroxylalkyl (meth)acrylate, allyl acrylate, hydroxyethyl vinyl ether, hydroxybutyl vinyl ether, maleic acid, crotonic acid), and constituent units obtained by introducing a crosslinking reactive group such as (meth)acryloyl group into these constituent units by a polymer reaction (e.g., by reacting acrylic acid chloride with hydroxyl group).

Besides the aforementioned fluorine-containing monomer units and constituent units for providing crosslinking reactivity, monomers free of fluorine atom may be properly copolymerized from the standpoint of solubility in the solvent, transparency of the film, etc. The monomer units which can be used in combination with the aforementioned monomer units are not specifically limited. Examples of these monomer units include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinyl ether, vinyl toluene, α-methyl styrene), vinylethers (e.g., methyl vinyl ether, ethyl vinyl ether, cyclohexyl vinyl ether), vinylesters (e.g., vinyl acetate, vinyl propionate, vinyl cinnamate), acrylamides (e.g., N-tert-butyl acrylamide, N-cyclohexyl acrylamide), methacrylamides, and acrylonitrile derivatives.

The aforementioned polymers may be used properly in combination with a hardener as disclosed in JP-A-10-25388 and JP-A-10-147739.

### (Light-Scattering Layer)

The light-scattering layer is formed for the purpose of providing the film with light-scattering properties developed by any of surface scattering and inner scattering and hard coating properties for the enhancement of scratch resistance of the film. Accordingly, the light-scattering layer comprises a binder for providing hard coating properties, a particulate mat for providing light diffusibility and optionally an inorganic filler for the enhancement of refractive index, the prevention of crosslink shrinkage and the enhancement of strength incorporated therein. Further, the provision of such a light-scattering layer allows the light-scattering layer to act as an anti-glare layer, causing the polarizing plate to have an anti-glare layer.

The thickness of the light-scattering layer is from 1 to 10 μm, more preferably from 1.2 to 6 μm for the purpose of providing hard coating properties. When the thickness of the light-scattering layer is greater than the lower limit, the problems such as the lack of hard coating properties are hard to arise. On the contrary, when the thickness of the light-scattering layer is smaller that the upper limit, the disadvantages such as the lack of adaptability to working due to the deterioration of curling resistance and brittleness are hard to arise, thus the ranges are preferred.

The binder to be incorporated in the light-scattering layer is preferably a polymer having a saturated hydrocarbon chain or polyether chain as a main chain, more preferably a polymer having a saturated hydrocarbon chain as a main chain. The binder polymer preferably has a crosslinked structure. As the binder polymer having a saturated hydrocarbon chain as a main chain there is preferably used a (co)polymer of monomers having two or more ethylenically unsaturated groups. In order to provide the binder polymer with a higher refractive index, those containing an aromatic ring or at least one atom selected from the group consisting of halogen atoms other than fluorine, sulfur atom, phosphorus atom and nitrogen atom may be selected.

Examples of the monomer having two or more ethylenically unsaturated groups include esters of polyvalent alcohol with (meth)acrylic acid (e.g., ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol penta(meth)acrylate, dipentaerythritol tetra(meth)acrylate, dipentaerythritol penta(meth)acrylate, dipentaerithritol hexa(meth)acrylate, pentaerythritol hexa(meth)acrylate, 1,2,3-cyclohexane tetramethacrylate, polyurethane polyacrylate, polyester polyacrylate), modification products of the aforementioned ethylene oxides, vinylbenzene and derivatives thereof (e.g., 1,4-divinylbenzene, 4-vinyl benzoic acid-2-acryloylethylester, 1,4-divinyl cyclohexanone), vinylsulfones (e.g., divinylsulfone), acrylamides (e.g., methylenebisacrylamide), and methacrylamides. The aforementioned monomers may be used in combination of two or more thereof.

Specific examples of the high refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of the monomers having these ethylenically unsaturated groups can be effected by irradiation with ionized radiation or heating in the presence of a photo-radical polymerization initiator or heat-radical polymerization initiator.

Accordingly, an anti-reflection layer can be formed by a process which comprises preparing a coating solution containing a monomer having an ethylenically unsaturated group, a photo-polymerization initiator or heat radical polymerization initiator, a particulate mat and an inorganic filler, spreading the coating solution over the protective film, and then irradiating the coat with ionized radiation or applying heat to the coat to cause polymerization reaction and curing. As such a photo-polymerization initiator or the like there may be used any compound known as such.

As the polymer having a polyether as a main chain there is preferably used an open-ring polymerization product of polyfunctional epoxy compound. The open-ring polymerization of the polyfunctional epoxy compound can be carried out by the irradiation of the polyfunctional epoxy compound with ionized radiation or applying heat to the polyfunctional epoxy compound in the presence of a photo-acid generator or beat-acid generator.

Accordingly, the anti-reflection layer can be formed by a process which comprises preparing a coating solution containing a polyfunctional epoxy compound, a photo-acid generator or heat-acid generator, a particulate mat and an inorganic filler, spreading the coating solution over the protective film, and then irradiating the coat layer with ionized radiation or applying heat to the coat layer to cause polymerization reaction and curing.

Instead of or in addition to the monomer having two or more ethylenically unsaturated groups, a monomer having a crosslinkable functional group may be used to incorporate a crosslinkable functional group in the polymer so that the crosslinkable functional group is reacted to incorporate a crosslinked structure in the binder polymer.

Examples of the crosslinkable functional group include isocyanate group, epoxy group, aziridin group, oxazoline group, aldehyde group, carbonyl group, hydrazine group, carboxyl group, methylol group, and active methylene group. Vinylsulfonic acids, acid anhydries, cyanoacrylate derivatives, melamines, etherified methylol, esters, urethane, and metal alkoxides such as tetramethoxysilane, too, may be used as monomers for introducing crosslinked structure. Functional groups which exhibit crosslinkability as a result of decomposition reaction such as block isocyanate group may be used. In other words, in the invention, the crosslinkable functional group may not be reactive as they are but may become reactive as a result of decomposition reaction.

These binder polymers having a crosslinkable functional group may be spread and heated to form a crosslinked structure.

The light-scattering layer comprises a particulate mat incorporated therein having an average particle diameter which is greater than that of filler particles and ranges from 1 to 10 μm, preferably from 1.5 to 7.0 μm, such as inorganic particulate compound and particulate resin for the purpose of providing itself with anti-glare properties.

Specific examples of the aforementioned particulate mat include inorganic particulate compounds such as particulate silica and particulate TiO₂, and particulate resins such as particulate acryl, particulate crosslinked acryl, particulate polystyrene, particulate crosslinked styrene, particulate melamine resin and particulate benzoguanamine resin. Preferred among these particulate resins are particulate crosslinked styrene, particulate crosslinked acryl, particulate crosslinked acryl styrene, and particulate silica. The particulate mat may be either spherical or amorphous.

Two or more particulate mats having different particle diameters may be used in combination. A particulate mat having a greater particle diameter may be used to provide the light-scattering layer with anti-glare properties. A particulate mat having a greater particle diameter may be used to provide the light-scattering layer with other optical properties.

Further, the distribution of the particle diameter of the mat particles is most preferably monodisperse. The particle diameter of the various particles are preferably as close to each other as possible. For example, in the case where a particle having a diameter of 20% or more greater than the average particle diameter is defined as coarse particle, the proportion of these coarse particles is preferably 1% or less, more preferably 0.1% or less, even more preferably 0.01% or less of the total number of particles. A particulate mat having a particle diameter distribution falling within the above defined range can be obtained by properly classifying the mat particles obtained by an ordinary synthesis method. By raising the number of classifying steps or intensifying the degree of classification, a matting agent having a better distribution can be obtained.

The aforementioned particulate mat is incorporated in the light-scattering layer in such a manner that the proportion of the particulate mat in the light-scattering layer is from 10 to 1,000 mg/m², more preferably from 100 to 700 mg/m².

For the measurement of the distribution of particle size of mat particles, a coulter counter method. The particle size distribution thus measured is then converted to distribution of number of particles.

The light-scattering layer preferably comprises an inorganic filler made of an oxide of at least one metal selected from the group consisting of titanium, zirconium, aluminum, indium, zinc, tin and antimony having an average particle diameter of 0.2 μm or less, preferably 0.1 μm or less, more preferably 0.06 μm or less incorporated therein in addition to the aforementioned particulate mat to enhance the refractive index thereof. In order to enhance the difference of refractive index from the particulate mat, the light-scattering layer comprising a high refractive particulate mat incorporated therein preferably comprises a silicon oxide incorporated therein for keeping the refractive index thereof somewhat low. The preferred particle diameter of the particulate silicon oxide is the same as that of the aforementioned inorganic filler.

Specific examples of the inorganic filler to be incorporated in the light-scattering layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of enhancement of refractive index. The inorganic filler is preferably subjected to silane coupling treatment or titanium coupling treatment on the surface thereof. To this end, a surface treatment having a functional group reactive with the binder seed on the surface thereof is preferably used.

The amount of the inorganic filler to be incorporated is preferably from 10 to 90%, more preferably from 20 to 80%, particularly from 30 to 75% based on the total mass of the light-scattering layer.

Such a filler has a particle diameter which is sufficiently smaller than the wavelength of light and thus causes no scattering. Thus, a dispersion having such a filler dispersed in a binder polymer behaves as an optically uniform material.

The bulk refractive index of the mixture of binder and inorganic filler in the light-scattering layer is preferably from 1.50 to 2.00, more preferably from 1.51 to 1.80. In order to predetermine the bulk refractive index of the mixture within the above defined range, the kind and proportion of the binder and the inorganic filler may be properly selected. How to select these factors can be previously easily known experimentally.

In order to keep the light-scattering layer uniform in surface conditions such as uniformity in coating and drying and prevention of point defects, the coating solution for forming the light-scattering layer comprises either or both of fluorine-based surface active agent and silicone-based surface active agent incorporated therein. In particular, a fluorine-based surface active agent is preferably used because it can be used in a smaller amount to exert an effect of eliminating surface defects such as unevenness in-coating and drying and point defects of the anti-reflection film which is preferably used in the invention. Such a fluorine-based surface active agent is intended to render the coating solution adaptable to high speed coating while enhancing the uniformity in surface conditions, thereby raising the productivity.

### [AR Film]

The anti-reflection layer (AR film) comprising a middle refractive layer, a high refractive layer and a low refractive layer laminated on a protective film in this order will be described hereinafter.

The anti-reflection layer comprising a layer structure having at least a middle refractive layer, a high refractive layer and a low refractive layer (outermost layer) laminated on a protective film in this order is designed so as to have a refractive index satisfying the following relationship.

Refractive index of high refractive layer>refractive index of middle refractive layer>refractive index of protective film>refractive index of low refractive layer

Further, a hard coat layer may be provided interposed between the protective film and the middle refractive layer. Moreover, the anti-reflection layer may comprise a middle refractive layer, a hard coat layer, a high refractive layer and a low refractive layer laminated on each other.

For example, an anti-reflection layer as disclosed in JP-A-8-122504, JP-A-8-110401, JP-A-10-300902, JP-A-2002-243906, and JP-A-2000-111706 may be used.

Further, the various layers may be provided with other functions. Examples of these layers include stain-proof low refractive layer, and antistatic high refractive layer (as disclosed in JP-A-10-206603, JP-A-2002-243906).

The haze of the anti-reflection layer is preferably 5% or less, more preferably 3% or less. The strength of the anti-reflection layer is preferably not lower than H, more preferably not lower than 2H, most preferably not lower than 3H as determined by pencil hardness test method according to JIS K5400.

### (High Refractive Layer and Middle Refractive Layer)

The layer having a high refractive index in the anti-reflection layer is formed by a hardened layer containing at least a high refractive inorganic particulate compound having an average particle diameter of 100 nm or less and a matrix binder.

As the high refractive inorganic particulate compound there may be used an inorganic compound having a refractive index of 1.65 or more, preferably 1.9 or more. Examples of such a high refractive inorganic particulate compound include oxides of Ti, Zn, Sb, Sn, Zr, Ce, Ta, La and In, and composite oxides of these metal atoms.

In order to provide such a particulate material, the following requirements need to be satisfied. For example, the surface of the particles must be treated with a surface treatment (e.g., silane coupling agent as disclosed in JP-A-11-295503, JP-A-11-153703, and JP-A-2000-9908, anionic compound or organic metal coupling agent as disclosed in JP-A-2001-310432). Further, the particles must have a core-shell structure comprising a high refractive particle as a core (as disclosed in JP-A-2001-166104). A specific dispersant must be used at the same time (as disclosed in JP-A-11-153703, U.S. Pat. No. 6,210,858B1, JP-A-2002-2776069).

Examples of the matrix-forming materials include known thermoplastic resins, thermosetting resins, etc.

Preferred examples of the matrix-forming materials include polyfunctional compound-containing compositions having two or more of at least any of radically polymerizable group and cationically polymerizable group, compositions having an organic metal compound containing a hydrolyzable group, and at least one selected from the group consisting of compositions containing a partial condensate thereof.

Examples of these materials include compounds as disclosed in JP-A-2000-47004, JP-A-2001-315242, JP-A-2001-31871, and JP-A-2001-296401.

Further, a colloidal metal oxide obtained from a hydrolytic condensate of metal alkoxide and a curable layer obtained from a metal alkoxide composition are preferably used. For the details of these materials, reference can be made to JP-A-2001-293818.

The refractive index of the high refractive layer is preferably from 1.70 to 2.20. The thickness of the high refractive layer is preferably from 5 nm to 10 μm, more preferably from 10 nm to 10 μm.

The refractive index of the middle refractive layer is adjusted so as to fall between the refractive index of the low refractive layer and the high refractive layer. The refractive index of the middle refractive layer is preferably from 1.50 to 1.70. The thickness of the middle refractive layer is preferably from 5 nm to 10 μm, more preferably from 10 nm to 1 μm.

### (Low Refractive Layer)

The low refractive layer is laminated on the high refractive layer. The refractive index of the low refractive layer is preferably from 1.20 to 1.55, more preferably from 1.30 to 1.50.

The low refractive layer is preferably designed as an outermost layer having scratch resistance and stain resistance. In order to drastically raise the scratch resistance of the low refractive layer, a thin layer which can effectively provide surface slipperiness may be formed on the low refractive layer by introducing a known silicone or fluorine thereinto.

As the fluorine-containing compound there is preferably used a compound containing a crosslinkable or polymerizable functional group having fluorine atoms in an amount of from 35 to 80% by mass.

Examples of such a compound include those disclosed in JP-A-9-222503, paragraphs [0018]-[0026], JP-A-11-38202, paragraphs [0019]-[0030], JP-A-2001-40284, paragraphs [0027]-[0028], and JP-A-284102.

The refractive index of the fluorine-containing compound is preferably from 1.35 to 1.50, more preferably from 1.36 to 1.47.

As the silicone compound there is preferably used a compound having a polysiloxane structure wherein a curable functional group or polymerizable functional group is incorporated in the polymer chain to form a bridged structure in the film. Examples of such a compound include reactive silicones (e.g., SILAPLANE, produced by CHISSO CORPORATION), and polysiloxanes having silanol group at both ends thereof (as disclosed in JP-A-11-258403).

In order to effect the crosslinking or polymerization reaction of at least any of fluorine-containing polymer and siloxane polymer having crosslikable or polymerizable group, the coating composition for forming the outermost layer containing a polymerization initiator, a sensitizer, etc. is preferably irradiated with light or heated at the same time with or after spreading to form a low refractive layer.

Further, a sol-gel cured film obtained by curing an organic metal compound such as silane coupling agent and a silane coupling agent containing a specific fluorine-containing hydrocarbon group in the presence of a catalyst is preferably used.

Examples of such a sol-gel cured film include polyfluoroalkyl group-containing silane compounds and partial hydrolytic condensates thereof (compounds as disclosed in JP-A-58-142958, JP-A-58-14783, JP-A-58-147484, JP-A-9-157582, and JP-A-11-106704), and silyl compounds having poly(perfluoroalkylether) group as a fluorine-containing long chain (compounds as disclosed in JP-A-2000-117902, JP-A-2001-48590, JP-A-2002-53804).

The low refractive layer may comprise a filler (e.g., low refractive inorganic compound having a primary average particle diameter of from 1 to 150 nm such as particulate silicon dioxide (silica) and particulate fluorine-containing material (magnesium fluoride, calcium fluoride, barium fluoride), organic particulate material as disclosed in JP-A-11-3820, paragraphs [0020]-[0038]), a silane coupling agent, a lubricant, a surface active agent, etc. incorporated therein as additives other than the aforementioned additives.

In the case where the low refractive layer is disposed under the outermost layer, the low refractive layer may be formed by a gas phase method (vacuum metallizing method, sputtering method, ion plating method, plasma CVD method, etc.). A coating method is desirable because the low refractive layer can be produced at reduced cost.

The thickness of the low refractive layer is preferably from 30 to 200 nm, more preferably from 50 to 150 nm, most preferably from 60 to 120 nm.

### (Hard Coat Layer)

The hard coat layer is provided on the surface of the protective film to give a physical strength to the protective film having an anti-reflection layer provided thereon. In particular, the hard coat layer is preferably provided interposed between the transparent support and the aforementioned high refractive layer. The hard coat layer is preferably formed by the crosslinking reaction or polymerization reaction of a photosetting and/or thermosetting compound. The curable functional group in the curable compound is preferably a photopolymerizable functional group. Further, an organic metal compound or organic alkoxysilyl compound containing a hydrolyzable functional group is desirable.

Specific examples of these compounds include the same compounds as exemplified with reference to the high refractive layer. Specific examples of the composition constituting the hard coat layer include those described in JP-A-2002-144913, JP-A-2000-9908, and WO00/46617.

The high refractive layer may act also as a hard coat layer. In this case, particles may be finely dispersed in a hard coat layer in the same manner as described with reference to the high refractive layer to form a high refractive layer.

The hard coat layer may comprise particles having an average particle diameter of from 0.2 to 10 μm incorporated therein to act also as an anti-glare layer provided with anti-glare properties.

The thickness of the hard coat layer may be properly designed depending on the purpose. The thickness of the hard coat layer is preferably from 0.2 to 10 μm, more preferably from 0.5 to 7 μm.

The strength of the hard coat layer is preferably not lower than H, more preferably not lower than 2H, most preferably not lower than 3H as determined by pencil hardness test according to JIS K5400. The abrasion of the test specimen is preferably as little as possible when subjected to taper test according to JIS K5400.

(Layers Other than Anti-Reflection Layer)

Further, a forward scattering layer, a primer layer, an antistatic layer, an undercoating layer, a protective layer, etc. may be provided.

### (Antistatic Layer)

The antistatic layer, if provided, is preferably given an electrical conductivity of 10⁻⁸ (Ωcm⁻³) or less as calculated in terms of volume resistivity. The use of a hygroscopic material, a water-soluble inorganic salt, a certain kind of a surface active agent, a cation polymer, an anion polymer, colloidal silica, etc. makes it possible to provide a volume resistivity of 10⁻⁸ (Ωcm⁻³). However, these materials have a great dependence on temperature and humidity and thus cannot provide a sufficient electrical conductivity at low humidity. Therefore, as the electrically conductive layer material there is preferably used a metal oxide. Some metal oxides have a color. The use of such a colored metal oxide as an electrically conductive layer material causes the entire film to be colored to disadvantage. Examples of metal that forms a colorless metal oxide include Zn, Ti, Al, In, Si, Mg, Ba, W, and V. Metal oxides mainly composed of these metals are preferably used. Specific examples of these metal oxides include ZnO, TiO₂, SnO₂, Al₂O₃, In₂O₃, SiO₂, MgO, BaO, MoO₃, V₂O₅, and composites thereof. Particularly preferred among these metal oxides are ZnO, TiO₂, and SnO₂. Referring to the incorporation of different kinds of atoms, Al, In, etc. are effectively added to ZnO. Sb, Nb, halogen atoms, etc. are effectively added to SnO₂. Nb, Ta, etc. are effectively added to TiO₂. Further, as disclosed in JP-B-59-6235, materials comprising the aforementioned metal oxide attached to other crystalline metal particles or fibrous materials (e.g., titanium oxide) may be used. Volume resistivity and surface resistivity are different physical values and thus cannot be simply compared with each other. However, in order to provide an electrical conductivity of 10⁻⁸ (Ωcm⁻¹) or less as calculated in terms of volume resistivity, it suffices if the electrically conductive layer has an electrical conductivity of 10⁻¹⁰ (Ω/□) or less, preferably 10⁻⁸ (Ω/□) or less as calculated in terms of surface resistivity. It is necessary that the surface resistivity of the electrically conductive layer be measured when the antistatic layer is provided as an outermost layer. The measurement of surface resistivity can be effected at a step in the course of the formation of laminated film.

### (Liquid Crystal Display Device)

The liquid crystal display device of the invention has at least a polarizing plate of the invention. The liquid crystal display device of the invention preferably comprises a pair of polarizing plates provided on the respective side of the liquid crystal cell. It is particularly preferred that a pair of the polarizing plates of the invention be provided on the respective side of a VA mode liquid crystal cell. It is also preferred that at least one of the protective films be the aforementioned protective film, i.e., the aforementioned cellulose acylate film or cycloolefin-based polymer film. It is also preferred that the protective film disposed on the liquid crystal cell side of the polarizing plate of the liquid crystal display device be a protective film satisfying the numerical formulae (6) and (7). Another preferred embodiment comprises an optically anisotropic layer and/or an anti-reflection layer provided on the protective film. In this arrangement, a liquid crystal display device having a light mass and a small thickness can be obtained.

Examples of the liquid crystal cell which can form a liquid crystal display device with the polarizing plate of the invention will be given below.

The polarizing plate of the invention can be used in liquid crystal cells of various display modes such as TN (Twisted Nematic), IPS (In-Plane Switching), FLC (Ferroelectricl Liquid Crystal), AFLC (Anti-ferroelectric Liquid Crystal), OCB (Optically Compensatory Bend), STN (Super Twisted Nematic), VA (Vertically Aligned) and HAN (Hybrid Aligned Nematic), preferably VA mode or OCB, particularly VA mode.

In a VA mode liquid crystal cell, rod-shaped liquid crystal molecules are vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society, pages 58 to 59, 1988 and Sharp Technical Journal No. 80, page 11 and (4) liquid crystal cell of SURVALVAL mode which is multidomained by an oblique electric field (as reported in “Monthly Display”, May, 1999, page 14) and liquid crystal cell of PVA mode (as reported in “18th, IDRC Proceedings”, p. 383, 1998).

An example of VA mode liquid crystal display device is one comprising a liquid crystal cell (VA mode cell) and two sheets of polarizing plates {polarizing plate having TAC1 (22), TAC2 (23, 33), TAC3 (32), polarizer (21, 31) and adhesive layer (not shown)} provided on the respective side thereof as shown in FIG. 3. Thought not specifically shown, the liquid crystal cell comprises a liquid crystal supported interposed between two sheets of electrode substrates.

In the embodiment of the transmission type liquid crystal display device shown in FIG. 3, the protective films TAC 1 and TAC3 provided on the liquid crystal cell side among the cellulose acylate films used as protective film may be the same or different. Further, TAC 1 and TAC3 may be used as protective film as well as optical compensation sheet.

The protective film (TAC2) of FIG. 3 may be an ordinary cellulose acylate film and preferably is thinner than the cellulose acylate film which is preferably used in the invention. The thickness of TAC2 is preferably from 40 μm to 80 μm for example. Examples of TAC2 employable herein include commercially available products such as “KC4UX2M” (produced by Unicaopto Co., Ltd.; 40 μm), “KC5UX” produced by Unicaopto Co., Ltd.; 60 μm), and “TD80LL” (produced by Fuji Photo Film Co., Ltd.; 80 μm).

The source of the backlight to be used in the liquid crystal display device of the invention is not specifically limited in its type so far as the surface temperature is 40° C. or less. The backlight source preferably has a high emission intensity with respect to power supplied. However, the type of the light source is not specifically limited. Examples of the backlight source employable herein include light-emitting diode (References 1, 2, 3), two-dimensional laminated fluorescent lamp (Reference 4), and light sources disclosed in References 5 to 8. Even when the light source generates heat, the light source is preferably arranged such that the heat thus generated cannot be transferred to the liquid crystal panel.
Reference 1: W. Folkerts, SID 04 DIGEST, p. 1,226 (2004)
Reference 2: S. Sakai et al, SID 04 DIGEST, p. 1,218 (2004)
Reference 3: M. J. Zwanenburg et al, SID 04 DIGEST, p. 1,222 (2004)
Reference 4: J. H. Kim, IMID. '04 DIGEST, p. 795 (2004)
Reference 5: T. Shiga et al, J. or SID, p. 151 (1999)
Reference 6: M. Anandan, “LCD backlighting”, Seminar Lecture Notes (Seminar F-2) of SID' 01
Reference 7: M. Anandan et al, Proc. of SID, p. 137, Vol. 32 (1991)
Reference 8: L. Hitsche, SID' 04 DIGEST, p. 1,322 (2004)

A surface tension can be regarded as a dispersion force component and a polarity component separately, due to its origine of the generation. A surface tension γ, a dispersion force component γ^{d} and a polarity component γ^{p} are represented by the following relation formula.

γ=γ^{d}+γ^{p}

A dispersion force component is an attracting force, which is attributed to non-polar parts of molecules, between a plurality of molecules spreading over a long distance range, and a polarity component is an attracting force, which is attributed to polar parts of molecules, spreading over a relatively short distance range. Many of organic substances are, as a whole, electronically neutral, however in microscopically, there is a substance that has a polar part (permanent dipole) generating a polarization of charge in the molecule due to the difference of electronegativities of atoms. Permanent dipoles have an interaction (Keesom interaction) in each other, and this interaction causes the aforementioned polarity component. Further, if permanent dipoles exist in a group of non-polar molecules, the permanent dipoles induce non-polar molecules to generate induced dipoles. Permanent dipole-induced dipole interaction (Debye interaction) works therebetween. Therefore, a polarity component is large in a molecule having a group of a strong polarity such as corbonyl group or hydroxyl group, and for example, polyimide, polyamide or epoxy resin show large values. Moreover, even non-polar molecule generates a momentary dipole by the transfer of electrons in the molecule, thereby polarizing other molecules and causing a dispersion force interaction (London interaction). In view of the above, a dispersion force is larger in a molecule including more covalent bondings abound in electron transfer ability, and for example, polyacetylene or polybutadiene show large values. Both of a dispersion force component and plarity component are small in a molecule including a fluorine atom, and for example, acrylic resin or methacrylic resin in which hydrogen atoms thereof are substituted with fluorine atoms are exemplified. To bond a support like polymer film with a substance having fluidity like an adhesive by contacting each other, it is preferable that the surface tension of the adhesive is smaller than the surface tension of the support.

Moreover, it is preferable that each of a surface tension of γ_{A} and a polarity component of γ_{A}^{P} of the adhesive, and each of a surface tension of γ_{F} and a polarity component of γ_{F}^{P} of the protective film satisfy numerical formulae (20) to (23),

30≦γ_{A}≦45 (20)

5≦γ_{A}^{P}≦15 (21)

50≦γ_{F}≦75 (22)

20≦γ_{F}^{P}≦45 (23)

[wherein each of γ_{A}, γ_{A}^{P}, γ_{F} and γ_{F}^{P} has a unit of mN/m.]

By employing the support and adhesive having the surface tensions satisfying the above numerical formulae (20) to (23), the peeling under a high temperature or a high temperature and high humidity between the support and the adhesive can be prevented.

The estimations of the dispersion force component and polarity component of the surface tension can be done by measuring the contacting angles of a plurality of liquids, which dispersion force component and polarity component are known, on the measuring object solid. As one of the exmples, Owens method (D. K. Owens and R. C. Wendt: J. Appl. Polym. Sci, 13, 1941 (1969)) in which the components are obtained by solving the following two simultaneous equations by using the contact angles of water (H₂O) and methylene chloride (CH₂Cl₂) is proposed.

1+cos θ_{H2O}=2×(γₛ^{d})^{0.5}×(γ_{H2O}^{d})/γ_{H2O}+2×(γₛ^{p})^{0.5}×(γ_{H2O}^{p})^{0.5}/γ_{H2O}

1+cos θ_{CH2Cl2}=2×(γₛ^{s})^{0.5}×(γ_{CH2Cl2}^{d})^{0.5}/γ_{CH2CL2}+2×(γₛ^{p})^{0.5}×(γ_{CH2Cl2}^{p})^{0.5}/γ_{CH2Cl2}

wherein θ_{H2O} and θ_{CH2Cl2} represent contact angles of water and methylene chloride on the solid “S”, respectively, γₛ^{d}, γ_{H2O}^{d} and γ_{CH2Cl2}^{d} represent dispersion force components of solid “S”, water and methylene chloride, respectively, and γₛ^{p}, γ_{H2O}^{p} and γ_{CH2Cl2}^{p} represent polarity components of solid “S”, water and methylene chloride, respectively. γ_{H2O}^{d}, γ_{CH2Cl2}^{d}, γ_{H2O}^{p} and γ_{CH2Cl2}^{p} are known values, and 21.8 in N/m, 49.5 mN/m, 51.0 mN/m and 1.3 mN/m, respectively.

### EXAMPLE

The invention will be further described in the following examples, production examples and synthesis examples, but the invention is not limited thereto.

### Production Example 1

### Production of Cellulose Acylate Film using Band Casting Machine (Films 1 to 17)

### (1) Cellulose Acylate

Cellulose acylates having different kinds of acyl groups and substitution degrees as set forth in Table 1 were prepared. In some detail, sulfuric acid was added as a catalyst (in an amount of 7.8 parts by mass based on 100 parts by mass of cellulose). In the presence of this catalyst, a carboxylic acid as a raw material of acyl substituent was then subjected to acylation reaction at 40° C. During this procedure, the amount of the sulfuric acid catalyst, the water content and the ripening time were adjusted to adjust the kind of acyl group, total substitution degree and 6-position substitution degree. The carboxylic acid thus acylated was then ripened at 40° C. The low molecular components of cellulose acylate were then removed by washing with acetone.

In Table 1, CAB stands for cellulose acylate butyrate (cellulose acetate derivative comprising acyl group composed of acetate and butyryl groups), CAP stands for cellulose acetate propionate (cellulose ester derivative comprising acyl group composed of acetate and propionyl groups), and CTA stands for cellulose triacetate (cellulose ester derivative comprising acyl group composed of acetate group alone).

TABLE 1

| | | | | | | | Degree of |
|---|---|---|---|---|---|---|---|
| | | | | | Total | | substitution in |
| | Kind of | | Substitution | | substitution | Degree of | 6-position/ |
| Film | cellulose | Substitution | degree B | | degree | substitution in | total degree of |
| No. | acylate | degree A | Kind | | A + B | 6-position | substitution |
| 1 | CAP | 1.9 | Pr | 0.8 | 2.7 | 0.897 | 0.332 |
| 2 | CAP | 0.18 | Pr | 2.47 | 2.65 | 0.883 | 0.333 |
| 3 | CAB | 1.4 | Bu | 1.3 | 2.7 | 0.880 | 0.326 |
| 4 | CAB | 0.3 | Bu | 2.5 | 2.8 | 0.890 | 0.318 |
| 5 | CTA | 2.785 | — | 0 | 2.785 | 0.910 | 0.327 |
| 6 | CTA | 2.849 | — | 0 | 2.849 | 0.934 | 0.328 |
| 7 | CTA | 2.87 | — | 0 | 2.87 | 0.907 | 0.316 |
| 8 | CAP | 1.9 | Pr | 0.8 | 2.7 | 0.897 | 0.332 |
| 9 | CAP | 0.18 | Pr | 2.47 | 2.65 | 0.883 | 0.333 |
| 10 | CAB | 1.1 | Bu | 1.6 | 2.7 | 0.881 | 0.326 |
| 11 | CAB | 0.3 | Bu | 2.5 | 2.8 | 0.890 | 0.318 |
| 12 | CTA | 2.785 | — | 0 | 2.785 | 0.910 | 0.327 |
| 13 | CTA | 2.847 | — | 0 | 2.847 | 0.947 | 0.333 |
| 14 | CTA | 2.87 | — | 0 | 2.87 | 0.907 | 0.316 |
| 15 | CTA | 2.87 | — | 0 | 2.87 | 0.907 | 0.316 |
| 16 | CTA | 2.785 | — | 0 | 2.785 | 0.910 | 0.327 |
| 17 | CTA | 2.92 | — | 0 | 2.92 | 0.923 | 0.316 |

### (2) Preparation of Dope

### [1-1. Cellulose Acrylate Solution]

The following components were put in a mixing tank where they were then stirred to make a solution which was heated to 90° C. for about 10 minutes and then filtered through a filter paper having an average pore diameter of 34 μm and a sintered metal filter having an average pore diameter of 10 μm.

(Formulation of cellulose acylate solution (unit: parts by mass))

| | |
|---|---|
| Cellulose acylate set forth in Table 1 | 100.0 |
| Triphenyl phosphate | 8.0 |
| Biphenyl diphenyl phosphate | 4.0 |
| Methylene chloride | 403.0 |
| Methanol | 60.0 |

### [1-2. Matting Agent Dispersion]

The following formulation containing the cellulose acylate solution thus prepared was put in a dispersing machine to prepare a matting agent dispersion.

(Formulation of matting agent dispersion (unit: parts by mass))

| | |
|---|---|
| Particulate silica (average particle diameter: 16 nm) | 2.0 |
| (“Aerosil R972”, produced by Nippon Aerosil Co., Ltd.) | |
| Methylene chloride | 72.4 |
| Methanol | 10.8 |
| Cellulose acylate solution prepared above | 10.3 |

### [1-3. Retardation Developer Solution A]

Subsequently, the following composition containing the cellulose acylate solution prepared above was put in a mixing tank where it was then heated with stirring to make a solution as retardation developer solution A. In the following composition, the retardation developer (RP1) is a compound shown below in [ka-19].

(Formulation of retardation developer solution A (unit: parts by mass))

| | |
|---|---|
| Retardation developer (RP1) | 20.0 |
| Methylene chloride | 58.3 |
| Methanol | 8.7 |
| Cellulose acylate solution prepared above | 12.8 |

100 parts by mass of the aforementioned cellulose acylate solution, 1.35 parts by mass of the matting agent dispersion, and the retardation developer solution A in an amount set forth in Table 2 were mixed to prepare a film-making dope. The dope thus prepared was then used to prepare films 1 to 15. The amount of the retardation developer solution A is set forth in Table 2 as calculated in terms of the parts by mass of retardation developer based on 100 parts by mass of cellulose acylate.

### [1-4. Retardation Developer Solution B]

Further, the following composition containing the cellulose acylate solution prepared above was put in a mixing tank where it was then heated with stirring to make a solution as retardation developer solution B. In the following composition, the retardation developer (RP1) is a compound shown below and the retardation developer (30) is a compound represented by the aforementioned general formula (30).

(Formulation of retardation developer solution B (unit: parts by mass))

| | |
|---|---|
| Retardation developer (RP1) | 7.8 |
| Retardation developer (30) | 12.2 |
| Methylene chloride | 58.3 |
| Methanol | 8.7 |
| Cellulose acylate solution prepared above | 12.8 |

100 parts by mass of the aforementioned cellulose acylate solution, 1.35 parts by mass of the matting agent dispersion, and the retardation developer solution B in an amount set forth in Table 2 were mixed to prepare a film-making dope. The dope thus prepared was then used to prepare films 16. The amount of the retardation developer solution B is set forth in Table 2 as calculated in terms of the parts by mass of retardation developer based on 100 parts by mass of cellulose acylate.

### [1-5. Retardation Decreaser Solution]

Further, the following compositions containing the cellulose acylate solution prepared above were put in a mixing tank where they were then heated with stirring to prepare a retardation decreaser solution and a wavelength dispersion adjustor solution. In the following composition, the retardation decreaser (199) is a compound shown in above [ka-10] (119). In the following formulations, HOBP as in the wavelength dispersion adjustor HOBP stands for 2-hydroxy-4-n-octoxybenzophenone.

(Formulation of retardation decreaser solution (unit: parts by mass))

| | |
|---|---|
| Retardation decreaser (119) | 20.0 |
| Methylene chloride | 58.3 |
| Methanol | 8.7 |
| cellulose acylate solution prepared above | 12.8 |

(Formulation of wavelength dispersion adjustor solution (unit: parts
by mass))

| | |
|---|---|
| Wavelength dispersion adjustor HOBP | 20.0 |
| Methylene chloride | 58.3 |
| Methanol | 8.7 |
| cellulose acylate solution prepared above | 12.8 |

100 parts by mass of the aforementioned cellulose acylate solution, 1.35 parts by mass of the matting agent dispersion, and the retardation decreaser solution and the wavelength dispersion adjustor solution in an amount set forth in Table 2 were mixed to prepare a film-making dope. The dope thus prepared was then used to prepare film 17.

The amount of the retardation developer solution A is set forth in Table 2 as calculated in terms of the parts by mass of retardation developer based on 100 parts by mass of cellulose acylate.

In Table 2, the ultraviolet absorbent UV1 represents 2-[2′-hydroxy-3′,5′-di-t-butylphenyl]benzotriazole] and the ultraviolet absorbent UV2 represents 2-[2′-hydroxy-3′,5′-di-t-amylphenyl]-5-chlorobenzotriazole].

Retardation Developer (RP1)

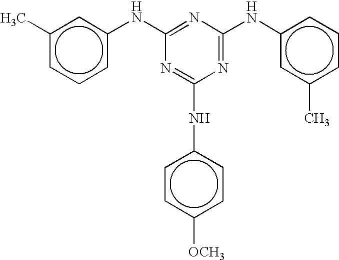

### (2) Casting

The aforementioned dopes were each then casted using a band casting machine. The films thus formed were each then peeled off the band when the amount of residual solvent was from 25% to 35% by mass. Using a tenter, the films thus peeled were each then crosswise stretched by a factor of from 0% to 30% (see Table 2) at a stretching temperature of from the value about 5° C. lower than the glass transition temperature of the cellulose acylate film to the value about 5° C. higher than the glass transition temperature of the cellulose acylate film (hereinafter occasionally referred to as “about (Tg −5° C.) to (Tg +5° C.)) to prepare a cellulose acylate film. The cellulose acylate film thus prepared was trimmed at the both edges thereof before the winding zone to form a wedge having a width of 2,000 mm which was then wound as a rolled film to a length of 4,000 m. The factor of stretching by the tenter is set forth in Table 2. Using a Type KOBRA 21ADH birefringence measuring device (produced by Ouji Scientific Instruments Co. Ltd.), the cellulose acylate film thus prepared was then measured for Re₅₉₀ and Rth₅₉₀ at a wavelength of 590 nm, 25° C. and 60% RH. For the calculation of Rth₅₉₀, 1.48 was inputted as average refractive index. Further, the elastic modulus and the hygroscopic expansion coefficient were determined according the aforementioned process. The results are set forth in Table 2. Further, the film 17 was measured for Re₄₀₀ and Rth₄₀₀ at a wavelength of 400 nm and Re₇₀₀ and Rth₇₀₀ at a wavelength of 700 nm. For the calculation of Rth₄₀₀ and Rth₇₀₀, 1.48 was inputted as average refractive index. As a result, Re₄₀₀, Re₇₀₀, Rth₄₀₀, and Rth₇₀₀ were determined to be −1 nm, 3 nm, −3 nm and 6 nm, respectively.

All the films obtained in the present production example exhibited a haze of from 0.1 to 0.9, a matting agent secondary average particle diameter of 1.0 μm or less and a mass change of from 0 to 3% after being allowed to stand at 80° C. and 90% RH for 48 hours. The dimensional change developed when the films are each allowed to stand at 60° C. and 95% RH and 90° C. and 5% RH for 24 hours was from 0 to 4.5%. All the samples exhibited a photoelastic coefficient of 50×10⁻¹³ cm²/dyne or less.

TABLE 2

| | | | | | | | Film properties | | | |
|---|---|---|---|---|---|---|---|---|---|---|
| | | Formulation | | | Processing | | | | | Hygroscopic |
| Production | | Kind of | | | % Factor | | | | Elastic | expansion |
| Example | Film | cellulose | Additives | | of | Thickness | Re | Rth | modulus | coefficient |
| No. | No. | acylate | Kind | Amount | stretching | (μm) | (nm) | (nm) | (Mpa) | (ppm/% RH) |
| 1-1 | 1 | CAP | UV1/UV2*¹ | 0.7/0.3 | 31 | 80 | 45 | 125 | 2,352 | 61 |
| 1-2 | 2 | CAP | PR1*² | 3 | 15 | 93 | 39 | 138 | 1,700 | 31 |
| 1-3 | 3 | CAB | UV1/UV2*¹ | 0.7/0.3 | 20 | 93 | 24 | 140 | 2,100 | 55 |
| 1-4 | 4 | CAB | UV1/UV2*¹ | 0.7/0.3 | 20 | 92 | 28 | 138 | 1,500 | 28 |
| 1-5 | 5 | CTA | PR1*² | 5 | 23 | 60 | 48 | 132 | 2,900 | 56 |
| 1-6 | 6 | CTA | PR1*² | 4 | 23 | 92 | 51 | 130 | 3,000 | 63 |
| 1-7 | 7 | CTA | PR1*² | 2.7 | 25 | 92 | 33 | 136 | 2,136 | 28 |
| 1-8 | 8 | CAP | UV1/UV2*¹ | 0.7/0.3 | 31 | 134 | 76 | 210 | 2,353 | 61 |
| 1-9 | 9 | CAP | PR1*² | 5 | 30 | 91 | 61 | 263 | 1,700 | 31 |
| 1-10 | 10 | CAB | PR1*² | 3 | 20 | 92 | 58 | 233 | 2,000 | 55 |
| 1-11 | 11 | CAB | PR1*² | 3 | 20 | 93 | 56 | 229 | 1,500 | 28 |
| 1-12 | 12 | CTA | PR1*² | 5 | 19 | 92 | 74 | 220 | 2,900 | 56 |
| 1-13 | 13 | CTA | PR1*² | 5 | 19 | 92 | 57 | 211 | 3,000 | 63 |
| 1-14 | 14 | CTA | PR1*² | 6.5 | 20 | 97 | 47 | 210 | 3,038 | 51 |
| 1-15 | 15 | CTA | PR1*² | 5 | 20 | 92 | 37 | 176 | 3,030 | 53 |
| 1-16 | 16 | CTA | PR1/(30)*² | 2.8/4.4 | 22 | 90 | 60 | 200 | 2,930 | 60 |
| 1-17 | 17 | CTA | (36)*³/HOBP*⁴ | 12/1.5 | 3 | 80 | 2 | 1 | 2,901 | 50 |

UV1/UV2*¹: ultraviolet absorbent;
RP1, (30)*²: retardation developer;
(36)*³: retardation decreaser;
HOB*⁴: wavelength dispersion adjustor

### Production Example 2

### Production of Cellulose Acylate Film using Drum Casting Machine (Film 18)

### (1) Dissolution

The following components were put in a mixing tank where they were then heated to 30° C. with stirring to make a solution as a cellulose acetate solution.

(Formulation of cellulose acetate solution (unit: parts by mass))

| | Inner layer | Outer layer |
|---|---|---|
| Cellulose acetate | 100 | 100 |
| (acylation degree: 60.9%) | | |
| Triphenyl phosphate | 7.8 | 7.8 |
| (plasticizer) | | |
| Biphenyl diphenyl phosphate | 3.9 | 3.9 |
| (plasticizer) | | |
| Methylene chloride (first solvent) | 293 | 314 |
| Methanol (second solvent) | 71 | 76 |
| 1-Butanol (third solvent) | 1.5 | 1.6 |
| Particulate silica | 0 | 0.8 |
| Type AEROSIL R972 retardation developer | 1.4 | 0 |
| (produced by Nippon Aerosil Co., Ltd.) | | |

The degree of substitution of the aforementioned cellulose acetate was as follows.

Substitution degree A: 2.87; Substitution degree B: 0; Total substitution degrees A+B: 2.87; 6-position substitution degree: 0.907; 6-position substitution degree/total substitution degree: 0.316

Retardation developer (RP2)

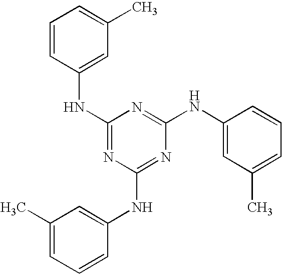

The inner layer-forming dope and the outer layer-forming dope thus obtained were each casted through a three-layer cocasting die over a drum which had been cooled to 0° C. When the residual amount of solvent was 70% by mass, the film was then peeled off the drum. The film was then fixed to a pin tenter at both ends thereof. Using this pin tenter, the film was dried at 80° C. and a conveying direction draw ratio of 110% (factor of stretching: 10%). When the residual amount of solvent reached 10% by mass, the film was then dried at 110° C. Thereafter, the film was dried at 140° C. for 30 minutes. The film was then trimmed at the both edges thereof before the winding zone to form a wedge having a width of 2,000 mm which was then wound as a rolled film to a length of 4,000 m. Thus, a film 18 having a residual solvent content of 0.3% by mass (outer layer: 3 μm; inner layer: 74 μm; outer layer: 3 μm) was prepared. Using a Type KOBRA 21ADH birefringence measuring device (produced by Ouji Scientific Instruments Co. Ltd.), the cellulose acylate film thus prepared was then measured for Re₅₉₀ and Rth₅₉₀ at 25° C., 60% RH and a wavelength of 590 nm. For the calculation of Rth₅₉₀, 1.48 was inputted as average refractive index. Further, the elastic modulus and the hygroscopic expansion coefficient were determined according the aforementioned process. As a result, Re₅₉₀, Rth₅₉₀, elastic modulus and hygroscopic expansion coefficient were 8 nm, 80 nm, 2,950 MPa and 55 ppm/ORH, respectively.

All the films obtained in Production Example 2 exhibited a haze of 0.3, a matting agent secondary average particle diameter of 1.0 μm or less and a mass change of 0.5% after being allowed to stand at 80° C. and 90% RH for 48 hours. The dimensional change developed when the films are each allowed to stand at 60° C. and 95% RH and 90° C. and 5% RH for 24 hours was 0.1% or less. All the samples exhibited a photoelastic coefficient of 13×10⁻¹³ cm²/dyne.

### Production Example 3

### Preparation of Cycloolefin-Based Biaxially-Stretched Film (film 19)

Using a longitudinal monoaxial stretching machine, a Type ZEONOA 1420R film (thickness: 100 μm, produced by ZEON CORPORATION) was longitudinally stretched at a stretching factor of 20%, a feed air temperature of 140° C. and a film surface temperature of 130° C. Thereafter, using a tenter stretching machine, the film was crosswise stretched at a stretching factor of 10%, a feed air temperature of 140° C. and a film surface temperature of 130° C. The film thus stretched was then trimmed at both edges thereof before the winding zone to form a wedge having a width of 1,500 mm which was then wound as a roll film to a length of 4,000 mm. Thus, a biaxially-stretched film 19 was prepared. The film thus prepared had a thickness of 75 μm. Using a Type KOBRA 21ADH birefringence measuring device (produced by Ouji Scientific Instruments Co. Ltd.), the film thus prepared was then measured for Re₅₉₀ and Rth₅₉₀ at 25° C., 60% RH and a wavelength of 590 nm. For the calculation of Rth₅₉₀, 1.51 was inputted as average refractive index. Further, the elastic modulus and the hygroscopic expansion coefficient were determined according the aforementioned process. As a result, Re₅₉₀, Rth₅₉₀, elastic modulus and hygroscopic expansion coefficient were 47 nm, 128 nm, 1,600 MPa and 1 ppm/% RH, respectively.

### Production Example 4

### Preparation of protective film (film 20=optical compensation sheet 20 having optically anisotropic layer)

### (1) Saponification

As a base film there was used the film 15 prepared in Production Example 2. The base film was passed through a 60° C. induction-heated roll to raise the film surface temperature to 40° C. An alkaline solution having the following formulation was then spread over the film at a rate of 14 ml/m² using a bar coater. The film thus coated was retained under a 110° C. steam type far infrared heater (produced by Noritake Co., Limited) for 10 seconds, and then coated with purified water at a rate of 3 ml/m² using a bar coater. During this procedure, the film temperature was 40° C. Subsequently, the film was washed with water using a fountain coater and then dehydrated using an air knife. This procedure was conducted three times. Thereafter, the film was retained in a 70° C. drying zone for 2 seconds so that it was dried.

(Formulation of alkaline solution (unit: parts by mass))

| | |
|---|---|
| Potassium hydroxide | 4.7 |
| Water | 15.7 |
| Isopropanol | 64.8 |
| Propylene glycol | 14.9 |
| C₁₆H₃₃O(CH₂CH₂O)₁₀H (surface active agent) | 1.0 |

### (2) Formation of Oriented Film Oriented Layer)

Using a #14 wire bar coater, a coating solution having the following formulation was spread over the cellulose acylate film which had been subjected to surface treatment at the aforementioned step (1) in an amount of 24 ml/m². The coated cellulose acylate film was dried with 60° C. hot air for 60 seconds and then with 90° C. hot air for 150 seconds. Subsequently, the cellulose acylate film was subjected to rubbing in the direction of clockwise 1350 with the longitudinal direction (conveying direction) of the cellulose acylate film as 0°.

(Formulation of oriented layer coating solution (unit: parts by mass))

| | |
|---|---|
| Modified polyvinyl alcohol having the following | 40 |
| formulation | |
| Water | 728 |
| Methanol | 228 |
| Glutaraldehyde (crosslinking agent) | 2 |
| Ester citrate | 0.69 |

(AS3, produced by Sankio Chemical Co., Ltd.)

### Modified Polyvinyl Alcohol

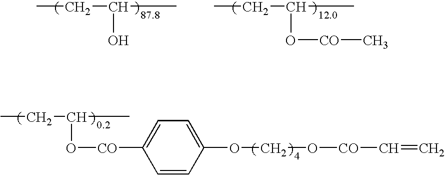

### (3) Formation of Optically Anisotropic Layer

A coating solution obtained by dissolving 41.01 Kg of the following discotic liquid crystal compound, 4.06 Kg of an ethylene oxide-modified trimethylolpropane triacrylate (V#360, produced by OSAKA ORGANIC CHEMICAL INDUSTRY LTD.), 0.29 Kg of a cellulose acetate butyrate (CAB531-1, produced by Eastman Chemical Ltd.), 1.35 Kg of a photopolymerization initiator (Irgacure 907, produced by Ciba Geigy Inc.), 0.45 Kg of a sensitizer (Kayacure DETX, produced by NIPPON KAYAKU CO., LTD.) and 0.45 Kg of ester citrate (AS3, produced by Sankio Chemical Co., Ltd.) in 102 Kg of methyl ethyl ketone and then adding 0.1 Kg of a fluoroaliphatic group-containing copolymer (Megafac F780, produced by DAINIPPON INK AND CHEMICALS, INCORPORATED) to the solution was continuously spread over the oriented layer of the film 18 which was being conveyed at a rate of 20 m/min using a #2.7 wire bar which was being rotated at 391 rpm in the same direction as the direction of conveyance of the film. The film was then dried at a step where the film was continuously heated from room temperature to 100° C. to remove solvent. Thereafter, the film was heated for about 90 seconds in a 135° C. drying zone in such a manner that hot air hit the surface of the film at a rate of 1.5 m/sec in the direction parallel to that of conveyance of the film so that the discotic liquid crystal compound was oriented. Subsequently, the film was passed to a 80° C. drying zone where the film was irradiated with ultraviolet rays at an illuminance of 600 mW for 4 seconds using an ultraviolet radiator (ultraviolet lamp: output: 160 W/cm; length of light emitted: 1.6 m) with the surface temperature of the film kept at about 100° C. so that the crosslinking reaction proceeded to fix the discotic liquid crystal compound to its orientation. Thereafter, the film was allowed to cool to room temperature, and then wound cylindrically to form a rolled film. Thus, a rolled optical compensation film 20 was prepared.

Re retardation value of the optically anisotropic layer measured at a wavelength of 589 nm using a Type KOBRA 21ADH birefringence measuring device (produced by Ouji Scientific Instruments Co. Ltd.) was 27 nm. Only the optically anisotropic layer was then peeled off the sample. Using a Type KOBRA 21ADH birefringence measuring device (produced by Ouji Scientific Instruments Co. Ltd.), the optically anisotropic layer was then measured for β value and average direction of symmetrical molecular axes. As a result, β value was 33°. The average direction of symmetrical molecular axes was 45.5° with respect to the longitudinal direction of the film 20. For the calculation of β value, 1.6 was inputted as average refractive index.

Discotic Liquid Crystal Compound

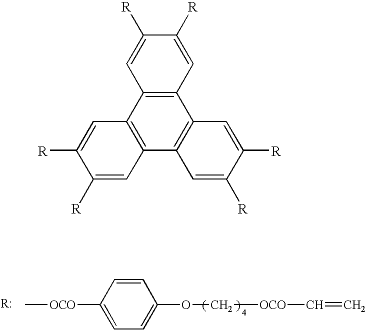

### Production Example 5

### Preparation of Protective Film (Film 21)

A polyimide synthesized from 2,2′-bis(3,4-discarboxyphenyl)hexafluoropropane and 2,2′-bis(trifluoromethyl)-4,4′-diaminobiphenyl was dissolved in cyclohexanone to prepare a 15 mass % solution. The polyimide solution thus prepared was spread over the film 17 prepared in Production Example 1 as a base film to a dry thickness of 6 μm, dried at 150° C. for 5 minutes, crosswise stretched in a 150° C. atmosphere using a tenter stretching machine by a factor of 15%, and then trimmed at both edges thereof before the winding zone to form a wedge having a width of 1,800 mm which was then wound as a roll film to a length of 4,000 m. Thus, a film 21 was obtained. The film 21 had a thickness of 75 μm. The film thus prepared was then measured for Re₅₉₀ value and Rth₅₉₀ value at 25° C., 60% RH and a wavelength of 590 nm using a Type KOBRA 21ADH birefringence measuring device (produced by Ouji Scientific Instruments Co. Ltd.). For the calculation of Rth₅₉₀, 1.58 was inputted as average refractive index. Further, the elastic modulus and the hygroscopic expansion coefficient were determined according the aforementioned process. As a result, Re₅₉₀, Rth₅₉₀, elastic modulus and hygroscopic expansion coefficient were 60 nm, 230 nm, 2,930 MPa and 45 ppm % RH, respectively.

### Production Example 6

### Preparation of Protective Film (Film 22)

A film 22 was prepared in the same manner as in Production Example 5 except that as the support there was used Fujitac TD80UL (produced by Fuji Photo Film Co., Ltd.) instead of film 17 and the polyimide solution was spread to a dry thickness of 5.5 μm. The film was trimmed at both edges thereof before the winding zone to form a wedge having a width of 1,450 mm which was then wound as a roll film to a length of 3,800 m. The thickness of the film 22 was 75 μm. The film 22 thus prepared was then measured for Re₅₉₀ value and Rth₅₉₀ value using a Type KOBRA 21ADH birefringence measuring device (produced by Ouji Scientific Instruments Co. Ltd.). Further, the elastic modulus and the hygroscopic expansion coefficient were determined according the aforementioned process. As a result, Re₅₉₀, Rth₅₉₀, elastic modulus and hygroscopic expansion coefficient were 59 nm, 234 nm, 3,045 MPa and 47 ppm % RH, respectively.

### Production Example 7

### Preparation of Protective Film (Film 23=Optical Compensation Sheet 23 having Optically Anisotropic Layer)

The film 18 prepared in Production Example 2 was saponified and stretched in the same manner as in Production Example 4. Subsequently, the cellulose acylate film was subjected to rubbing in the direction of clockwise 180° with the longitudinal direction (conveying direction) of the cellulose acylate film as 0°.

A coating solution obtained by dissolving 91.0 Kg of the aforementioned discotic liquid crystal compound, 9.0 Kg of an ethylene oxide-modified trimethylolpropane triacrylate (V#360, produced by OSAKA ORGANIC CHEMICAL INDUSTRY LTD.), 2.0 Kg of a cellulose acetate butyrate (CAB551-0.2, produced by Eastman Chemical Ltd.), 0.5 kg of a cellulose acetate butyrate (CAB531-1, produced by Eastman chemical Ltd.), 0.3 Kg of a photopolymerization initiator (Irgacure 907, produced by Ciba Geigy Inc.) and 1.0 Kg of a sensitizer (Kayacure DETX, produced by NIPPON KAYAKU CO., LTD.) in 207 Kg of methyl ethyl ketone and then adding 0.4 Kg of a fluoroaliphatic group-containing copolymer (Megafac F780, produced by DAINIPPON INK AND CHEMICALS, INCORPORATED) to the solution was continuously spread over the oriented layer of the film which was being conveyed at a rate of 20 m/min using a #3.2 wire bar which was being rotated at 391 rpm in the same direction as the direction of conveyance of the film 18.

The film was then dried at a step where the film was continuously heated from room temperature to 100° C. to remove solvent. Thereafter, the film was heated for about 90 seconds in a 135° C. drying zone in such a manner that hot air hit the surface of the film at a rate of 5.0 m/sec in the direction parallel to that of conveyance of the film so that the discotic liquid crystal compound was oriented. Subsequently, the film was passed to a 80° C. drying zone where the film was irradiated with ultraviolet rays at an illuminance of 600 mW for 4 seconds using an ultraviolet radiator (ultraviolet lamp: output: 160 W/cm; length of light emitted: 1.6 m) with the surface temperature of the film kept at about 100° C. so that the crosslinking reaction proceeded to fix the discotic liquid crystal compound to its orientation. Thereafter, the film was allowed to cool to room temperature, and then wound cylindrically to form a rolled film. Thus, a rolled optical compensation film 23 having an optically anisotropic layer was prepared.

Re retardation value of the optically anisotropic layer measured at a wavelength of 589 nm using a Type KOBRA 21ADH birefringence measuring device (produced by Ouji Scientific Instruments Co. Ltd.) was 46 nm. Only the optically anisotropic layer was then peeled off the sample. Using a Type KOBRA 21ADH birefringence measuring device (produced by Ouji Scientific Instruments Co. Ltd.), the optically anisotropic layer was then measured for β value and average direction of symmetrical molecular axes. As a result, β value was 38°. The average direction of symmetrical molecular axes was −0.3° with respect to the longitudinal direction of the optically anisotropic film 22. For the calculation of β value, 1.6 was inputted as average refractive index.

### Production Example 8

### Preparation of Protective Film having Anti-Reflection Layer (film 24)

### [Preparation of Light-Scattering Layer Coating Solution]

50 g of a mixture of pentaerythritol triacrylate and pentaerythritol tetraacryalte (PETA, produced by NIPPON KAYAKU CO., LTD.) was diluted with 38.5 g of toluene. To the solution was then added 2 g of a polymerization initiator (Irgacure 184, produced by Ciba Geigy Specialty Chemicals Co., Ltd.). The mixture was then stirred. The refractive index of the coat layer obtained by spreading and ultraviolet-curing the solution was 1.51.

To the solution were then added 1.7 g of a 30% toluene dispersion of a particulate crosslinked polystyrene having an average particle diameter of 3.54m (refractive index: 1.60; SX-350, produced by Soken Chemical & Engineering Co., Ltd.) and 13.3 g of a 30% toluene dispersion of a particulate crosslinked acryl-styrene having an average particle diameter of 3.5 μm (refractive index: 1.55, produced by Soken Chemical & Engineering Co., Ltd.) which had both been dispersed at 10,000 rpm by a polytron dispersing machine for 20 minutes. Finally, to the solution were added 0.75 g of the following fluorine-based surface modifier (FP-1) and 10 g of a silane coupling agent (KBM-5103, produced by Shin-Etsu Chemical Co., Ltd.) to obtain a mixed solution which was then filtered through a polypropylene filter having a pore diameter of 30 μm to prepare a light-scattering layer coating solution.

Fluorine-Based Surface Modifier (FP-1)

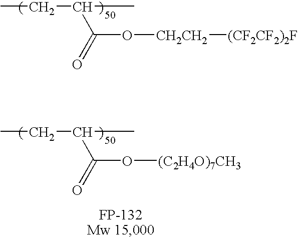

### [Preparation of Low Refractive Layer Coating Solution]

Firstly, a sol a was prepared in the following manner.

In some detail, 120 parts of methyl ethyl ketone, 100 parts of an acryloyloxypropyl trimethoxysilane (KBM5103, produced by Shin-Etsu Chemical Co., Ltd.) and 3 parts of diisopropoxyaluminum ethyl acetoacetate were charged in a reaction vessel equipped with an agitator and a reflux condenser to make mixture. To the mixture were then added 30 parts of deionized water. The mixture was reacted at 60° C. for 4 hours, and then allowed to cool to room temperature to obtain a sol a. The mass-average molecular mass of the sol was 1,600. The proportion of components having a molecular mass of from 1,000 to 20,000 in the oligomer components was 100%. The gas chromatography of the sol showed that no acryloyloxypropyl trimethoxysilane which is a raw material had been left.

13 g of a thermally-crosslinkable fluorine-containing polymer (JN-7228; solid concentration: 6%; produced by JSR Co., Ltd.) having a refractive index of 1.42, 1.3 g of silica sol (silica having a particle size different from that MEK-ST; average particle size: 45 nm; solid concentration: 30%; produced by NISSAN CHEMICAL INDUSTRIES, LTD.), 0.6 g of the sol a thus prepared, 5 g of methyl ethyl ketone and 0.6 g of cyclohexanone were mixed with stirring. The solution was then filtered through a polypropylene filter having a pore diameter of 1 Sun to prepare a low refractive layer coating solution.

[Preparation of Protective Film having Anti-Reflection Layer]

The aforementioned coating solution for functional layer (light-scattering layer) was spread over a triacetyl cellulose film having a thickness of 80 μm as a base film (Fujitac TD80UL, produced by Fuji Photo Film Co., Ltd.) which was being unwound from a roll at a gravure rotary speed of 30 rpm and a conveying speed of 30 m/min using a microgravure roll with a diameter of 50 mm having 180 lines/inch and a depth of 40 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a functional layer to a thickness of 6 μm. The film was then wound.

The coating solution for low refractive layer thus prepared was spread over the triacetyl cellulose film having a functional layer (light-scattering layer) provided thereon was being unwound at a gravure rotary speed of 30 rpm and a conveying speed of 15 m/min using a microgravure roll with a diameter of 50 mm having 180 lines/inch and a depth of 40 μm and a doctor blade. The coated film was dried at 120° C. for 150 seconds and then at 140° C. for 8 minutes. The film was irradiated with ultraviolet rays at an illuminance of 400 mW/cm² and a dose of 900 mJ/cm² from an air-cooled metal halide lamp having an output of 240 W/cm (produced by EYE GRAPHICS CO., LTD.) in an atmosphere in which the air within had been purged with nitrogen to form a low refractive layer to a thickness of 100 μm. The film was then wound. Thus, an anti-reflection protective film (film 24) was prepared.

### Production Example 9

### Preparation of Protective Film (Film 25) having Anti-Reflection Layer

### [Preparation of Hard Coat Layer Coating Solution]

To 750.0 parts by mass of a trimethylolpropane triacrylate (TMPTA, produced by NIPPON KAYAKU CO., LTD.) were added 270.0 parts by mass of a poly(glycidyl methacrylate) having a mass-average molecular mass of 3,000,730.0 g of methyl ethyl ketone, 500.0 g of cyclohexanone and 50.0 g of a photopolymerization initiator (Irgacure 184, produced by Ciba. Geigy Japan Inc.). The mixture was then stirred. The mixture was then filtered through a polypropylene filter having a pore diameter of 0.4 μm to prepare a hard coat layer coating solution.

### [Preparation of Fine Dispersion of Particulate Titanium Dioxide]

As the particulate titanium dioxide there was used a particulate titanium dioxide containing cobalt surface-treated with aluminum hydroxide and zirconium hydroxide (MPT-129, produced by ISHIHARA SANGYO KAISHA, LTD.).

To 257.1 g of the particulate titanium dioxide were then added 38.6 g of the following dispersant and 704.3 g of cyclohexanone. The mixture was then dispersed using a dinomill to prepare a dispersion of titanium dioxide particles having a mass-average particle diameter of 70 nm.

Dispersant

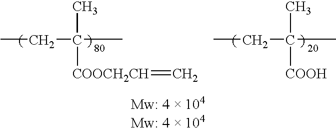

### [Preparation of Middle Layer Coating Solution]

To 88.9 g of the aforementioned dispersion of titanium dioxide particles were added 58.4 g of a mixture of dipentaerytritol pentaacrylate and dipentaerythritol hexaacrylate (DPHA), 3.1 g of a photopolymerization initiator (Irgacure 907), 1.1 g of a photosensitizer (Kayacure DETX, produced by NIPPON KAYAKU CO., LTD.), 482.4 g of methyl ethyl ketone and 1,869.8 g of cyclohexanone. The mixture was then stirred. The mixture was thoroughly stirred, and then filtered through a polypropylene filter having a pore diameter of 0.4 μm to prepare a middle refractive layer coating solution.

### [Preparation of High Refractive Layer Coating Solution]

To 586.8 g of the aforementioned dispersion of titanium dioxide particles were added 47.9 g of a mixture of dipentaerytritol pentaacrylate and dipentaerythritol hexaacrylate (DPHA), 4.0 g of a photopolymerization initiator (Irgacure 907), 1.3 g of a photosensitizer (Kayacure DETX, produced by NIPPON KAYAKU CO., LTD.), 455.8 g of methyl ethyl ketone and 1,427.8 g of cyclohexanone. The mixture was then stirred. The mixture was thoroughly stirred, and then filtered through a polypropylene filter having a pore diameter of 0.4 μm to prepare a high refractive layer coating solution.

### [Preparation of Low Refractive Layer Coating Solution]

The following copolymer (P-1) was dissolved in methyl ethyl ketone in such an amount that the concentration reached 7% by mass. To the solution were then added a methacrylate group-terminated silicone resin X-22-164C (produced by Shin-Etsu Chemical Co., Ltd.) and a photoradical generator Irgacure 907 (trade name) in an amount of 3% and 5% by mass, respectively, to prepare a low refractive layer coating solution.

### Copolymer (P-1)

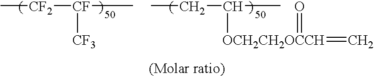

[Preparation of Protective Film having Anti-Reflection Layer]

A hard coat layer coating solution was spread over a triacetyl cellulose film having a thickness of 80 μm (Fujitack TD80 U, produced by Fuji Photo Film Co., Ltd.) as a base film using a gravure coater. The coated film was dried at 100° C., and then irradiated with ultraviolet rays at an illuminance of 400 mW/cm² and a dose of 300 mJ/cm² from an air-cooled metal halide lamp having an output of 160 W/cm (produced by EYE GRAPHICS CO., LTD.) in an atmosphere in which the air within had been purged with nitrogen to reach an oxygen concentration of 1.0 vol-% so that the coat layer was cured to form a hard coat layer to a thickness of 8 μm.

The middle refractive layer coating solution, the high refractive layer coating solution and the low refractive layer coating solution were continuously spread over the hard coat layer using a gravure coater having three coating stations.

The drying conditions of the middle refractive layer were 100° C. and 2 minutes. Referring to the ultraviolet curing conditions, the air in the atmosphere was purged with nitrogen so that the oxygen concentration reached 1.0 vol-%. In this atmosphere, ultraviolet rays were emitted at an illuminance of 400 mW/cm² and a dose of 400 mJ/cm² by an air-cooled metal halide lamp having an output of 180 W/cm (produced by EYE GRAPHICS CO., LTD.). The middle refractive layer thus cured had a refractive index of 1.630 and a thickness of 67 nm.

The drying conditions of the high refractive layer and the low refractive layer were 90° C. and 1 minute followed by 100° C. and 1 minute. Referring to the ultraviolet curing conditions, the air in the atmosphere was purged with nitrogen so that the oxygen concentration reached 1.0 vol-%. In this atmosphere, ultraviolet rays were emitted at an illuminance of 600 mW/cm² and a dose of 600 mJ/cm² by an air-cooled metal halide lamp having an output of 240 W/cm (produced by EYE GRAPHICS CO., LTD.).

The high refractive layer thus cured had a refractive index of 1.905 and a thickness of 107 nm and the low refractive layer thus cured had a refractive index of 1.440 and a thickness of 85 nm. Thus, a protective film having an anti-reflection layer (film 25) was prepared.

The configuration of the protective films prepared in Production Examples 4 to 9 and the functional layers formed therewith are set forth in Table 3.

TABLE 3

| Production | Base or | Protective film | | |
|---|---|---|---|---|
| Example | support | (Film) | Layer configuration on base or support | |
| No. | film No. | No. | film | Functional layer |
| 4 | 15 | 20 | Oriented layer/liquid crystal compound | Optically anisotropic |
| | | | layer | layer |
| 5 | 17 | 21 | Polyimide layer | |
| 6 | TD80UL | 22 | Polyimide layer | |
| 7 | 18 | 23 | Oriented layer/ | Optically anisotropic |
| | | | liquid crystal compound layer | layer |
| 8 | TD80UL | 24 | Light-scattering layer/ | Anti-reflection layer |
| | | | low refractive layer | |
| 9 | TD80UL | 25 | Hard coat layer/middle refractive layer/ | Hard coat layer/ |
| | | | high refractive layer/low refractive layer | anti-reflection layer |

TD80UL: “Fujitac TD80UL”, produced by Fuji Photo Film Co., Ltd.

### Synthesis Example 1

### (1) Preparation of (meth)acrylic Copolymer (A) Solution

A (meth)acrylic acid ester (a₁) having Tg of less than −30° C. in the form of homopolymer, a vinyl group-containing compound (a₂) having Tg of −30° C. or more in the form of homopolymer, a functional group-containing monomer (a₃) reactive with a polyfunctional compound and a polymerization initiator were charged in a reaction vessel in proportions set forth in Table 4. The air in the reactive vessel was replaced by nitrogen gas. The reaction mixture was then reacted with stirring in a nitrogen atmosphere at a reaction temperature set forth in Table 4 for a period of time set forth in Table 4. The (meth)acrylic copolymer Nos. 1, 2, 3, 5 and 6 were each diluted with ethyl acetate after reaction to a solid content concentration of 20% by mass to obtain a polymer solution. The (meth)acrylic copolymer Nos. 4 and 7 were each diluted with toluene after reaction to a solid content concentration of 20% by mass to obtain a (meth)acrylic copolymer solution.

### [Measurement of Mass-Average Molecular Mass]

The various copolymers in the aforementioned (meth)acrylic copolymer solutions were each measured for mass-average molecular mass (Mw) in styrene equivalence using gel permeation chromatography (GPC). The measurement conditions will be described below. The results are set forth in Table 4.

Name of device: “HLC-8120”, produced by TOSOH CORPORATION

### Column:

“G7000HXL” 7.8 mmID×30 cm×1 (produced by TOSOH CORPORATION)

“GMHXL” 7.8 mmID×30 cm×2 (produced by TOSOH CORPORATION) “G2500HXL” 7.8 mmID×30 cm×1 (produced by TOSOH CORPORATION)

Sample concentration: diluted with tetrahydrofurane to 1.5 ml/ml
Mobile phase solvent: Tetrahydrofurane
Flow rate: 1.0 mL/min
Column temperature: 40° C.

TABLE 4

| (Meth)acrylic copolymer (A) | | | | | | Reaction | |
|---|---|---|---|---|---|---|---|
| Copolymer | Formulation | | | Solvent | Polymerization | temperature/ | |
| No. | a₁ | a₂ | a₃ | formulation | initiator | time | Mw (×10,000) |
| 1 | BA: 100 | | AA: 5 | EAc: 120/ | BPO: 0.3 | 70° C./10 hr | 80 |
| | | | | toluene: 30 | | | |
| 2 | BA: 80 | MA: 20 | AA: 5 | EAc: 120/ | AIBN: 0.3 | 70° C./10 hr | 70 |
| | | | | toluene: 30 | | | |
| 3 | BA: 100 | | AA: 5 | EAc: 100 | BPO: 0.2 | 66° C./10 hr | 150 |
| 4 | BA: 90 | BzA: 10 | HEA: 1 | Toluene: 100 | AIBN: 2/LaSH: 2 | 110° C./6 hr | 1 |
| 5 | BA: 50 | MA: 50 | AA: 5 | EAc: 120/ | AIBN: 0.3 | 70° C./10 hr | 75 |
| | | | | toluene: 30 | | | |
| 6 | BA: 80 | MA: 20 | AA: 15 | EAc: 120/ | AIBN: 0.3 | 70° C./10 hr | 70 |
| | | | | toluene: 30 | | | |
| 7 | BA: 90 | BzA: 10 | HEA: 0.1 | Toluene: 100 | AIBN: 2/LaSH: 2 | 110° C./6 hr | 1 |

Composition ratio: parts by mass
BA: Butyl acrylate;
EAc: Ethyl acetate;
BPO: Benzoyl peracetate;
MA: Methyl acrylate;
AIBN: Azobisisobutylonitrile;
AA: Acrylic acid;
LaSH: Lauryl mercaptan;
BaZ: Benzyl acrylate;
HEA: 2-Hydroxyethyl acrylate

### (2) Preparation of Adhesive Solution

The (meth)acrylic copolymer (A) solution prepared in Synthesis Example 1 was charged in a solid content proportion set forth in Table 5. To the (meth)acrylic copolymer (A) solution was then added the polyfunctional compound (crosslinking agent) (B) set forth in Table 5. The mixture was then stirred thoroughly to obtain an adhesive solution.

### [Measurement of Gel Fraction]

The measurement of gel fraction was conducted as follows. The adhesive solution was spread over a PET film having a thickness of 25 μm using a die coater, and then dried. The spread of the adhesive solution was adjusted such that the dried thickness reached 25 μm. About 20 ml of the adhesive layer thus dried was dipped in about 10 ml of chloroform. The undissolved components were then removed by filtration through a filter having a pore diameter of 0.45 μm. The residue was then dried. The residue thus dried was then measured for mass as mass Mg of gel component (crosslinked component). The filtrate was then dried. The resulting residue was then measured for mass as mass Ms of sol component (uncrosslinked component). The gel fraction was calculated by the following formula.

% Gel fraction=Mg/(Mg+Ms)×100

The measurement of gel fraction was conducted under three conditions, i.e., shortly after spreading, 1 month after spreading and heated to 80° C. for 500 hours 1 month after spreading.

TABLE 5

| | | | | % Functional | |
|---|---|---|---|---|---|
| Adhesive | Compounding of | | % Gel | group | |
| solution | (meth)acrylic | Polyfunctional | fraction | distribution | |
| No. | copolymer (A) | compound (B) | (mass %) | (mass %) | Remarks |
| 1 | No. 1: 100 | Tetrad X: 0.02 | 50 | 0 | Inventive |
| 2 | No. 1: 100 | Tetrad X: 0.04 | 75 | 0 | Inventive |
| 3 | No. 2: 100 | Colonate L: 0.03 | 60 | 0 | Inventive |
| 4 | No. 3: 100/No. 4: 50 | Colonate L: 0.04 | 70 | 10 | Inventive |
| 5 | No. 3: 100 | Colonate L: 0.04 | 70 | 0 | Inventive |
| 6 | No. 3: 100/No. 4: 5 | Colonate L: 0.04 | 70 | 1 | Inventive |
| 7 | No. 1: 100 | Tetrad X: 0.005 | 30 | 0 | Comparative |
| 8 | No. 1: 100 | Tetrad X: 2 | 95 | 0 | Comparative |
| 9 | No. 5: 100 | Colonate: 0.03 | 60 | 0 | Comparative |
| 10 | No. 6: 100 | Colonate: 2 | 97 | 0 | Comparative |
| 11 | No. 3: 100/No. 4: 200 | Colonate: 0.04 | 85 | 40 | Comparative |
| 12 | No. 3: 100/No. 7: 300 | Colonate: 0.04 | 85 | 6 | Comparative |

Composition ratio: parts by mass;
No. of (meth)acrylic copolymer is copolymer No.
“Tetrad X”: N,N,N′,N′-Tetraglycidyl-m-xylenediamine, produced by MITSUBISHI GAS CHEMICAL COMPANY, INC.
“Colonate L”: Tolylene diisocyanate-trimethylol propane adduct, produced by NIPPON POLYURETHANE INDUSTRY CO., LTD.

### Synthesis Example 2

### Preparation of Adhesive Solution 13

100 parts by mass of butyl acrylate, 5 parts by mass of acrylic acid and 0.5 parts by mass of 2,2′-azobisbutylonitrile were dissolved in ethyl acetate to a monomer concentration of 60% by mass, and then polymerized at 60° C. for 8 hours to obtain a solution of polymer 1. To 100 parts by mass of the solid content of the polymer 1 was then added 1 part by mass of an isocyanate-based crosslinking agent (trade name: Colonate L, produced by NIPPON POLYURETHANE INDUSTRY CO., LTD.). The mixture was then thoroughly stirred to prepare an adhesive solution 13.

### Synthesis Example 3

### Preparation of Adhesive Solution 14

100 parts by mass of butyl acrylate, 5 parts by mass of acrylic acid and 0.5 parts by mass of benzoyl peroxide were dissolved in ethyl acetate to a monomer concentration of 60% by mass, and then polymerized at 60° C. for 8 hours to obtain a solution of polymer 2. To 100 parts by mass of the solid content of the polymer 2 was then added 1 part by mass of an isocyanate-based crosslinking agent (trade name: Colonate L, produced by NIPPON POLYURETHANE INDUSTRY CO., LTD.). The mixture was then thoroughly stirred to prepare an adhesive solution 14.

### Synthesis Example 4

### Preparation of Adhesive Solution 15

100 parts by mass of butyl acrylate, 5 parts by mass of acrylic acid and 0.5 parts by mass of 2,2′-azobisbutylonitrile were dissolved in ethyl acetate to a monomer concentration of 60% by mass, and then polymerized at 60° C. for 8 hours to obtain a solution of polymer 3. To 100 parts by mass of the solid content of the polymer 3 was then added 0.2 parts by mass of an isocyanate-based crosslinking agent (trade name: Colonate L, produced by NIPPON POLYURETHANE INDUSTRY CO., LTD.). The mixture was then thoroughly stirred to prepare an adhesive solution 15.

### Synthesis Example 5

### Preparation of Adhesive Solution 16

70 parts by mass of butyl acrylate, 30 parts by mass of methyl acrylate, 5 parts by mass of acrylic acid and 0.5 parts by mass of 2,2′-azobisbutylonitrile were dissolved in ethyl acetate to a monomer concentration of 60% by mass, and then polymerized at 60° C. for 8 hours to obtain a solution of polymer 4. To 100 parts by mass of the solid content of the polymer 4 was then added 1 part by mass of an isocyanate-based crosslinking agent (trade name: Colonate L, produced by NIPPON POLYURETHANE INDUSTRY CO., LTD.). The mixture was then thoroughly stirred to prepare an adhesive solution 16.

### (Spreading of Adhesive Layer Coating Solution)

The spreading of the adhesive layer coating solution over the polarizing plate was conducted as follows.

The adhesive solutions 1 to 16 were each spread over a PET film having a thickness of 25 μm using a die coater, and then dried. During this procedure, adjustment was made such that the thickness of the adhesive layer dried reached 25 μm. The adhesive layer formed on the PET film was transferred onto the polarizing plate where it was then ripened at 25° C. and 60% RH for 7 days. The adhesive solutions 1 to 16 were spread to form adhesive layers 1 to 16, respectively. As the adhesive 17 there was used a rubber-based adhesive.

### [Measurement of Creep]

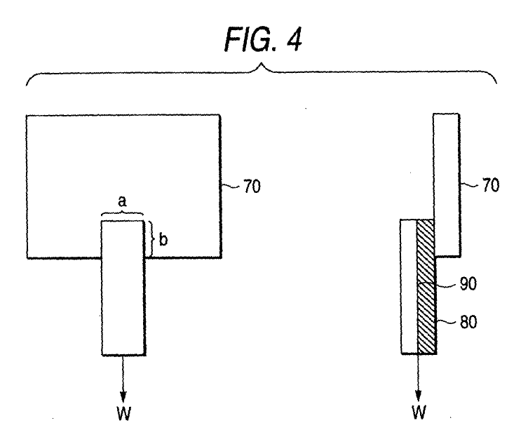

A polarizing plate 90 having an adhesive layer 80 formed thereon was stuck to an alkali-free glass sheet (model number: 1737, produced by Corning Inc.) 70 which had been washed with water and dried as shown in FIG. 4. The sticking area was 10 mm (width a)×10 mm (length b). The initial adhesion pressure was 5 kg/cm². Thereafter, the adhesion pressure was removed. The laminate was under a load W of 200 g in a 50° C. atmosphere for 1 hour. The laminate was withdrawn at room temperature, and then measured for creep of adhesive. The creep was also measured on the same test specimen as used above after being processed in the same manner as in the case of 50° C. except that the temperature of the atmosphere was 25° C., 70° C. and 90° C.

### [Measurement of Adhesion]

The adhesion of the adhesive layer is measured according to JIS Z 0237 (method of testing adhesive tape and adhesive sheet). In some detail, a polarizing plate having an adhesive layer formed thereon at an area of 100 mm length×25 mm width is prepared. The polarizing plate thus prepared is then stuck to an alkali-free glass sheet (model number: 1737, produced by Corning Inc.) which had been washed with water and dried. Subsequently, a 2 kg roller is moved back and forth on the laminate which is then allowed to stand at 25° C. for 20 minutes. The aforementioned glass sheet and the polarizing plate are then measured for force required to peel the polarizing plate off the glass sheet using a Type TMC-1kNB tensile testing machine (produced by Minebea Co., Ltd.) at 25° C., a peel rate of 300 mm/min and an angle of 90° according to JIS Z 0237. Thus, the adhesion of the aforementioned adhesive layer is determined.

The measurement was conducted on two samples, i.e., sample which had not been subjected to heat treatment after sticking the polarizing plate to the glass sheet and sample which had been allowed to stand at 50° C. and 5 atm. in an autoclave for 15 minutes so that the adhesion is ripened, and then heated to 70° C. for 5 hours.

### [Method of Measuring Elastic Modulus]

The adhesive solution was spread over a PET film having a thickness of 25 μm using a die coater, and then dried. During this procedure, adjustment was made such that the thickness of the adhesive layer dried reached 25 μm. The PET film was then laminated on the adhesive layer. The laminate was then ripened at 25° C. and 60% RH for 7 days. The lamination was made such that the thickness of the adhesive layer reached 1 mm. The laminate was then cut into a size of 20 mm length×5 mm width. The sample was then measured for stress-strain curve at a pulling rate of 300 mm/min and a chuck distance of 10 mm to determine elastic modulus. The measurement was conducted in an atmosphere of 25° C. and 90° C.

### [Measurement of Shear Modulus]

The laminate was measured for tensile stress-strain curve by pulling at a pulling rate of 1 mm/min according to JIS K 6850 (method of testing tensile shear adhesion of adhesive). Since JIS K 6850 doesn't specify a method of calculating elastic modulus, the value determined by the calculation method specified in the method of tensile test on plastic film and sheet according to Clause 8(3) of JIS K 7127 is defined as shear modulus of adhesive layer.

The physical properties of the adhesives 13 to 17 are set forth in Table 6 below.

TABLE 6

| Physical | | | | | | |
|---|---|---|---|---|---|---|
| properties | Conditions | Adhesive 13 | Adhesive 14 | Adhesive 15 | Adhesive 16 | Adhesive 17 |
| Creep | 25° C. | 10 μm | 11 μm | 50 μm | 26 μm | |
| | 50° C. | 20 μm | 20 μm | 82 μm | 50 μm | |
| | 70° C. | 83 μm | 75 μm | 120 μm | 68 μm | |
| | 90° C. | 105 μm | 98 μm | 158 μm | 88 μm | |
| | Temperature | 0.037 | 0.036 | 0.056 | 0.037 | |
| | dependence | | | | | |

| | | | | | | |
|---|---|---|---|---|---|---|
| Adhesion | Not | 25° C. | 14.2 N/25 mm | 13.2 N/25 mm | 14.5 N/25 mm | 7.5 N/25 mm |
| | heat- | | | | | |
| | treated | | | | | |
| | After | 25° C. | 24.5 N/25 mm | 23.5 N/25 mm | 25.5 N/25 mm | 13.2 N/25 mm |
| | 70° C. × 5 hr | 40° C. | 12.3 N/25 mm | 11.8 N/25 mm | 12.8 N/25 mm | 6.7 N/25 mm |
| | | 60° C. | 17.6 N/25 mm | 16.9 N/25 mm | 18.3 N/25 mm | 9.5 N/25 mm |

| | | | | | | |
|---|---|---|---|---|---|---|
| Elastic | 25° C. | 0.1 MPa | 0.11 MPa | 0.06 MPa | 0.14 MPa | |
| modulus | 90° C. | 0.07 MPa | 0.08 MPa | 0.03 MPa | 0.11 MPa | |
| Shear | 25° C. | 6 × 10⁹ Pa | 7 × 10⁹ Pa | 3 × 10⁹ Pa | 1 × 10¹⁰ Pa | 8 × 10⁷ Pa |
| modulus | | | | | | |
| Tg | | Tg = −55° C. | Tg = −53° C. | Tg = −55° C. | Tg = −43° C. | |
| Gel | Shortly after | 74% | 77% | 50% | 75% | |
| fraction | spreading | | | | | |
| | 1 month after | 75% | 82% | 51% | 76% | |
| | spreading | | | | | |
| | 80° C. × 500 hr | 78% | 93% | 53% | 79% | |
| | 1 month | | | | | |
| | after | | | | | |
| | spreading | | | | | |
| Adhesion | 25° C. 1 | 14.5 N/25 mm | 13.0 N/25 mm | 14.8 N/25 mm | 7.7 N/25 mm | |
| | month after | | | | | |
| | spreading | | | | | |
| | 25° C. after | 14.0 N/25 mm | 8.9 N/25 mm | 14.1 N/25 mm | 7.2 N/25 mm | |
| | 80° C. × 500 hr 1 | | | | | |
| | month | | | | | |
| | after | | | | | |
| | spreading | | | | | |

| | | | | | |
|---|---|---|---|---|---|
| Remarks | Inventive | Comparative | Comparative | Comparative | Comparative |

### [Preparation of Polarizing Plate]

### Examples 1-1 to 1-51

### Comparative Examples 1-1 to 1-18

### (Preparation of Polarizer)

A polyvinyl alcohol (PVA) film having a thickness of 80 μm was dipped in an aqueous solution of iodine having an iodine concentration of 0.05% by mass at 30° C. for 60 seconds so that it was dyed, longitudinally stretched by a factor of 5 while being dipped in an aqueous solution of boric acid having a boric cid concentration of 4% by mass for 60 seconds, and then dried at 50° C. for 4 minutes to obtain a polarizing film having a thickness of 20 μm.

### (Surface Treatment of Cellulose Acylate Film)

The protective films prepared in Production Examples 1 and 4 to 9 and the following commercially available cellulose acylate films were each dipped in a 55° C. 1.5 mol/l aqueous solution of sodium hydroxide, and then thoroughly washed with water to remove sodium hydroxide. Thereafter, these films were each dipped in a 35° C. 0.005 mol/l aqueous solution of diluted sulfuric acid for 1 minute, and then dipped in water to remove thoroughly the aqueous solution of diluted sulfuric acid. Finally, the sample was thoroughly dried at 120° C.

### (Preparation of Polarizing Plate)

The protective films and commercially available cellulose acylate films thus saponified were each then laminated with a polyvinyl alcohol-based adhesive with the aforementioned polarizer interposed therebetween according to the combination set forth in Tables 7 and 8 to obtain polarizing plates.

As the commercially available cellulose acylate films there were used Fujitac T40UZ, Fujitac T80UZ, Fujitac TF80UL, Fujitac TD80UL, Fujitac TDY80UL (produced by Fuji Photo Film Co., Ltd.) and KC80UVSFD (produced by Konica Minolta Opto Products Co., Ltd.).

During this procedure, the polarizer and the protective film on the both sides of the polarizer are continuously stuck to each other because they are in a rolled form and parallel to each other in the longitudinal direction. In the protective film (corresponding to TAC 1) disposed on the cell side, as shown in FIG. 1, the transmission axis 2 of the polarizer 1 and the slow axis 4 of the cellulose acylate film 3 prepared in Example 1 are parallel to each other.

### (Spreading of Adhesive Layer Coating Solution)

The spreading of the adhesive layer coating solution over the polarizing plate was conducted as follows.

The adhesive solutions were each spread over a PET film having a thickness of 25 μm using a die coater, and then dried. During this procedure, adjustment was made such that the thickness of the adhesive layer dried reached 25 μm. The adhesive layer formed on the PET film was transferred onto the polarizing plate in such an arrangement that the combination set forth in Tables 7 and 8 was made. The adhesive layer was then ripened at 25° C. and 60% RH for 7 days.

A separator film of PET was then stuck to the polarizing plate thus prepared on the adhesive layer side thereof. A protective film of PET was stuck to the side of the polarizing plate opposite the adhesive layer.

### Example 2

A commercially available cellulose acetate film which had been subjected to saponification in the same manner as in Example 1 was stuck to one side of the polarizer prepared in the same manner as in Example 1 with a polyvinyl alcohol-based adhesive. The film 19 prepared in Production Example 3 was stuck to the other side of the polarizer with an acrylic adhesive “DD624” (produced by NOGAWA CHEMICAL CO., LTD.) to prepare a polarizing plate on which an adhesive layer was then formed in the same manner as in Example 1.

The configuration of the polarizing plates prepared in Examples 1 and 2 are set forth in Tables 7 and 8.

TABLE 7
Viewing side polarizing plate:

| | | Protective film (Film No.) | | Adhesive layer |
|---|---|---|---|---|
| | Polarizing plate | Liquid crystal | Side opposite | coating solution |
| Example No. | No. | side | liquid crystal cell | No. |
| Example 1-1 | F-1 | 1 | 24*¹ | 1 |
| Example 1-2 | F-2 | 2 | 24*¹ | 1 |
| Example 1-3 | F-3 | 3 | 25*¹ | 1 |
| Example 1-4 | F-4 | 4 | 25*¹ | 2 |
| Example 1-5 | F-5 | 5 | 24*¹ | 2 |
| Example 1-6 | F-6 | 6 | 24*¹ | 2 |
| Example 1-7 | F-7 | 7 | 24*¹ | 2 |
| Example 1-8 | F-8 | 19 | 24*¹ | 2 |
| Example 1-9 | F-9 | KC80UVSFD | 24*¹ | 2 |
| Example 1-10 | F-10 | TD80UL | 24*¹ | 2 |
| Example 1-11 | F-11 | TD80UL | 25*¹ | 2 |
| Example 1-12 | F-12 | TF80UL | 25*¹ | 2 |
| Example 1-13 | F-13 | TDY80UL | 24*¹ | 2 |
| Example 1-14 | F-14 | 12 | 24*¹ | 2 |
| Example 1-15 | F-15 | 16 | 24*¹ | 2 |
| Example 1-16 | F-16 | TD80UL | 24*¹ | 3 |
| Example 1-17 | F-17 | TDY80UL | 24*¹ | 3 |
| Example 1-18 | F-18 | TD80UL | 24*¹ | 4 |
| Example 1-19 | F-19 | TDY80UL | 24*¹ | 4 |
| Example 1-20 | F-20 | TD80UL | 24*¹ | 5 |
| Example 1-21 | F-21 | TD80UL | 24*¹ | 6 |
| Comp. Ex. 1-1 | FR-1 | TD80UL | 24*¹ | 7 |
| Comp. Ex. 1-2 | FR-2 | TD80UL | 24*¹ | 8 |
| Comp. Ex. 1-3 | FR-3 | TD80UL | 24*¹ | 9 |
| Comp. Ex. 1-4 | FR-4 | TD80UL | 24*¹ | 10 |
| Comp. Ex. 1-5 | FR-5 | TD80UL | 24*¹ | 11 |
| Comp. Ex. 1-6 | FR-6 | TD80UL | 24*¹ | 12 |
| Example 1-22 | F-22 | 20 | 24*¹ | 1 |
| Comp. Ex. 1-7 | FR-7 | 20 | 24*¹ | 9 |
| Example 1-23 | F-23 | 23 | 24*¹ | 1 |
| Comp. Ex. 1-8 | FR-8 | 23 | 24*¹ | 9 |
| Example 1-24 | F-24 | 17 | 24*¹ | 2 |
| Comp. Ex. 1-9 | FR-9 | 17 | 24*¹ | 9 |

*¹With anti-reflection properties

TABLE 8
Backlight side polarizing plate:

| | | Protective film (Film No.) | | Adhesive layer |
|---|---|---|---|---|
| | Polarizing plate | Liquid crystal | Side opposite | coating solution |
| Example No. | No. | side | liquid crystal cell | No. |
| Example 1-25 | B-1 | 1 | KC80UVSFD | 1 |
| Example 1-26 | B-2 | 2 | T80UZ | 1 |
| Example 1-27 | B-3 | 3 | TDY80UL | 1 |
| Example 1-28 | B-4 | 4 | T40UZ | 2 |
| Example 1-29 | B-5 | 5 | TF80UL | 2 |
| Example 1-30 | B-6 | 6 | TDY80UL | 2 |
| Example 1-31 | B-7 | 7 | TD80UL | 2 |
| Example 2 | B-8 | 19 | TD80UL | 2 |
| Example 1-32 | B-9 | 8 | KC80UVSFD | 2 |
| Example 1-33 | B-10 | 9 | T80UZ | 2 |
| Example 1-34 | B-11 | 10 | TDY80UL | 2 |
| Example 1-35 | B-12 | 11 | T40UZ | 2 |
| Example 1-36 | B-13 | 12 | 24*¹ | 2 |
| Example 1-37 | B-14 | 13 | 24*¹ | 2 |
| Example 1-38 | B-15 | 14 | 24*¹ | 2 |
| Example 1-39 | B-16 | 16 | 24*¹ | 2 |
| Example 1-40 | B-18 | TD80UL | 24*¹ | 2 |
| Example 1-41 | B-19 | 21 | 24*¹ | 2 |
| Example 1-42 | B-20 | 22 | 24*¹ | 2 |
| Example 1-43 | B-21 | 12 | TD80UL | 3 |
| Example 1-44 | B-22 | 16 | TD80UL | 3 |
| Example 1-45 | B-23 | 12 | TD80UL | 4 |
| Example 1-46 | B-24 | 16 | TD80UL | 4 |
| Example 1-47 | B-25 | 12 | TD80UL | 5 |
| Example 1-48 | B-26 | 12 | TD80UL | 6 |
| Comp. Ex. 1-10 | BR-1 | 12 | TD80UL | 7 |
| Comp. Ex. 1-11 | BR-2 | 12 | TD80UL | 8 |
| Comp. Ex. 1-12 | BR-3 | 12 | TD80UL | 9 |
| Comp. Ex. 1-13 | BR-4 | 12 | TD80UL | 10 |
| Comp. Ex. 1-14 | BR-5 | 12 | TD80UL | 11 |
| Comp. Ex. 1-15 | BR-6 | 12 | TD80UL | 12 |
| Example 1-49 | B-27 | 20*² | TD80UL | 1 |
| Comp. Ex. 1-16 | BR-7 | 20*² | TD80UL | 9 |
| Example 1-50 | B-28 | 23*² | TD80UL | 1 |
| Comp. Ex. 1-17 | BR-8 | 23*² | TD80UL | 9 |
| Example 1-51 | B-29 | 17 | TD80UL | 2 |
| Comp. Ex. 1-18 | BR-9 | 17 | TD80UL | 9 |

*¹With anti-reflection properties
*²With optical compensation properties

### [Measurement of Reflectance]

Using a spectrophotometer (produced by JASCO CO., LTD.), these polarizing plates were each measured for spectral reflectance on the functional layer side thereof at an incidence angle of 5° and a wavelength of from 380 to 780 nm to determine an integrating sphere average reflectance at 450 to 650 nm. As a result, the polarizing plate comprising the protective film 24 with anti-reflection layer exhibited an integrating sphere average reflectance of 2.3%. The polarizing plate comprising the protective film 25 with anti-reflection layer exhibited an integrating sphere average reflectance of 0.4%. For the measurement of reflectance, the protective film was peeled off the protective film with anti-reflection layer.

### Examples 3-1 to 3-26

### Comparative Examples 3-1 to 3-6

### (1) Mounting on VA Panel

The polarizing plates prepared in Example 1, Comparative Example 1 and Example 2 were each punched into a rectangle such that the viewing side polarizing plate has a 26″ wide size and a polarizer absorption axis as a longer side and the backlight side polarizing plate has a polarizer absorption axis as a shorter side. The front and rear polarizing plates and the retarder film plate were peeled off a Type KDL-L26RX2 VA mode liquid crystal TV (produced by Sony Corporation). The polarizing plates prepared in Example 1, Comparative Example 1 and Example 2 were each then stuck to the front and back sides of the liquid crystal according to combination of configurations set forth in Table 8 to prepare liquid crystal display devices VA-1 to VA-27 and VA-R1 to VA-R6. After the sticking of polarizing plate, these liquid crystal display devices were each then kept at 50° C. and 5 kg/cm² for 20 minutes to cause adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

### [Light Leakage and Polarizing Plate Exfoliation by Durability Test]

The liquid crystal display device prepared in Example 3 was subjected to durability test under the following two conditions.

(1) The liquid crystal display device was kept in an atmosphere of 60° C. and 90% RH for 200 hours, and then withdrawn in an atmosphere of 25° C. and 60% RH. 24 hours after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 8.

(2) The liquid crystal display device was kept in a dry atmosphere of 80° C. for 200 hours, and then withdrawn in an atmosphere of 25° C. and 60% RH. One hour after, the liquid crystal display device was allowed to perform black display. During the performance, the liquid crystal display device was evaluated for the degree of light leakage and the occurrence of exfoliation of the polarizing plate from the liquid crystal panel.

The evaluation of light leakage was conducted according to the following criterion.

| Conditions | | Degree of light |
|---|---|---|
| of light leakage | Practical problem | leakage |
| No light leakage | None | 1 |
| Very weak | None | 2 |
| Weak | None | 3 |
| Strong | Some | 4 |
| Very strong | Some | 5 |

The combination of the VA mode liquid crystal display devices thus prepared with polarizing plates and the properties of the liquid crystal display devices are set forth in Table 9.

TABLE 9

| | Liquid | | | | 60° C.-90% | | | |
|---|---|---|---|---|---|---|---|---|
| | crystal | Viewing | | Backlight | RH × 200 hr | | 80° C. dry × 200 hr | |
| | display | side | Liquid | side | Degree | | Degree | |
| Example | device | polarizing | crystal | polarizing | of light | | of light | |
| No. | No. | plate No. | cell | plate No. | leakage | Exfoliated? | leakage | Exfoliated? |
| Example | VA-1 | F-1 | VA | B-1 | 1 | No | 1 | No |
| 3-1 | | | | | | | | |
| Example | VA-2 | F-2 | VA | B-2 | 1 | No | 1 | No |
| 3-2 | | | | | | | | |
| Example | VA-3 | F-3 | VA | B-3 | 1 | No | 1 | No |
| 3-3 | | | | | | | | |
| Example | VA-4 | F-4 | VA | B-4 | 1 | No | 1 | No |
| 3-4 | | | | | | | | |
| Example | VA-5 | F-5 | VA | B-5 | 1 | No | 1 | No |
| 3-5 | | | | | | | | |
| Example | VA-6 | F-6 | VA | B-6 | 1 | No | 1 | No |
| 3-6 | | | | | | | | |
| Example | VA-7 | F-7 | VA | B-7 | 1 | No | 1 | No |
| 3-7 | | | | | | | | |
| Example | VA-8 | F-8 | VA | B-8 | 1 | No | 1 | No |
| 3-8 | | | | | | | | |
| Example | VA-9 | F-9 | VA | B-9 | 1 | No | 1 | No |
| 3-9 | | | | | | | | |
| Example | VA-10 | F-10 | VA | B-10 | 1 | No | 1 | No |
| 3-10 | | | | | | | | |
| Example | VA-11 | F-11 | VA | B-11 | 1 | No | 1 | No |
| 3-11 | | | | | | | | |
| Example | VA-12 | F-12 | VA | B-12 | 1 | No | 1 | No |
| 3-12 | | | | | | | | |
| Example | VA-13 | F-10 | VA | B-13 | 1 | No | 1 | No |
| 3-13 | | | | | | | | |
| Example | VA-14 | F-13 | VA | B-14 | 1 | No | 1 | No |
| 3-14 | | | | | | | | |
| Example | VA-15 | F-10 | VA | B-15 | 1 | No | 1 | No |
| 3-15 | | | | | | | | |
| Example | VA-16 | F-10 | VA | B-16 | 1 | No | 1 | No |
| 3-16 | | | | | | | | |
| Example | VA-17 | F-14 | VA | B-17 | 1 | No | 1 | No |
| 3-17 | | | | | | | | |
| Example | VA-18 | F-15 | VA | B-17 | 1 | No | 1 | No |
| 3-18 | | | | | | | | |
| Example | VA-19 | F-10 | VA | B-18 | 1 | No | 1 | No |
| 3-19 | | | | | | | | |
| Example | VA-20 | F-10 | VA | B-19 | 1 | No | 1 | No |
| 3-20 | | | | | | | | |
| Example | VA-21 | F-16 | VA | B-20 | 2 | No | 1 | No |
| 3-21 | | | | | | | | |
| Example | VA-22 | F-17 | VA | B-21 | 2 | No | 1 | No |
| 3-22 | | | | | | | | |
| Example | VA-23 | F-18 | VA | B-22 | 1 | No | 1 | No |
| 3-23 | | | | | | | | |
| Example | VA-24 | F-19 | VA | B-23 | 1 | No | 1 | No |
| 3-24 | | | | | | | | |
| Example | VA-25 | F-20 | VA | B-24 | 2 | No | 1 | No |
| 3-25 | | | | | | | | |
| Example | VA-26 | F-21 | VA | B-25 | 2 | No | 1 | No |
| 3-26 | | | | | | | | |
| Comp. Ex. | VA-R1 | FR-1 | VA | BR-1 | 1 | Yes | 1 | Yes |
| 3-1 | | | | | | | | |
| Comp. Ex. | VA-R2 | FR-2 | VA | BR-2 | 5 | No | 4 | No |
| 3-2 | | | | | | | | |
| Comp. Ex. | VA-R3 | FR-3 | VA | BR-3 | 5 | Yes | 4 | Yes |
| 3-3 | | | | | | | | |
| Comp. Ex. | VA-R4 | FR-4 | VA | BR-4 | 4 | No | 3 | No |
| 3-4 | | | | | | | | |
| Comp. Ex. | VA-R5 | FR-5 | VA | BR-5 | 4 | No | 3 | No |
| 3-5 | | | | | | | | |
| Comp. Ex. | VA-R6 | FR-6 | VA | BR-6 | 4 | Yes | 3 | Yes |
| 3-6 | | | | | | | | |

### Example 4 and Comparative Example 4

### (2) Mounting on OCB panel

A polyimide layer was provided as an alignment layer on a glass substrate with ITO electrode. The alignment layer was subjected to rubbing. Two sheets of the glass substrates thus obtained were laminated on each other in such an arrangement that the rubbing direction of the two sheets are parallel to each other. The cell gap was predetermined to be 5.7 μm. Into the cell gap was then injected a liquid crystal compound having Δn of 0.1396 “ZLI1132” (produced by Melc Co., Ltd.) to prepare a cell.

The polarizing plates prepared in Example 1 and Comparative Example 1 were each punched into a 23″ wide rectangle both on the viewing side polarizing plate and backlight side polarizing plate such that the absorption axis is disposed at an angle of 45° with respect to the longer side of the polarizing plate thus punched. Two sheets of the polarizing plates were then laminated with OCB interposed therebetween. The arrangement was made such that the optically anisotropic layer of the polarizing plate is opposed to the cell substrate and the rubbing direction of the liquid crystal cell and the rubbing direction of the optically anisotropic layer opposed to the liquid crystal cell are not parallel to each other to prepare liquid crystal display devices OCB-1 and OCB-R1. After the sticking of polarizing plate, the laminate was kept at 50° C. and a load of 5 kg/cm² for 20 minutes to complete adhesion.

The liquid crystal display device thus prepared was disposed on the backlight. A white display voltage of 2 V and a black display voltage of 4.5 V were then applied to the liquid crystal cell. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

The OCB mode liquid crystal display devices thus obtained were each evaluated for properties in the same manner as in Example 3 and Comparative Example 3. The combination of the liquid crystal display devices thus prepared with polarizing plates and the properties of the display devices are set forth in Table 10.

TABLE 10

| | Liquid | | | | 60° C.-90% | | | |
|---|---|---|---|---|---|---|---|---|
| | crystal | Viewing | | Backlight | RH × 200 hr | | 80° C. dry × 200 hr | |
| | display | side | Liquid | side | Degree | | Degree | |
| Example | device | polarizing | crystal | polarizing | of light | | of light | |
| No. | No. | plate No. | cell | plate No. | leakage | Exfoliated? | leakage | Exfoliated? |
| Example 4 | OCB-1 | F-22 | OCB | B-26 | 1 | No | 1 | No |
| Comp. Ex. 4 | OCB- | FR-7 | OCB | BR-7 | 5 | Yes | 4 | Yes |
| | R1 | | | | | | | |

### Example 5 and Comparative Example 5

### (3) Mounting on TN Panel

The polarizing plates prepared in Example 1 and Comparative Example 1 were each punched into a 17″ wide rectangle both on the viewing side polarizing plate and backlight side polarizing plate such that the absorption axis is disposed at an angle of 45° with respect to the longer side of the polarizing plate thus punched. The front and rear polarizing plates and the retarder film plate were peeled off a Type SynchMaster 172×TN mode liquid crystal monitor (produced by Samsung Corporation). The polarizing plates prepared in Example 1 and Comparative Example 1 were each then stuck to the front and back sides of the liquid crystal according the combination of configurations set forth in Table 11 to prepare liquid crystal display devices TN-1 and TN-R1. After the sticking of polarizing plate, these liquid crystal display devices were each then kept at 50° C. and 5 kg/cm² for 20 minutes to complete adhesion. During this procedure, arrangement was made such that the optically anisotropic layer of the polarizing plate is opposed to the cell substrate and the rubbing direction of the liquid crystal cell and the rubbing direction of the optically anisotropic layer opposed to the liquid crystal cell are not parallel to each other.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 60° or more in all directions.

The TN mode liquid crystal display devices thus obtained were each evaluated for properties in the same manner as in Example 3 and Comparative Example 3. The combination of the liquid crystal display devices thus prepared with polarizing plates and the properties of the display devices are set forth in Table 11.

TABLE 11

| | Liquid | | | | 60° C.-90% | | | |
|---|---|---|---|---|---|---|---|---|
| | crystal | Viewing | | Backlight | RH × 200 hr | | 80° C. dry × 200 hr | |
| | display | side | Liquid | side | Degree | | Degree | |
| | device | polarizing | crystal | polarizing | of light | | of light | |
| Example No. | No. | plate No. | cell | plate No. | leakage | Exfoliated? | leakage | Exfoliated? |
| Example 5 | TN-1 | F-23 | TN | B-27 | 1 | No | 1 | No |
| Comp. Ex. 5 | TN-R1 | FR-8 | TN | BR-8 | 5 | Yes | 4 | Yes |

### Example 6 and Comparative Example 6

### (4) Mounting on IPS Panel

The polarizing plates prepared in Example 1 and Comparative Example 1 were each punched into a rectangle such that the viewing side polarizing plate has a 32″ wide size and a polarizer absorption axis as a longer side and the backlight side polarizing plate has a polarizer absorption axis as a shorter side. The front and rear polarizing plates and the retarder film plate were peeled off a Type W32-L5000 IPS mode liquid crystal TV (produced by Hitachi Ltd.). The polarizing plates prepared in Example 1 and Comparative Example 1 were each then stuck to the front and back sides of the liquid crystal according the combination of configurations set forth in Table 12 to prepare liquid crystal display devices IPS-1 and IPS-R1. After the sticking of polarizing plate, these liquid crystal display devices were each then kept at 50° C. and 5 kg/cm² for 20 minutes to complete adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

The IPS mode liquid crystal display devices thus obtained were each evaluated for properties in the same manner as in Example 3 and Comparative Example 3. The combination of the liquid crystal display devices thus prepared with polarizing plates and the properties of the display devices are set forth in Table 12.

TABLE 12

| | Liquid | | | | 60° C.-90% | | | |
|---|---|---|---|---|---|---|---|---|
| | crystal | Viewing | | Backlight | RH × 200 hr | | 80° C. dry × 200 hr | |
| | display | side | Liquid | side | Degree | | Degree | |
| Example | device | polarizing | crystal | polarizing | of light | | of light | |
| No. | No. | plate No. | cell | plate No. | leakage | Exfoliated? | leakage | Exfoliated? |
| Example 6 | IPS-1 | F-24 | IPS | B-29 | 1 | No | 1 | No |
| Comp. Ex. 6 | IPS-R1 | FR-9 | IPS | BR-9 | 5 | Yes | 4 | Yes |

### Example 7 and Comparative Example 7

### Preparation of Polarizing Plate

(Preparation of Polarizer)

A polyvinyl alcohol (PVA) film having a thickness of 80 μm was dipped in an aqueous solution of iodine having an iodine concentration of 0.05% by mass at 30° C. for 60 seconds so that it was dyed, longitudinally stretched by a factor of 5 while being dipped in an aqueous solution of boric acid having a boric cid concentration of 4% by mass for 60 seconds, and then dried at 50° C. for 4 minutes to obtain a polarizing film having a thickness of 20 μm.

(Surface Treatment of Cellulose Acylate Film)

The protective films prepared in Production Examples 1 and 3 to 9 and the following commercially available cellulose acylate films were each dipped in a 55° C. 1.5 mol/l aqueous solution of sodium hydroxide, and then thoroughly washed with water to remove sodium hydroxide. Thereafter, these films were each dipped in a 35° C. 0.005 mol/l aqueous solution of diluted sulfuric acid for 1 minute, and then dipped in water to remove thoroughly the aqueous solution of diluted sulfuric acid. Finally, the sample was thoroughly dried at 120° C. The surface tensions were measured. The results are shown in the column of “After saponification” of Table 16.

### (Preparation of Polarizing Plate)

The protective films and commercially available cellulose acylate films thus saponified were each then laminated with a polyvinyl alcohol-based adhesive with the aforementioned polarizer interposed therebetween according to the combination set forth in Table 5 to obtain polarizing plates.

As the commercially available cellulose acylate films there were used Fujitac T40UZ, Fujitac T80UZ, Fujitac TF80UL, Fujitac TD80UL, Fujitac TDY80UL (produced by Fuji Photo Film Co., Ltd.) and KC80UVSFD (produced by Konica Minolta Opto Products Co., Ltd.).

During this procedure, the polarizer and the protective film on the both sides of the polarizer are continuously stuck to each other because they are in a rolled form and parallel to each other in the longitudinal direction. In the protective film (corresponding to TAC1) disposed on the cell side, as shown in FIG. 1, the transmission axis 2 of the polarizer 1 and the slow axis 4 of the cellulose acylate film 3 prepared in Example 1 are parallel to each other.

### (Spreading of Adhesive Layer Coating Solution)

The spreading of the adhesive layer coating solution over the polarizing plate was conducted as follows.

The adhesive 13 solution was spread over a PET film having a thickness of 25 μm using a die coater, and then dried. During this procedure, adjustment was made such that the thickness of the adhesive layer dried reached 25 μm. The adhesive layer formed on the PET film was transferred onto the polarizing plate in such an arrangement that the combination set forth in Table 13 was made. The adhesive layer was then ripened at 25° C. and 60% RH for 7 days. The adhesive layer 14 was ripened at 25° C. and 60% RH for 7 days and at 25° C. and 60% RH for 21 days (totaling one month) to prepare a polarizing plate sample. The sample which had been ripened for 1 month was further subjected to 80° C. for 500 hours to prepare a polarizing plate sample.

A separator film of PET was then stuck to the polarizing plate thus prepared on the adhesive layer side thereof. A protective film of PET was stuck to the side of the polarizing plate opposite the adhesive layer.

### Example 8

A commercially available cellulose acetate film which had been subjected to saponification in the same manner as in Example 7 was stuck to one side of the polarizer prepared in the same manner as in Example 7 with a polyvinyl alcohol-based adhesive. The film 19 prepared in Production Example 3 was stuck to the other side of the polarizer with an acrylic adhesive “DD624” (produced by NOGAWA CHEMICAL CO., LTD.) to prepare a polarizing plate on which an adhesive layer 13 was then formed in the same manner as in Example 7.

The configuration of the polarizing plates prepared in Examples 7 and 8 and Comparative Example 7 are set forth in Table 13.

TABLE 13

| | Viewing side polarizing plate | | | | | | Backlight side | |
|---|---|---|---|---|---|---|---|---|
| Liquid | Protective | | | | | | polarizing plate | |
| crystal | film | Protective | | Protective | | | | Protective |
| display | on side | film | | film 2 | | Liquid | | film 2 |
| device | opposite | 1 on cell | | on cell | | crystal | | on cell |
| No. | cell | side | Adhesive | side | Adhesive | cell | Adhesive | side |
| 1 | Film 24 | Film 1 | 13 | — | — | VA | — | — |
| 2 | Film 24 | Film 2 | 13 | — | — | VA | — | — |
| 3 | Film 25 | Film 3 | 13 | — | — | VA | — | — |
| 4 | Film 25 | Film 4 | 13 | — | — | VA | — | — |
| 5 | Film 24 | Film 5 | 13 | — | — | VA | — | — |
| 6 | Film 24 | Film 6 | 13 | — | — | VA | — | — |
| 7 | Film 24 | Film 7 | 13 | — | — | VA | — | — |
| 8 | Film 24 | Film 19 | 13 | — | — | VA | — | — |
| 9 | Film 24 | KC80UVSFD | 13 | — | — | VA | — | — |
| 10 | Film 24 | TD80UL | 13 | — | — | VA | — | — |
| 11 | Film 25 | TD80UL | 13 | — | — | VA | — | — |
| 12 | Film 25 | TF80UL | 13 | — | — | VA | — | — |
| 13 | Film 24 | TDY80UL | 13 | — | — | VA | — | — |
| 14 | Film 24 | TDY80UL | 13 | — | — | VA | — | — |
| 15 | Film 24 | TD80UL | 13 | — | — | VA | — | — |
| 16 | Film 24 | TD80UL | 13 | — | — | VA | — | — |
| 17 | Film 24 | TDY80UL | 13 | — | — | VA | — | — |
| 18 | Film 24 | Film 12 | 13 | — | — | VA | — | — |
| 19 | Film 24 | Film 16 | 13 | — | — | VA | — | — |
| 20 | Film 24 | TD80UL | 13 | — | — | VA | — | — |
| 21 | Film 24 | TD80UL | 13 | — | — | VA | — | — |
| 22 | Film 24 | Film 7 | 14 | — | — | VA | — | — |
| 23 | Film 24 | Film 7 | 14, 1 month | — | — | VA | — | — |
| | | | after spread | | | | | |
| 24 | Film 24 | Film 7 | 14, 80° C., 500 hr, | — | — | VA | — | — |
| | | | after 1 | | | | | |
| | | | month after | | | | | |
| | | | spread | | | | | |
| 25 | Film 24 | Film 7 | 15 | — | — | VA | — | — |
| 26 | Film 24 | Film 7 | 16 | — | — | VA | — | — |
| 27 | Film 24 | Film 7 | 17 | — | — | VA | — | — |
| 28 | Film 24 | TDY80UL | 14 | — | — | VA | — | — |
| 29 | Film 24 | TDY80UL | 14, 1 month | — | — | VA | — | — |
| | | | after spread | | | | | |
| 30 | Film 24 | TDY80UL | 14, 80° C., 500 hr, | — | — | VA | — | — |
| | | | after 1 | | | | | |
| | | | month after | | | | | |
| | | | spread | | | | | |
| 31 | Film 24 | TDY80UL | 15 | — | — | VA | — | — |
| 32 | Film 24 | TDY80UL | 16 | — | — | VA | — | — |
| 33 | Film 24 | TDY80UL | 17 | — | — | VA | — | — |
| 34 | Film 24 | Film 20 | 13 | — | — | OCB | — | — |
| 35 | Film 24 | Film 20 | 15 | — | — | OCB | — | — |
| 36 | Film 24 | Film 23 | 13 | — | — | TN | — | — |
| 37 | Film 24 | Film 23 | 15 | — | — | TN | — | — |
| 38 | Film 24 | Film 17 | 13 | — | — | IPS | — | — |
| 39 | Film 24 | Film 17 | 15 | — | — | IPS | — | — |
| 40 | Film 24 | TD80UL | 13 | Film | 1 | VA | 1 | Film |
| | | | | 19 | | | | 19 |

| | Backlight side | | | | | | | |
|---|---|---|---|---|---|---|---|---|
| | polarizing plate | | | 60 c.- | | | | |
| Liquid | | Protective | Protective | 90% RH × 200 hr | | 80 C. dry × 200 hr | | |
| crystal | | film | film | Degree | | Degree | | |
| display | | on | on side | of | | of | | |
| device | | cell | opposite | light | | light | | |
| No. | Adhesive | side | cell | leakage | Exfoliation | leakage | Exfoliation | Remarks |
| 1 | 13 | Film 1 | KC80UVSFD | 2 | No | 2 | No | Inventive |
| 2 | 13 | Film 2 | T80UZ | 2 | No | 2 | No | Inventive |
| 3 | 13 | Film 3 | TDY80UL | 2 | No | 2 | No | Inventive |
| 4 | 13 | Film 4 | T40UZ | 2 | No | 2 | No | Inventive |
| 5 | 13 | Film 5 | TF80UL | 1 | No | 1 | No | Inventive |
| 6 | 13 | Film 6 | TDY80UL | 1 | No | 1 | No | Inventive |
| 7 | 13 | Film 7 | TD80UL | 1 | No | 1 | No | Inventive |
| 8 | 13 | Film | TD80UL | 1 | No | 1 | No | Inventive |
| | | 19 | | | | | | |
| 9 | 13 | Film 8 | KC80UVSFD | 1 | No | 1 | No | Inventive |
| 10 | 13 | Film 9 | T80UZ | 1 | No | 1 | No | Inventive |
| 11 | 13 | Film | TDY80UL | 1 | No | 1 | No | Inventive |
| | | 10 | | | | | | |
| 12 | 13 | Film | T40UZ | 1 | No | 1 | No | Inventive |
| | | 11 | | | | | | |
| 13 | 13 | Film | Film 24 | 1 | No | 1 | No | Inventive |
| | | 12 | | | | | | |
| 14 | 13 | Film | Film 24 | 1 | No | 1 | No | Inventive |
| | | 13 | | | | | | |
| 15 | 13 | Film | Film 24 | 1 | No | 1 | No | Inventive |
| | | 14 | | | | | | |
| 16 | 13 | Film | Film 24 | 1 | No | 1 | No | Inventive |
| | | 15 | | | | | | |
| 17 | 13 | Film | Film 24 | 1 | No | 1 | No | Inventive |
| | | 16 | | | | | | |
| 18 | 13 | TDY80UL | Film 24 | 1 | No | 1 | No | Inventive |
| 19 | 13 | TDY80UL | Film 24 | 1 | No | 1 | No | Inventive |
| 20 | 13 | Film | Film 24 | 1 | No | 1 | No | Inventive |
| | | 21 | | | | | | |
| 21 | 13 | Film | Film 24 | 1 | No | 1 | No | Inventive |
| | | 22 | | | | | | |
| 22 | 14 | Film 7 | TD80UL | 1 | No | 1 | No | Inventive |
| 23 | 14, 1 month | Film 7 | TD80UL | 1 | No | 1 | No | Inventive |
| | after spread | | | | | | | |
| 24 | 14, 80° C., | Film 7 | TD80UL | 4 | Yes | 4 | Yes | Comparative |
| | 500 hr, | | | | | | | |
| | after 1 | | | | | | | |
| | month after | | | | | | | |
| | spread | | | | | | | |
| 25 | 15 | Film 7 | TD80UL | 5 | No | 5 | No | Comparative |
| 26 | 16 | Film 7 | TD80UL | 4 | Yes | 4 | Yes | Comparative |
| 27 | 17 | Film 7 | TD80UL | 5 | No | 5 | No | Comparative |
| 28 | 14 | Film | Film 24 | 1 | No | 1 | No | Comparative |
| | | 12 | | | | | | |
| 29 | 14, 1 month | Film | Film 24 | 1 | No | 1 | No | Comparative |
| | after spread | 12 | | | | | | |
| 30 | 14, 80° C., | Film | Film 24 | 3 | Yes | 3 | Yes | Comparative |
| | 500 hr, | 12 | | | | | | |
| | after 1 | | | | | | | |
| | month after | | | | | | | |
| | spread | | | | | | | |
| 31 | 15 | Film | Film 24 | 1 | No | 1 | No | Comparative |
| | | 12 | | | | | | |
| 32 | 16 | Film | Film 24 | 1 | No | 1 | No | Comparative |
| | | 12 | | | | | | |
| 33 | 17 | Film | Film 24 | 1 | No | 1 | No | Comparative |
| | | 12 | | | | | | |
| 34 | 13 | Film | TD80UL | 1 | No | 1 | No | Inventive |
| | | 20 | | | | | | |
| 35 | 15 | Film | TD80UL | 5 | Yes | 4 | Yes | Comparative |
| | | 20 | | | | | | |
| 36 | 13 | Film | TD80UL | 1 | No | 1 | No | Inventive |
| | | 23 | | | | | | |
| 37 | 15 | Film23 | TD80UL | 5 | Yes | 4 | Yes | Comparative |
| 38 | 13 | Film | TD80UL | 1 | No | 1 | No | Inventive |
| | | 17 | | | | | | |
| 39 | 15 | Film | TD80UL | 5 | Yes | 4 | Yes | Comparative |
| | | 17 | | | | | | |
| 40 | 13 | TD80UL | TD80UL | 1 | No | 1 | No | Inventive |

### [Measurement of Reflectance]

Using a spectrophotometer (produced by JASCO CO., LTD.), these polarizing plates were each measured for spectral reflectance on the functional layer side thereof at an incidence angle of 50 and a wavelength of from 380 to 780 nm to determine an integrating sphere average reflectance at 450 to 650 nm. As a result, the polarizing plate comprising the protective film 24 with anti-reflection layer exhibited an integrating sphere average reflectance of 2.3%. The polarizing plate comprising the protective film 25 with anti-reflection layer exhibited an integrating sphere average reflectance of 0.4%. For the measurement of reflectance, the protective film was peeled off the protective film with anti-reflection layer.

### Example 9 and Comparative Example 9

### (1) Mounting on VA Panel

The polarizing plates prepared in Examples 7 and 8 and Comparative Example 7 were each punched into a rectangle such that the viewing side polarizing plate has a 26″ wide size and a polarizer absorption axis as a longer side and the backlight side polarizing plate has a polarizer absorption axis as a shorter side. The front and rear polarizing plates and the retarder film plate were peeled off a Type KDL-L26HVX VA mode liquid crystal TV (produced by Sony Corporation). The polarizing plates prepared in Examples 7 and 8 and Comparative Example 7 were each then stuck to the front and back sides of the liquid crystal according to combination of configurations set forth in Table 13 to prepare liquid crystal display devices 1 to 33. After the sticking of polarizing plate, these liquid crystal display devices were each then kept at 50° C. and 5 kg/cm² for 20 minutes to cause adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

### [Light Leakage and Polarizing Plate Exfoliation by Durability Test]

The liquid crystal display devices prepared in Example 9 and Comparative Example 9 were each subjected to durability test under the following two conditions.

(1) The liquid crystal display device was kept in an atmosphere of 60° C. and 90% RH for 200 hours, and then withdrawn in an atmosphere of 25° C. and 60% RH. 24 hours after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 13.

(2) The liquid crystal display device was kept in a dry atmosphere of 80° C. for 200 hours, and then withdrawn in an atmosphere of 25° C. and 60% RH. One hour after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 13.

The evaluation of light leakage was conducted according to the following criterion.

| Conditions | | Degree of light |
|---|---|---|
| of light leakage | Practical problem | leakage |
| No light leakage | None | 1 |
| Very weak | None | 2 |
| Weak | None | 3 |
| Strong | Some | 4 |
| Very strong | Some | 5 |

The combination of the VA mode liquid crystal display devices thus prepared with polarizing plates and the properties of the liquid crystal display devices are set forth in Table 13.

### Example 10 and Comparative Example 10

### (2) Mounting on OCB Panel

A polyimide layer was provided as an alignment layer on a glass substrate with ITO electrode. The alignment layer was subjected to rubbing. Two sheets of the glass substrates thus obtained were laminated on each other in such an arrangement that the rubbing direction of the two sheets are parallel to each other. The cell gap was predetermined to be 5.7 μm. Into the cell gap was then injected a liquid crystal compound having Δn of 0.1396 “ZLI1132” (produced by Melc Co., Ltd.) to prepare a cell. The rubbing direction of the cell was disposed at an angle of 45° with respect to the horizontal direction on the screen of the cell substrate.

The polarizing plates prepared in Example 7 and Comparative Example 7 were each punched into a 23″ wide rectangle such that the longer side of the viewing side polarizing plate is parallel to the longer side of the polarizing plate thus punched and the shorter side of the polarizing plate thus punched is parallel to the absorption axis. Two sheets of the polarizing plates were then laminated with OCB interposed therebetween. The arrangement was made such that the optically anisotropic layer of the polarizing plate is opposed to the cell substrate and the rubbing direction of the liquid crystal cell and the rubbing direction of the optically anisotropic layer opposed to the liquid crystal cell are not parallel to each other to prepare liquid crystal display devices 33 and 34. After the sticking of polarizing plate, the laminate was kept at 50° C. and a load of 5 kg/cm² for 20 minutes to complete adhesion.

The liquid crystal display device thus prepared was disposed on the backlight. A white display voltage of 2 V and a black display voltage of 4.5 V were then applied to the liquid crystal cell. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

The OCB mode liquid crystal display devices thus obtained were each evaluated for properties in the same manner as in Example 9 and Comparative Example 9. The combination of the liquid crystal display devices thus prepared with polarizing plates and the properties of the display devices are set forth in Table 13.

### Example 11 and Comparative Example 11

### (3) Mounting on TN Panel

A polyimide layer was provided as an alignment layer on a glass substrate with ITO electrode. The alignment layer was subjected to rubbing. Two sheets of the glass substrates thus obtained were laminated on each other in such an arrangement that the rubbing direction of the two sheets are perpendicular to each other. The cell gap was predetermined to be 4.9 pun. Into the cell gap was then injected a liquid crystal compound having Δn of 0.075 and a positive dielectric anisotropy and a chiral agent to prepare a cell. The rubbing direction of the cell was disposed downward from the top of the screen on the backlight side and leftward from the right of the screen on the viewing side.

The polarizing plates prepared in Example 8 and Comparative Example 8 were each punched into a rectangle having a size of 19″ wide such that the shorter side of the viewing side polarizing plate is parallel to the longer side of the polarizing plate thus punched and the longer side of the viewing side polarizing plate thus punched is parallel to the absorption axis. Two sheets of the polarizing plates thus prepared were then laminated with the TN cell interposed therebetween. The arrangement was made such that the optically anisotropic layer of the polarizing plate is opposed to the cell substrate and the rubbing direction of the liquid crystal cell and the rubbing direction of the optically anisotropic layer opposed to the liquid crystal cell are not parallel to each other to prepare liquid crystal display devices 36 and 37. After the sticking of polarizing plate, the laminate was kept at 50° C. and a load of 5 kg/cm² for 20 minutes to complete adhesion.

The liquid crystal display device thus prepared was disposed on the backlight. A white display voltage of 1 V and a black display voltage of 4.5 V were then applied to the liquid crystal cell. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in both the horizontal direction on the screen and vertical direction on the screen.

The TN mode liquid crystal display devices thus obtained were each evaluated for properties in the same manner as in Example 9 and Comparative Example 9. The combination of the liquid crystal display devices thus prepared with polarizing plates and the properties of the display devices are set forth in Table 13.

### Example 12 and Comparative Example 12

### (4) Mounting on IPS Panel

The polarizing plates prepared in Example 8 and Comparative Example 8 were each punched into a rectangle such that the viewing side polarizing plate has a 32″ wide size and a polarizer absorption axis as a longer side and the backlight side polarizing plate has a polarizer absorption axis as a shorter side. The front and rear polarizing plates and the retarder film plate were peeled off a Type W32-L5000 IPS mode liquid crystal TV (produced by Hitachi Ltd.). The polarizing plates prepared in Example 1 and Comparative Example 1 were each then stuck to the front and back sides of the liquid crystal according the combination of configurations set forth in Table 13 to prepare liquid crystal display devices 38 and 39. After the sticking of polarizing plate, these liquid crystal display devices were each then kept at 50° C. and 5 kg/cm² for 20 minutes to complete adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

The IPS mode liquid crystal display devices thus obtained were each evaluated for properties in the same manner as in Example 9 and Comparative Example 9. The combination of the liquid crystal display devices thus prepared with polarizing plates and the properties of the display devices are set forth in Table 13.

### Example 13

### Preparation of Polarizing Plate

### (Preparation of Polarizer)

A polyvinyl alcohol (PVA) film having a thickness of 80 μm was dipped in an aqueous solution of iodine having an iodine concentration of 0.05% by mass at 30° C. for 60 seconds so that it was dyed, longitudinally stretched by a factor of 5 while being dipped in an aqueous solution of boric acid having a boric cid concentration of 4% by mass for 60 seconds, and then dried at 50° C. for 4 minutes to obtain a polarizing film having a thickness of 20 μm.

### (Surface Treatment of Cellulose Acylate Film)

The protective films prepared in Production Example 8 and a Type Fujitac TD80UL commercially available cellulose acylate film were each dipped in a 55° C. 1.5 moil aqueous solution of sodium hydroxide, and then thoroughly washed with water to remove sodium hydroxide. Thereafter, these films were each dipped in a 35° C. 0.005 mol/l aqueous solution of diluted sulfuric acid for 1 minute, and then dipped in water to remove thoroughly the aqueous solution of diluted sulfuric acid. Finally, the sample was thoroughly dried at 120° C.

### (Preparation of Polarizing Plate)

The protective films and commercially available cellulose acylate film thus saponified were each then laminated with a polyvinyl alcohol-based adhesive with the aforementioned polarizer interposed therebetween according to the combination set forth in Table 13 to obtain polarizing plates.

During this procedure, the polarizer and the protective film on the both sides of the polarizer are continuously stuck to each other because they are in a rolled form and parallel to each other in the longitudinal direction.

### (Spreading of Adhesive Layer Coating Solution)

The spreading of the adhesive layer coating solution over the polarizing plate was conducted as follows.

The adhesive 13 solution was spread over a PET film having a thickness of 25 μM using a die coater, and then dried. During this procedure, adjustment was made such that the thickness of the adhesive layer dried reached 25 am. The adhesive layer formed on the PET film was transferred onto the polarizing plate thus prepared.

On the polarizing plate thus prepared was continuously laminated the film 19 prepared in Production Example 3 in such an arrangement that the transmission axis of the polarizing plate and the slow axis of the film 19 are parallel to each other. Further, the adhesive 13 solution was spread over a PET film having a thickness of 25 μm using a die coater, and then dried. During this procedure, adjustment was made such that the thickness of the adhesive layer dried reached 25 μm. The adhesive layer formed on the PET film was transferred onto the polarizing plate thus prepared, and then ripened at 25° C. and 60% RH for 7 days.

A separator film of PET was then stuck to the polarizing plate thus prepared on the adhesive layer side thereof. A protective film of PET was stuck to the side of the polarizing plate opposite the adhesive layer.

### (1) Mounting on VA Panel

The polarizing plate prepared in Example 13 was punched into a rectangle such that the viewing side polarizing plate has a 26″ wide size and a polarizer absorption axis as a longer side and the backlight side polarizing plate has a polarizer absorption axis as a shorter side. The front and rear polarizing plates and the retarder film plate were peeled off a Type KDL-L26HVX VA mode liquid crystal TV (produced by Sony Corporation). The polarizing plate prepared in Example 13 was then stuck to the front and back sides of the liquid crystal according to combination of configurations set forth in Table 13 to prepare a liquid crystal display device 40. After the sticking of polarizing plate, these liquid crystal display devices were each then kept at 50° C. and 5 kg/cm² for 20 minutes to cause adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

### [Light Leakage and Polarizing Plate Exfoliation by Durability Test]

The liquid crystal display device prepared in Example 13 was subjected to durability test under the following two conditions.

(1) The liquid crystal display device was kept in an atmosphere of 60° C. and 90% RH for 200 hours, and then withdrawn in an atmosphere of 25° C. and 60% RH. 24 hours after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 13.

(2) The liquid crystal display device was kept in a dry atmosphere of 80° C. for 200 hours, and then withdrawn in an atmosphere of 25° C. and 60% RH. One hour after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 13.

### Example 14

### (1) Mounting on VA Panel

The same polarizing plate as used in the liquid crystal display device 17 prepared in Example 9 was punched into a rectangle such that the viewing side polarizing plate has a 46″ wide size and a polarizer absorption axis as a longer side and the backlight side polarizing plate has a polarizer absorption axis as a shorter side. The front and rear polarizing plates and the retarder film plate were peeled off the liquid crystal panel of a Type LT46G 15W liquid crystal TV (produced by Samsung Corporation; backlight source: cold cathode ray tube [CCFL]). The aforementioned polarizing plate was then stuck to the front and back sides of the liquid crystal according to combination of configurations set forth in Table 14 to prepare a liquid crystal display device 41.

The front and rear polarizing plates and retardar film plate were peeled off the liquid crystal panel of the aforementioned Type LT46G15W liquid crystal TV (produced by Samsung Corporation). The aforementioned polarizing plate was then stuck to the front and back sides of the liquid crystal according to combination of configurations set forth in Table 14 to prepare another liquid crystal panel from which a Type QUALIA005 KDX-46Q005 liquid crystal display device 42 (produced by Sony Corporation; backlight source: LED) was then prepared.

The surface temperature of the backlight with the liquid crystal panel detached therefrom was 45° C. for the liquid crystal display device 41 and 35° C. for the liquid crystal display device 42.

After the sticking of the polarizing plate, the two liquid crystal display devices 41 and 42 were each then kept at 50° C. and 5 kg/cm² for 20 minutes to complete adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

### [Light Leakage and Polarizing Plate Exfoliation by Durability Test]

The liquid crystal display device prepared in Example 14 was subjected to durability test under the following two conditions.

(1) The liquid crystal display device was kept in an atmosphere of 60° C. and 90% RH for 200 hours, and then withdrawn in an atmosphere of 25° C. and 60% RH. 24 hours after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 14.

(2) The liquid crystal display device was kept in a dry atmosphere of 80° C. for 200 hours, and then withdrawn in an atmosphere of 25° C. and 60% RH. One hour after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 14.

TABLE 14

| Liquid | | | | | | | | | 60 C.-90% | | 80° C. dry × | | |
|---|---|---|---|---|---|---|---|---|---|---|---|---|---|
| crystal | Viewing side polarizing plate | | | | Backlight side polarizing plate | | | | RH × 200 hr | | 200 hr | | |
| display | Protective | Protective | | Liquid | | Protective | Protective | | | Exfo- | | Exfo- | |
| device | film on side | film 1 on | | crystal | | film on | film on side | Back- | Light | lia- | Light | lia- | |
| No. | opposite cell | cell side | Adhesive | cell | Adhesive | cell side | opposite cell | light | leakage | tion | leakage | tion | Remarks |
| 41 | Film 24 | TDY80UL | Adhesive | VA | Adhesive | Film 16 | Film 24 | CCFL | 2 | No | 2 | No | Inventive |
| | | | 13 | | 13 | | | | | | | | |
| 42 | Film 24 | TDY80UL | Adhesive | VA | Adhesive | Film 16 | Film 24 | LED | 1 | No | 1 | No | Inventive |
| | | | 13 | | 13 | | | | | | | | |

| | | |
|---|---|---|
| Degree of | Conditions of light | Practical |
| light leakage | leakage | problem |
| 1 | No light leakage | None |
| 2 | Very weak | None |
| 3 | Weak | None |
| 4 | Strong | Some |
| 5 | Very strong | Some |

### Example 15

### Preparation of Polarizing Plate

### (Preparation of Polarizer)

The polyvinyl alchohole (PVA) film having a thickness of 80 μm was immersed and stained in iodine solution having an iodine concentration of 0.05 mass % at 30° C. for 60 seconds. Next, the film was stretched in 5 times longer than the original length in a longitudinal direction during the film being immersed in a boric acid solution having an boric acid concentration of 4 mass % for 60 seconds. After that, the film was dried at 50° C. for 4 minutes, and then the polarizer having a thickness of 20 μm was obtained.

### (Surface Treatment of Cellulose Acylate Film)

The protective film produced in production Example 8 and a commercially available cellulose acylate film Fujitac were immersed in sodium hydrate solution having a concentration of 1.5 mol/L at 55° C., and then rinsed with water to wash out sodium hydrate well. After that, the films were immersed in diluted sulfuric acid having a concentration of 0.005 mol/L at 35° C. for 1 minute, and then rinsed with water to wash out diluted sulfuric acid well. Finally, the samples were dried well at 120° C.

Further, after sticking the protective film SAT-106T (produced by SUN A KAKEN CO., LTD.) on the whole surface of one side of each of the protective films produced in the production Example 1 and 2, the obtained samples were immersed in sodium hydrate solution having a concentration of 1.5 mol/L at 55° C., and then rinsed with water to wash out sodium hydrate well. After that, the samples were immersed in diluted sulfuric acid having a concentration of 0.005 mol/L at 35° C. for 1 minute, and then rinsed with water to wash out diluted sulfuric acid well. Finally, the samples were dried well at 120° C. After finishing the drying, the protective film SAT-106T was peeled. During the above operations, the side where the protective film SAT-106T was stuck on was not affected by sodium hydrate solution, nor saponified. The surface tensions were measured. The results are shown in the column of “Befor saponification” of Table 16.

To examine the difference of the surface tensions of the saponified surface and the unsaponified surface of the film, the surface tension of the other films used in Examples before and after the saponification were measured, respectively. The results are shown in the columns of “Befor saponification” and “After saponification” of Table 16.

### (Preparation of Polarizing Plate)

The saponification treated protective film and commercially available cellulose acylate film were each stuck with the above polarizer as the film sandwiches the above polarizer with the combinations shown in Table 15 using polyvinyl alcohol adhesive, so as to produce a polarizing plate. In this time, in the protective films produced in production Example 1 and 2, the polarizing plate was produced in which the surface where the protective film SAT-106T was not stuck on during the saponification treatment was placed to the polarizer side. Namely, thus produced polarizing plate has protective film surfaces in which both sides of the polarizing plate were not saponified.

During this, since the polarizer and the protective films on both sides of the polarizer were produced in roll forms, the longitudinal directions of the roll films were parallel in each other, thus can be continuously stuck with each other.

### (Coating of Adhesive Layer)

The coating of adhesive layer on polarizing plate was conducted as follows.

The solution of adhesive 13 or 14 is coated on PET film having a thickness of 25 μm with dye coater, and then dried. During this coating, the coating was adjusted to be the thickness of the adhesive layer after drying of 25 μm. Further, the adhesive layer coated on the PET film was transferred to the above produced polarizing plate. After transferring the adhesive layer, the PET film was peeled, and then the surface tension of the adhesive layer was measured. The results are shown in Table 16.

### (1) Mounting on VA Panel

The polarizing plates prepared in Example 15 were each punched into a rectangle such that the viewing side polarizing plate has a 26″ wide size and a polarizer absorption axis as a longer side and the backlight side polarizing plate has a polarizer absorption axis as a shorter side. The front and rear polarizing plates and the retarder film plate were peeled off a Type KDL-L26RX2 VA mode liquid crystal TV (produced by Sony Corporation). The polarizing plates prepared in Example 15 were each then stuck to the front and back sides of the liquid crystal according to combination of configurations set forth in Table 15 to prepare liquid crystal display device 40. After the sticking of polarizing plate, these liquid crystal display devices were each then kept at 50° C. and 5 kg/cm² for 20 minutes to cause adhesion. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The protective film was then peeled off the polarizing plates. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

### [Light Leakage and Polarizing Plate Exfoliation by Durability Test]

The liquid crystal display device prepared in Example 15 was subjected to durability test under the following two conditions.

(1) The liquid crystal display device was kept in an atmosphere of 60° C. and 90% RH for 200 hours, and then withdrawn in an atmosphere of 25° C. and 60% RH. 24 hours after, the liquid crystal display device was allowed to perform black display. During the performance, the liquid crystal display device was evaluated for the degree of light leakage and the occurrence of exfoliation of the polarizing plate from the liquid crystal panel. The results are set forth in Table 15.

(2) The liquid crystal display device was kept in a dry atmosphere of 80° C. for 200 hours, and then withdrawn in an atmosphere of 25° C. and 60% RH. One hour after, the liquid crystal display device was allowed to perform black display. During the performance, the liquid crystal display device was evaluated for the degree of light leakage and the occurrence of exfoliation of the polarizing plate from the liquid crystal panel. The results are shown in Table 15.

TABLE 15

| | Viewing side polarizing plate | | | | | | | | | | | |
|---|---|---|---|---|---|---|---|---|---|---|---|---|
| | Protec- | | | | | | | | | | | |
| Liquid | tive | | | | | | | 60 c.-90% | | 80 C. | | |
| crystal | film | | | | Backlight side polarizing plate | | | RH × 200 hr | | dry × 200 hr | | |
| display | on side | Protective | | Liquid | | Protective | Protective film | Degree | | Degree | | |
| device | opposite | film on cell | Adhe- | crystal | Adhe- | film on | on side | of light | | of light | Exfo- | |
| No. | cell | side | sive | cell | sive | cell side | opposite cell | leakage | Exfoliation | leakage | liation | Remarks |
| 41 | Film 24 | Film 1 | 13 | VA | 13 | Film 1 | KC80UVSFD | 2 | Yes | 2 | Yes | Comparative |
| 42 | Film 24 | Film 2 | 13 | VA | 13 | Film 2 | T80UZ | 2 | Yes | 2 | Yes | Comparative |
| 43 | Film 25 | Film 3 | 13 | VA | 13 | Film 3 | TDY80UL | 2 | Yes | 2 | Yes | Comparative |
| 44 | Film 25 | Film 4 | 13 | VA | 13 | Film 4 | T40UZ | 2 | Yes | 2 | Yes | Comparative |
| 45 | Film 24 | Film 5 | 13 | VA | 13 | Film 5 | TF80UL | 1 | Yes | 1 | Yes | Comparative |
| 46 | Film 24 | Film 6 | 13 | VA | 13 | Film 6 | TDY80UL | 1 | Yes | 1 | Yes | Comparative |
| 47 | Film 24 | Film 7 | 13 | VA | 13 | Film 7 | TD80UL | 1 | Yes | 1 | Yes | Comparative |
| 48 | Film 24 | Film 19 | 13 | VA | 13 | Film 19 | TD80UL | 1 | Yes | 1 | Yes | Comparative |
| 49 | Film 24 | KC80UVSFD | 13 | VA | 13 | Film 8 | KC80UVSFD | 1 | Yes | 1 | Yes | Comparative |
| 50 | Film 24 | TD80UL | 13 | VA | 13 | Film 9 | T80UZ | 1 | Yes | 1 | Yes | Comparative |
| 51 | Film 25 | TD80UL | 13 | VA | 13 | Film 10 | TDY80UL | 1 | Yes | 1 | Yes | Comparative |
| 52 | Film 25 | TF80UL | 13 | VA | 13 | Film 11 | T40UZ | 1 | Yes | 1 | Yes | Comparative |
| 53 | Film 24 | TDY80UL | 13 | VA | 13 | Film 12 | Film 24 | 1 | Yes | 1 | Yes | Comparative |
| 54 | Film 24 | TDY80UL | 13 | VA | 13 | Film 13 | Film 24 | 1 | Yes | 1 | Yes | Comparative |
| 55 | Film 24 | TD80UL | 13 | VA | 13 | Film 14 | Film 24 | 1 | Yes | 1 | Yes | Comparative |
| 56 | Film 24 | TD80UL | 13 | VA | 13 | Film 15 | Film 24 | 1 | Yes | 1 | Yes | Comparative |
| 57 | Film 24 | TDY80UL | 13 | VA | 13 | Film 16 | Film 24 | 1 | Yes | 1 | Yes | Comparative |
| 58 | Film 24 | Film 12 | 13 | VA | 13 | TDY80UL | Film 24 | 1 | Yes | 1 | Yes | Comparative |
| 59 | Film 24 | Film 16 | 13 | VA | 13 | TDY80UL | Film 24 | 1 | Yes | 1 | Yes | Comparative |
| 60 | Film 24 | TD80UL | 13 | VA | 13 | Film 21 | Film 24 | 1 | Yes | 1 | Yes | Comparative |
| 61 | Film 24 | TD80UL | 13 | VA | 13 | Film 22 | Film 24 | 1 | Yes | 1 | Yes | Comparative |
| 62 | Film 24 | Film 7 | 14 | VA | 14 | Film 7 | TD80UL | 1 | Yes | 1 | Yes | Comparative |

TABLE 16

| | Before saponification | | | After saponification | | |
|---|---|---|---|---|---|---|
| | | Dispersion force | | | Dispersion force | Polarity component |
| | Surface tension γ | component γ^{d} | Polarity component γ^{p} | Surface tension γ | component γ^{d} | γ^{p} |
| | (mN/m) | (mN/m) | (mN/m) | (mN/m) | (mN/m) | (mN/m) |
| Film 1 | 48.4 | 31.2 | 17.2 | 67.5 | 31.0 | 36.5 |
| Film 2 | 48.9 | 32.1 | 16.8 | 67.3 | 31.8 | 35.5 |
| Film 3 | 45.6 | 33.3 | 12.3 | 66 | 32.8 | 33.2 |
| Film 4 | 49.3 | 35.1 | 14.2 | 66.9 | 34.8 | 32.1 |
| Film 5 | 49.2 | 32.1 | 17.1 | 68.2 | 31.9 | 36.3 |
| Film 6 | 48.7 | 32.4 | 16.3 | 67.6 | 32.3 | 35.3 |
| Film 7 | 49.0 | 32.5 | 16.5 | 67.9 | 32.3 | 35.6 |
| Film 8 | 48.4 | 31.2 | 17.2 | 67.4 | 31.1 | 36.3 |
| Film 9 | 48.9 | 32.1 | 16.8 | 67.1 | 31.9 | 35.2 |
| Film 10 | 45.6 | 33.3 | 12.3 | 66.0 | 33.0 | 33 |
| Film 11 | 49.3 | 35.1 | 14.2 | 66.7 | 34.7 | 32 |
| Film 12 | 49.2 | 32.1 | 17.1 | 67.6 | 31.8 | 35.8 |
| Film 13 | 48.7 | 32.4 | 16.3 | 67.4 | 32.3 | 35.1 |
| Film 14 | 49.0 | 32.5 | 16.5 | 67.9 | 32.4 | 35.5 |
| Film 15 | 49.2 | 32.1 | 17.1 | 66.3 | 31.8 | 34.5 |
| Film 16 | 49.4 | 33.5 | 15.9 | 68.3 | 33.2 | 35.1 |
| KC80UVSFD | 47.0 | 33.0 | 14.0 | 68.6 | 32.5 | 36.1 |
| TD80UL | 48.2 | 32.6 | 15.6 | 69.9 | 32.4 | 37.5 |
| TDY80UL | 48.4 | 33.1 | 15.3 | 71.7 | 32.9 | 38.8 |
| TF80UL | 47.8 | 33.5 | 14.3 | 70.0 | 33.2 | 36.8 |
| Adhesive 13 | 37.0 | 30.6 | 6.4 | — | — | — |
| Adhesive 14 | 39.2 | 32.2 | 7.0 | — | — | — |

### INDUSTRIAL APPLICABILITY

The polarizing plate and liquid crystal display device of the invention show little light leakage at the periphery of black-and-white screen due to change of humidity and temperature or during continuous lighting of liquid crystal display device. Further, a polarizing plate having a high optical compensation function can be obtained. Moreover, an excellent viewing angle compensating effect can be exerted.

The entire disclosure of each and every foreign patent application from which the benefit of foreign priority has been claimed in the present application is incorporated herein by reference, as if fully set forth.

1. A polarizing plate comprising:
a polarizer; and
at least two protective films provided on both sides of the polarizer,
wherein the polarizing plate has an adhesive layer provided on at least one side of the polarizing plate, and
wherein the adhesive layer is formed by spreading an adhesive comprising a (meth)acrylic copolymer composition comprising:
(A) 100 parts by mass of a copolymer comprising:
(a₁) a (meth)acrylic acid ester monomer having Tg of less than −30° C. in a form of homopolymer in a mass proportion of 75% by mass or more as calculated in terms of monomer unit;
(a₂) a vinyl group-containing compound having Tg of −30° C. or more in a form of homopolymer in a mass proportion of 25% by mass or less as calculated in terms of monomer unit; and
(a₃) a functional group-containing monomer reactive with a polyfunctional compound (B) in an amount of 10 parts by mass or less based on 100 parts by mass of a sum of the mass of the monomer (a₁) and the compound (a₂); and
(B) from 0.005 to 5 parts by mass of a polyfunctional compound having at least two functional groups in a molecule, and the at least two functional groups can react with a functional group in the functional group-containing monomer (a₃) to form a crosslinked structure, and
wherein a gel fraction of the adhesive is from not smaller than 40% by mass to not greater than 90% by mass.

2. A polarizing plate comprising:
a polarizer; and
at least two protective films provided on both sides of the polarizer,
wherein the polarizing plate has an adhesive layer provided on at least one side of the polarizing plate, and
wherein the adhesive layer is formed by spreading an adhesive comprising a (meth)acrylic copolymer composition comprising:
(A₁) 100 parts by mass of a copolymer having a mass-average molecular mass of 1,000,000 or more comprising:
(a₁₁) a (meth)acrylic acid ester monomer having Tg of less than −30° C. in a form of homopolymer in a mass proportion of 75% by mass or more as calculated in terms of monomer unit;
(a₁₂) a vinyl group-containing compound having Tg of −30° C. or more in a form of homopolymer in a mass proportion of 25% by mass or less as calculated in terms of monomer unit; and
(a₁₃) a functional group-containing monomer reactive with a polyfunctional compound (B) in an amount of 10 parts by mass or less based on 100 parts by mass of a sum of the mass of the monomer (a₁₁) and the compound (a₁₂); and
(A₂) from 20 to 200 parts by mass of a copolymer having a mass-average molecular mass of 100,000 or less comprising:
(a₂₁) a (meth)acrylic acid ester monomer having Tg of less than −30° C. in a form of homopolymer in a mass proportion of 75% by mass or more as calculated in terms of monomer unit;
(a₂₂) a vinyl group-containing compound having Tg of −30° C. or more in a form of homopolymer in a mass proportion of 25% by mass or less as calculated in terms of monomer unit; and
(a₂₃) a functional group-containing monomer reactive with a polyfunctional compound (B) in an amount of 10 parts by mass or less based on 100 parts by mass of a sum of the mass of the monomer (a₂₁) and the compound (a₂₂); and
(B) from 0.005 to 5 parts by mass of a polyfunctional compound having at least two functional groups in a molecule, and the at least two functional groups can react with a functional group in the functional group-containing monomers (a₁₃) and (a₂₃) to form a crosslinked structure, and
wherein a gel fraction of the adhesive is from not smaller than 40% by mass to not greater than 90% by mass, and
wherein an amount of repeating units derived from the functional group-containing monomers (a₁₃) and (a₂₃) incorporated in the (meth)acrylic copolymers (A₁) and (A₂), respectively, satisfies a percent functional group distribution range of from 0 to 15% by mass defined by numerical formula (1):
Percent functional group distribution=[mass of repeating units derived from functional group-containing monomer (a₂₃) in (meth)acrylic copolymer (A₂)/mass of repeating units derived from functional group-containing monomer (a₁₃) in (meth)acrylic copolymer (A₁)]×100 (1)

3. The polarizing plate according to claim 1,
wherein the (meth)acrylic copolymer A has a glass transition temperature of 0° C. or less.

4. The polarizing plate according to any of claim 1,
wherein the adhesive layer exhibits a creep of less than 70 μm when subjected to a load of 200 g in a 50° C. atmosphere for 1 hour while being stuck to an alkali-free glass sheet at an area of 10 mm width and 10 mm length.

5. The polarizing plate according to claim 1,
wherein the adhesive layer exhibits a creep of less than 40 μm when subjected to a load of 200 g in a 50° C. atmosphere for 1 hour while being stuck to an alkali-free glass sheet at an area of 10 mm width and 10 mm length.

6. The polarizing plate according to claim 1,
wherein the adhesive layer exhibits a 90° peel adhesion of 10 N/25 mm width or more with respect to an alkali-free glass sheet in a 25° C. atmosphere.

7. The polarizing plate according to claim 1,
wherein the adhesive layer exhibits a 90° peel adhesion of 10 N/25 mm width or more with respect to an alkali-free glass sheet at any measuring temperature between 0° C. and 90° C. after processed in a 70° C. atmosphere for 5 hours.

8. The polarizing plate according to claim 1,
wherein the adhesive layer has an elastic modulus of 0.08 MPa or more.

9. The polarizing plate according to claim 1,
wherein the adhesive layer has an elastic modulus of 0.06 MPa or more at 90° C.

10. The polarizing plate according to claim 1,
wherein the adhesive layer has a shear modulus of from 0.1 GPa to 100 GPa.

11. The polarizing plate according to claim 1,
wherein a gel fraction of the adhesive is from not smaller than 60% by mass to not greater than 90% by mass.

12. The polarizing plate according to claim 1,
wherein the adhesive layer has a thickness of from 5 μm to 30 μm.

13. The polarizing plate according to claim 1,
wherein the adhesive has a surface tension of γ_{A} and a polarity component of γ_{A}^{p} satisfying numerical formulae (20) to (23), and at least one of the at least two protective films has a surface tension of γ_{F} and a polarity component of γ_{F}^{p} satisfying numerical formulae (20) to (23),
30≦γ_{A}≦45 (20)
5≦γ_{A}^{P}≦15 (21)
50≦γ_{F}≦75 (22)
20≦γ_{F}^{P}≦45 (23)
wherein each of γ_{A}, γ_{A}^{p}, γ_{F} and γ_{F}^{p} has a unit of mN/m.

14. The polarizing plate according to claim 1,
wherein at least one of the at least two protective films has a front retardation value Reλ and a thickness direction retardation value Rthλ satisfying numerical formulae (2) and (3):
0 nm≦Re₅₉₀≦200 nm (2)
0 nm≦Rth₅₉₀≦400 nm (3)
wherein each of Re₅₉₀ and Rth₅₉₀ is a value at a wavelength λ of 590 nm, and has a unit of nm.

15. The polarizing plate according to claim 1,
wherein at least one of the at least two protective films is a cellulose acylate film comprising, as a main polymer component, a cellulose acylate which is a mixed aliphatic acid ester of cellulose in which a hydroxyl group of cellulose is substituted by an acetyl group and an acyl group having 3 or more carbon atoms, and
wherein a degree A of substitution of the cellulose acylate by the acetyl group and a degree B of substitution of the cellulose acylate by the acyl group having 3 or more carbon atoms satisfy numerical formulae (4) and (5):
2.0≦A+B≦3.0 (4)
0<B (5)

16. The polarizing plate according to claim 15,
wherein the acyl group having 3 or more carbon atoms is a propionyl group or butanoyl group.

17. The polarizing plate according to claim 15,
wherein a degree of substitution of 6-position hydroxyl group in the cellulose is 0.75 or more.

18. The polarizing plate according to claim 1,
wherein at least one of the at least two protective films is a film comprising a cellulose acylate obtained by substituting a hydroxyl group in a glucose unit constituting the cellulose by an acyl group having two or more carbon atoms, and
wherein supposing that degrees of substitution of a 2-position hydroxyl group, a 3-position hydroxyl group and a 6-position hydroxyl group in the glucose unit constituting the cellulose by the acyl group having two or more carbon atoms are DS₂, DS₃ and DS₆, respectively, the degrees satisfy numerical formulae (6) and (7):
2.0≦DS₂+DS₃+DS₆≦3.0 (6)
DS₆/(DS₂+DS₃+DS₆)≧0.315 (7)

19. The polarizing plate according to claim 18,
wherein the acyl group is an acetyl group.

20. The polarizing plate according to claim 1,
wherein at least one of the at least two protective films comprises at least one retardation developer which is a rod-like compound or a disc-shaped compound.

21. The polarizing plate according to claim 1,
wherein at least one of the at least two protective films is a cycloolefin-based polymer.

22. The polarizing plate according to ax claim 1,
wherein at least one of the at least two protective films has a front retardation value Reλ and a thickness direction retardation value Rthλ satisfying numerical formulae (8) to (11):
0≦|Re₅₉₀|≦10 (8)

|Rth₅₉₀|≦25 (9)

|Re₄₀₀−Re₇₀₀|≦10 (10)

|Rth₄₀₀−Rth₇₀₀|≦35 (11)
wherein each of Re₅₉₀ and Rth₅₉₀ is a value at a wavelength λ of 590 nm, and has a unit of nm;
each of Re₄₀₀ and Rth₄₀₀ is a value at a wavelength λ of 400 nm, and has a unit of nm; and
each of Re₇₀₀ and Rth₇₀₀ is a value at a wavelength λ of 700 nm, and has a unit of nm.

23. The polarizing plate according to claim 22,
wherein at least one of the at least two protective films comprises:
a cellulose acylate film having an acyl substitution degree of from 2.85 to 3.00; and
at least one compound for lowering Reλ and Rthλ in an amount of from 0.01 to 30% by mass based on a solid content of the cellulose acylate.

24. The polarizing plate according to claim 1,
wherein an optically anisotropic layer is provided on at least one of the at least two protective films.

25. The polarizing plate according to claim 1,
wherein at least one of the at least two protective films comprises at least one of plasticizer, ultraviolet absorbent, peel accelerator, dye and matting agent.

26. The polarizing plate according to claim 1,
wherein at least one of hard coat layer, anti-glare layer and anti-reflection layer is provided on a surface of at least one of the at least two protective films.

27. A liquid crystal display device comprising:
a liquid crystal cell; and
a plurality of polarizing plates,
wherein at least one of the plurality of polarizing plates is a polarizing plate according to claim 1.

28. A liquid crystal display device comprising:
a liquid crystal cell; and
a polarizing plate according to claim 26,
wherein the at least one of the at least two protective films having at least one of hard coat layer, anti-glare layer and anti-reflection layer is disposed on a side of the polarizing plate opposite to the liquid crystal cell.

29. The liquid crystal display device according to claim 27, which comprises a pair of polarizing plates,
wherein the liquid crystal cell is disposed interposed between the pair of polarizing plates, and
wherein a transmission axis of the pair of polarizing plates are disposed perpendicular to each other and disposed perpendicular or parallel to a side of the pair of polarizing plates.

30. The liquid crystal display device according to claim 27,
wherein the liquid crystal cell is a VA mode.

31. The liquid crystal display device according to claim 27,
wherein a backlight having a surface temperature of 40° C. or less is utilized.

32. The liquid crystal display device according to claim 31,
wherein one of light-emitting diode and two-dimensionally laminated fluorescent lamp is utilized as a source of a backlight.
